(19) United States
(12) Patent Application Publication
(10) Pub. No.: US 2014/0253727 A1
(43) Pub. Date: Sep. 11, 2014

(54) SYSTEMS AND METHODS FOR FACILITATING COMMUNICATIONS BETWEEN A USER AND A PUBLIC OFFICIAL

(71) Applicant: Evocentauri Inc., Studio City, CA (US)

(72) Inventor: Ali Sadrieh, Studio City, CA (US)

(73) Assignee: Evocentauri Inc., Studio City, CA (US)

(21) Appl. No.: 14/198,010

(22) Filed: Mar. 5, 2014

Related U.S. Application Data
(60) Provisional application No. 61/774,980, filed on Mar. 8, 2013.

(51) Int. Cl. H04N 7/18

(52) U.S. Cl. CPC H04N 7/183
USPC 348/143

(57) ABSTRACT

To foster civilized discourse between the general public and public officials, a system is provided that establishes a controlled environment in which the general public and public officials can electronically communicate. For example, the system can allow a constituent to generate a message related to a political issue for a public official to read or view and provide a network that allows the message to be transmitted to the public official and be available for reading or viewing by the general public. The message could be written, captured via an audio file, and/or captured via a video file. The message, when viewed or read by the general public, can be distorted so as to preserve the identity of the person who has created the message. However, to ensure that a civilized discourse is maintained, the message would not be distorted when presented to the public official.

### RELATED APPLICATION

This application claims the benefit of priority under 35 U.S.C. §119(e) of U.S. Provisional Patent Application No. 61/774,980, filed on Mar. 8, 2013, and entitled “SYSTEMS AND METHODS FOR FACILITATING COMMUNICATIONS BETWEEN A USER AND A PUBLIC OFFICIAL,” the disclosure of which is hereby incorporated by reference in its entirety.

### BACKGROUND

1. Field

This disclosure generally relates to facilitating communications between users and more particularly to improved methods and systems for allowing a user to contact and communicate with a public official.

2. Description of the Related Art

Society has evolved considerably over the last few generations. A typical person living in the 1950's spent a significant amount of time reading and writing in long-form (e.g., with pen and paper) as that was the method of communication performed. Today, reading and writing in long-form is less prevalent due to the increased usage of computers and, in particular, the Internet. In fact, the Internet gave the ability for people that may not necessarily have an education or an occupation or the skill set in long-form thinking to communicate rapidly and easily. Moreover, the Internet has changed the amount of access that the average individual has to the wealth of human knowledge.

However, the Internet breeds a lack of accountability via anonymity. A person can comment or respond to a news story or a blurb posted by another person (e.g., a video published on a video streaming website, a tweet, etc.) with a username that is not publicly associated with the person's name. The person may comment or respond with words that he or she may not otherwise speak or write if it was publicly known who was making such comments or replies. This may be dangerous because it threatens democracy and civilized discourse. For example, in the context of public officials, there is no reason for a public official to listen or respond to protests made by individuals if the protests are lodged anonymously or with hate and venom. In some cases, this creates a disconnect between the actions of a public official and the will of the public official's constituents. Accordingly, what is needed is a system that fosters civilized discourse between constituents and public officials.

### BRIEF DESCRIPTION OF THE DRAWINGS

Features and aspects, and advantages of the embodiments of the invention are described in detail below with reference to the drawings of various embodiments, which are intended to illustrate and not to limit the invention. The drawings include the following figures in which:

FIG. 1 is a block diagram depicting an exemplary communications system.

FIG. 2 is a block diagram depicting communications between the various devices and servers of the communications system of FIG. 1.

FIG. 3 is a more detailed block diagram of a server of the communications system of FIG. 1.

FIGS. 4A-G are diagrams depicting exemplary graphical user interfaces used to capture video and generated by an application executed by the citizen device and/or the one or more society devices of the communications system of FIG. 1.

FIGS. 5A-N are diagrams depicting exemplary graphical user interfaces that display videos captured by other users and that are generated by an application executed by the citizen device and/or one or more society devices of the communications system of FIG. 1.

FIGS. 6A-B are diagrams depicting exemplary graphical user interfaces that display political issues and that are generated by an application executed by the citizen device and/or one or more society devices of the communications system of FIG. 1.

FIGS. 7A-D are diagrams depicting exemplary graphical user interfaces that display a list of public officials and that are generated by an application executed by the citizen device and/or the one or more society devices of the communications system of FIG. 1.

FIG. 8 is a diagram depicting an exemplary graphical user interface that displays information on bills, campaigns, petitions, and diverse points of view and that is generated by an application executed by the citizen device and/or the one or more society devices of the communications system of FIG. 1.

FIGS. 9A-L are diagrams depicting exemplary graphical user interfaces that display a user profile and that are generated by an application executed by the citizen device and/or one or more society devices of the communications system of FIG. 1.

FIG. 10 is a diagram depicting an exemplary graphical user interface that displays an option to log into an application executed by the citizen device and/or one or more society devices of the communications system of FIG. 1.

FIGS. 11A-C are diagrams depicting exemplary graphical user interfaces that display an option for following a public official or challenger using an application executed by the citizen device and/or one or more society devices of the communications system of FIG. 1.

FIGS. 12A-I are diagrams depicting exemplary graphical user interfaces that display an application executed by the government device of the communications system of FIG. 1.

FIGS. 13A-B are diagrams depicting exemplary graphical user interfaces that display an application executed by the government device of the communications system of FIG. 1.

FIGS. 14A-H are diagrams depicting exemplary graphical user interfaces that display a user profile generated by an application executed by the government device of the communications system of FIG. 1.

FIGS. 15A-C are diagrams depicting exemplary graphical user interfaces that display a process for claiming an account generated by an application executed by the government device of the communications system of FIG. 1.

FIG. 16 is a flow diagram depicting a process for facilitating communications between a user and a public official or a challenger.

FIG. 17 is a flowchart depicting an embodiment of a process for capturing video of commentary on a political issue.

FIG. 18 is a flowchart depicting an embodiment of a process for analyzing video of commentary on a political issue.

FIG. 19 is a flowchart depicting an embodiment of a process for promoting a video.

FIG. 20 is a flowchart depicting an embodiment of a process for providing access to a public official or a challenger.

FIG. 21 is block diagram depicting an embodiment of a more detailed device of the communications system of FIG. 1.

### DETAILED DESCRIPTION OF THE EMBODIMENT

In general, as described above, the Internet breeds a lack of accountability via anonymity. A person can comment or respond to a news story or a blurb posted by another person (e.g., a video published on a video streaming website, a tweet, etc.) with a username that is not publicly associated with the person's name. The person may comment or respond with words that he or she may not otherwise speak or write if it was publicly known who was making such comments or replies. This may be dangerous because it threatens democracy and civilized discourse. For example, in the context of public officials, there is no reason for a public official to listen or respond to protests made by individuals if the protests are lodged anonymously or with hate and venom. In some cases, this creates a disconnect between the actions of a public official and the will of the public official's constituents. Accordingly, what is needed is a system that fosters civilized discourse between constituents and public officials.

In an embodiment, a system that establishes a controlled environment in which the general public and public officials or challengers (e.g., persons challenging public officials in an election or for an appointment) can electronically communicate may foster such civilized discourse. For example, the system can allow a constituent to generate a message related to a political issue for a public official or challenger to read or view and provide a network that allows the message to be transmitted to the public official or challenger and be available for reading or viewing by the general public. The message could be written (e.g., typed), captured via an audio file, and/or captured via a video file. The message, when viewed or read by the general public, can be distorted so as to preserve the identity of the person who has created the message. However, to ensure that a civilized discourse is maintained, the message would not be distorted when presented to the public official or challenger.

As a further measure to ensure that a civilized discourse is maintained, the system can monitor these messages before they are transmitted to the public officials or challengers or made available to the public. For example, the messages can be analyzed to determine whether they contain any offensive material. In addition, the system can analyze the messages to determine a public official or challenger that should receive the message.

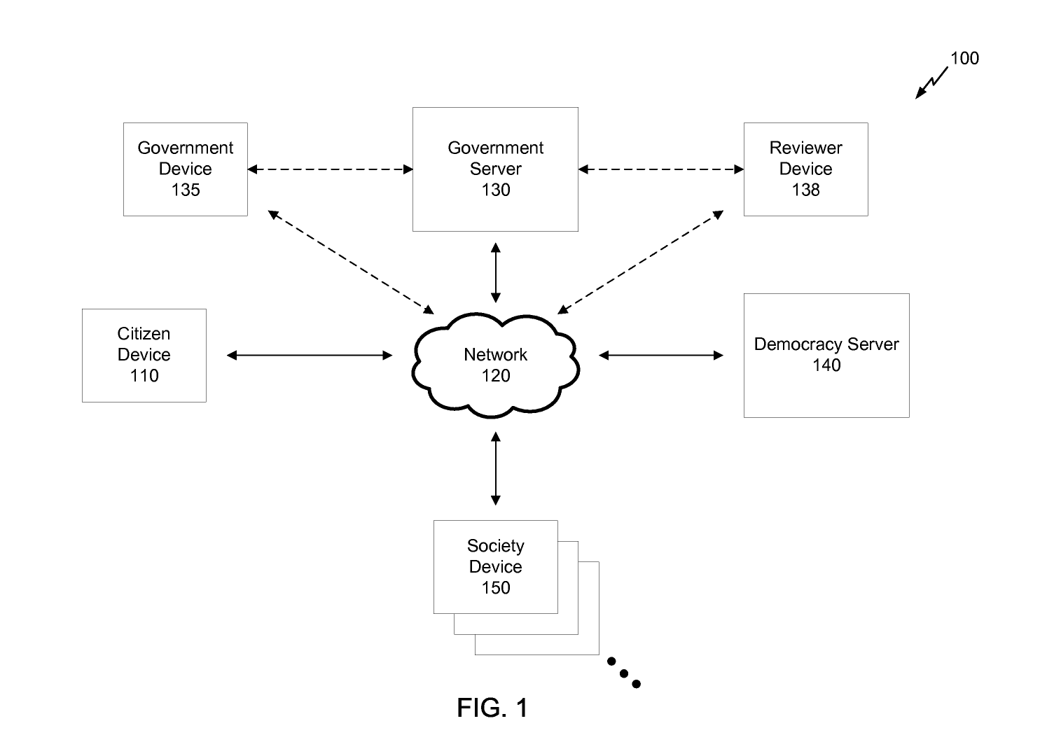

For those messages that are made available to the public, any member of the public can endorse the message or provide additional commentary by generating another message related to the content of the original message. The original message and any additional message can then be transmitted to the appropriate public official or challenger. In this way, the appropriate public official or challenger can get a sense of how important an issue is to his or her constituents and what his or her constituents think of the particular issue. The appropriate public official or challenger, if he or she chooses, can then respond to the message(s), and the system can make such response available to the public. Thus, the system and the processes performed by the system may promote an environment in which public officials or challengers and their constituents can engage in a constructive debate on the issues of the day. Such a system is described in greater detail below with respect to FIGS. 1-15.

FIG. 1 is a block diagram illustrating an exemplary communications system 100. As illustrated in FIG. 1, the communications system 100 can include a citizen device 110, a government server 130, a government device 135, a reviewer device 138, democracy server 140, one or more society devices 150, and/or a network 120.

The citizen device 110 can be associated with a constituent and configured to execute applications and communicate with the other devices and servers illustrated in FIG. 1 via the network 120. For example, the citizen device 110 can be configured to allow a user to participate in civilized discourse with a public official. The citizen device 110 can be configured to allow the user to participate in such a way by allowing the user to generate a message for a public official (e.g., by allowing the user to capture or record a video of the user discussing an issue), provide a description for the message (e.g., a title and summary describing the content of the message), transmit such message and description over the network 120 to a public official via the government server 130, and/or view messages (e.g., videos) posted by other users.

The government device 135 can be associated with a public official or a candidate challenging a public official for office (e.g., a “challenger”) and configured to execute applications and communicate with the other devices and servers illustrated in FIG. 1. For example, the government device 135 can be configured to receive messages from the government server 130 and/or the network 120 and display the received messages via an interface (e.g., a web interface, a mobile application, etc.). The government device 135 can be configured to generate a response to a message (e.g., via a message typed by the public official or challenger, via an audio message captured by the public official or challenger, via a video captured by the public official or challenger, etc.) and transmit such reply to the government server 130 and/or network 120. In some embodiments, the government device 135 is configured to allow a public official or challenger to flag a received message if the message is offensive in nature (e.g., the message includes profanity, derogatory comments, provocative or insulting gestures or actions, etc.). While FIG. 1 illustrates a single government device 135, it should be apparent to one skilled in the art that a plurality of government devices 135 can be present in the communications system 100, each government device 135 associated with a different public official or challenger.

In an embodiment, the government device 135 allows a public official or challenger to initiate an ad-hoc meeting or press conference. For example, the government device 135 can record (e.g., a video recording) the public official or challenger as the public official or challenger makes a statement. The public official or challenger can tag the statement such that it is appended to a new or existing issue. Alternatively or in addition, the government device 135 can also suggest a new or existing issue to tag the statement with based on the contents of the statement.

The reviewer device 138 can be associated with a message reviewer and configured to receive messages flagged by the government device 135 via the government server 130 and/or the network 120. In an embodiment, the reviewer device 138 is configured to allow the reviewer to analyze the message and determine whether the message does include offensive material. In some embodiments, the reviewer device 138 is configured to allow the reviewer to remove the message if the message includes offensive material or keep the message if the message does not include offensive material. While FIG. 1 illustrates a single reviewer device 138, it should be apparent to one skilled in the art that a plurality of reviewer devices 138 can be present in the communications system 100, each reviewer device 138 associated with a different message reviewer.

The one or more society devices 150 can be similar to the citizen device 110. The one or more society devices 150 can be associated with other constituents and configured to execute applications and communicate with the other devices and servers illustrated in FIG. 1 via the network 120. In an embodiment, the one or more society devices 150 can be configured to allow another constituent to generate a message (e.g., a video) in response to a message generated by the citizen device 110 and/or allow another constituent to promote a message generated by the citizen device 110 (e.g., indicate that the other constituents likes or approves the content of the message generated by the citizen device 110). As used herein, voting for a message comprises generating a message in response to a message generated by another user and promoting a message comprises endorsing a message generated by another user. A message that is voted or promoted may increase the message's weight (e.g., “like” count or other such measure to show the message's popularity). As described below, the amount that the message's weight is increased may depend on the political party of the constituent that votes or promotes the message.

The citizen device 110, government device 135, reviewer device 138, and/or the one or more society devices 150 can be embodied as a computer system, such as, without limitation, a laptop, a desktop, a tablet, a smartphone, a cell phone, or the like.

The government server 130 can be configured to serve as an interface between constituents and public officials and challengers. In an embodiment, the government server 130 receives messages from the citizen device 110 and/or the one or more society devices 150 via the democracy server 140 and transmits the messages to the government device 135 associated with the appropriate public official or challenger. For example, the messages may be transmitted to the government device 135 in the form of an electronic message (e.g., e-mail, text message, instant message, etc.) with an attachment (e.g., an audio file, a video file, etc.). In a further embodiment, the government server 130 receives messages generated by the government device 135. For example, the messages may be received from the government device 135 in the form of an electronic message with an attachment. The government server 130 can transmit the electronic message and/or attachment generated by the government device 135 to the democracy server 140 via the network 120 for eventual transmission to the citizen device 110 and/or the one or more society devices 150. Moreover, the government sever 130 can receive an indication of whether a public official or challenger has flagged a message generated by the citizen device 110 and/or the one or more society devices 150. If a message is flagged, the government server 130 can send the message to the reviewer device 138 and receive a determination from the reviewer device 138 on whether the message should be removed or deleted.

The government server 130 can be a messaging server, such as an e-mail server, that is located behind a firewall and housed remotely or at a government facility. The government server 130 may include secure connections to the government devices 135 and/or the reviewer devices 138.

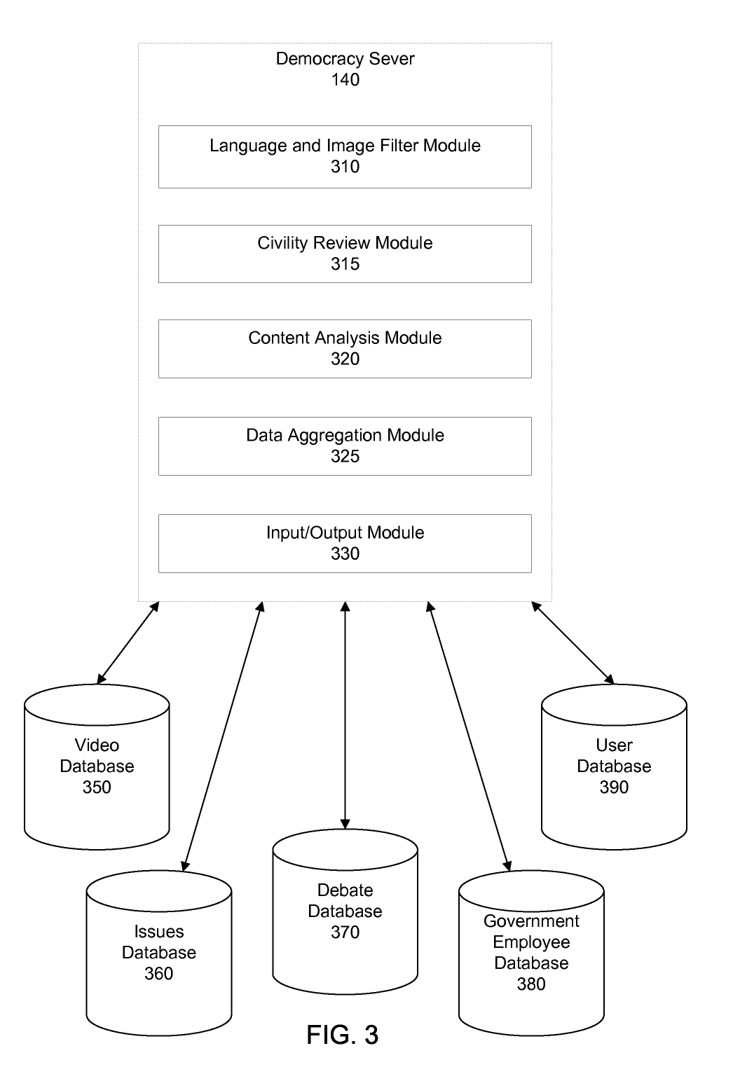

The democracy server 140 can be configured to control communications between the citizen device 110 and/or the one or more society devices 150 and the government server 130. For example, the democracy server 140 can be configured to filter messages for offensive material, analyze messages to provide suggestions, and control access to messages. Such functionality is described in greater detail below with respect to FIG. 3. In an embodiment, the democracy server 140 is configured to receive messages from the citizen device 110 and/or the one or more society devices 150 and transmit such messages to the government server 130. In a further embodiment, the democracy server 140 is configured to receive messages from the government server 130 and provide the citizen device 110 and/or the one or more society devices 150 with access to the received messages. In some embodiments, the democracy server 140 represents a central repository for storing and providing access to messages generated by any of the devices, political issues, lists of public officials, lists of challengers, information on bills, campaigns, petitions, and points of view on political issues from various interested private parties, and/or user profiles.

In an embodiment, the government server 130 and/or the democracy server 140 include or are in communication with one or more storage mediums. For example, the democracy server 140 may include or be in communication with one or more databases. Such databases are described in greater detail below with respect to FIG. 3.

The government server 130 and/or the democracy server 140 can be a computing device. For example, the government server 130 and/or the democracy server 140 can include one or more processors to execute one or more instructions, memory, and communication devices to transmit and receive data over the network 120. In some embodiments, the government server 130 and/or the democracy server 140 are implemented as one or more backend servers capable of communicating over a network. In other embodiments, the government server 130 and/or the democracy server 140 are implemented by one more virtual machines in a hosted computing environment. The hosted computing environment can include one or more rapidly provisioned and released computing resources, which computing resources can include computing, networking and/or storage devices. A hosted computing environment can also be referred to as a cloud computing environment. In still other embodiments, the government server 130 and/or the democracy server 140 can be represented as a user computing device capable of communicating over a network, such as a laptop or tablet computer, personal computer, personal digital assistant (PDA), hybrid PDA/mobile phone, mobile phone, global positioning system (GPS) device, or the like. Although FIG. 1 depicts a single government server 130 and a single democracy server 140, the functions described herein can be performed or distributed across multiple networked computing devices, including devices that are geographically distributed and/or are allocated dynamically from a pool of cloud computing resources. For example, the government server 130 and/or the democracy server 140 are implemented by one more virtual machines in a hosted computing environment. The hosted computing environment can include one or more rapidly provisioned and released computing resources (e.g., dynamically-allocated computing resources), which computing resources may include computing, networking and/or storage devices.

The network 120 can be a wired network, a wireless network, or a combination of the two. For example, the network 120 can be a personal area network, a local area network (LAN), a wide area network (WAN), or combinations of the same. Protocols and components for communicating via any of the other aforementioned types of communication networks, such as the TCP/IP protocols, can be used in the network 120.

In an embodiment, the devices and/or servers of the communications network 100 can be in communication with network 120 via wired or wireless technology. For example, devices and/or servers of the communications network 100 can communicate with network 120 via Ethernet, USB 1.0, USB 2.0, USB 3.0, IEEE 1394, IEEE 1394a, IEEE 1394b, Thunderbolt, VGA, DVI, HDMI, optical fiber, serial port, parallel port, the 802.11 standard, the 802.15.4 standard, radio-frequency identification (RFID), near-field communication (NFC), Bluetooth, or the like.

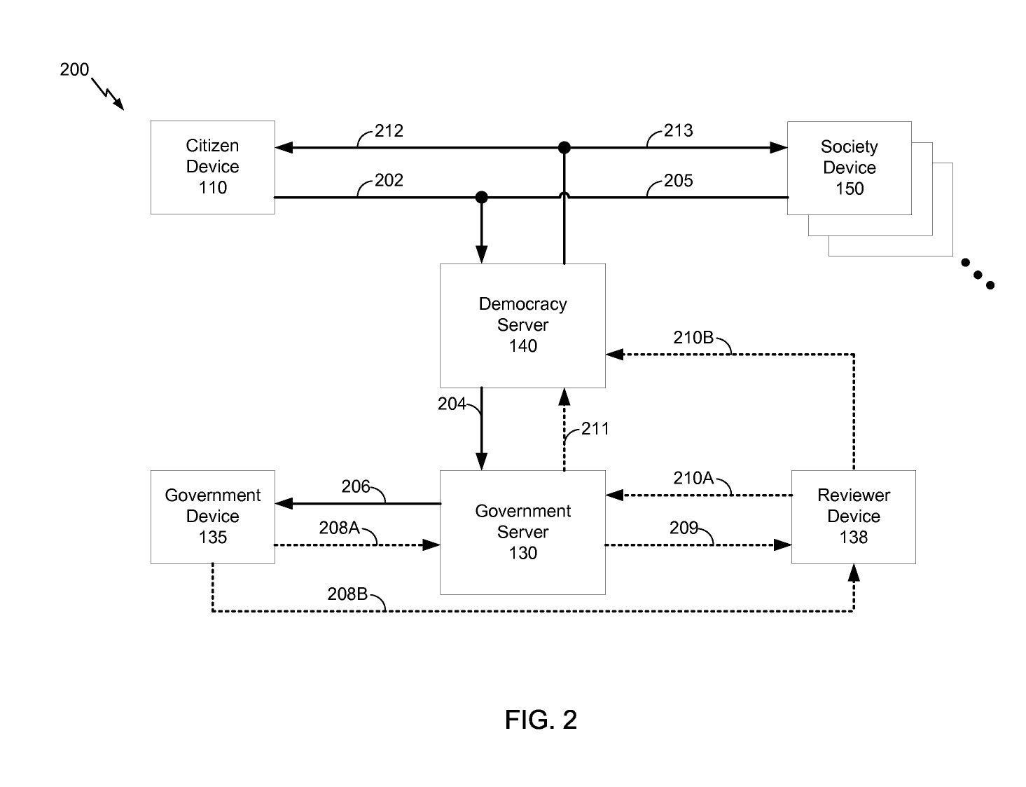

The messages and other communications transmitted between the various devices and servers in the communications system 100 as illustrated in FIG. 1 are described in more detail below with respect to FIG. 2.

FIG. 2 is a block diagram 200 depicting communications between the various devices and servers of the communications system 100 of FIG. 1. As illustrated in FIG. 2, a message 202 can be transmitted by the citizen device 110 to the democracy server 140. In an embodiment, the message 202 is a message transmitted for the purpose of being received by a selected public official or challenger. For example, the message can include a video captured by a user and a description of the content of the video. The content of the video can be directed to a political issue related to the selected public official or challenger (e.g., a political issue championed by the selected public official or challenger, a political issue of importance to the constituents of the selected public official or challenger, etc.).

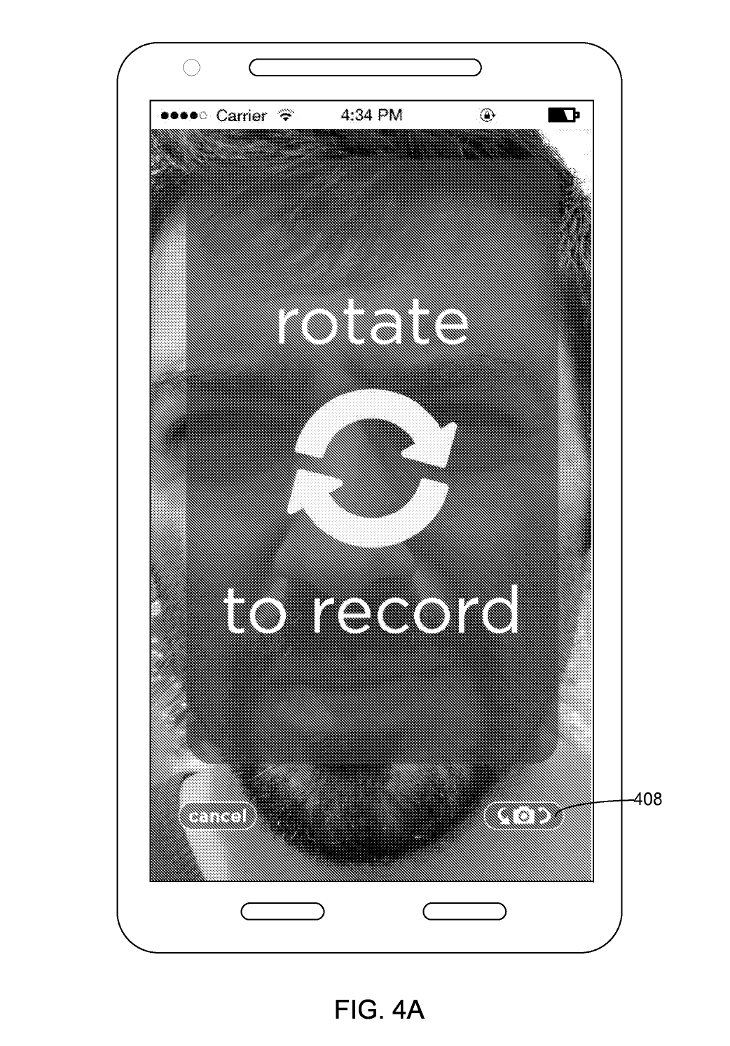

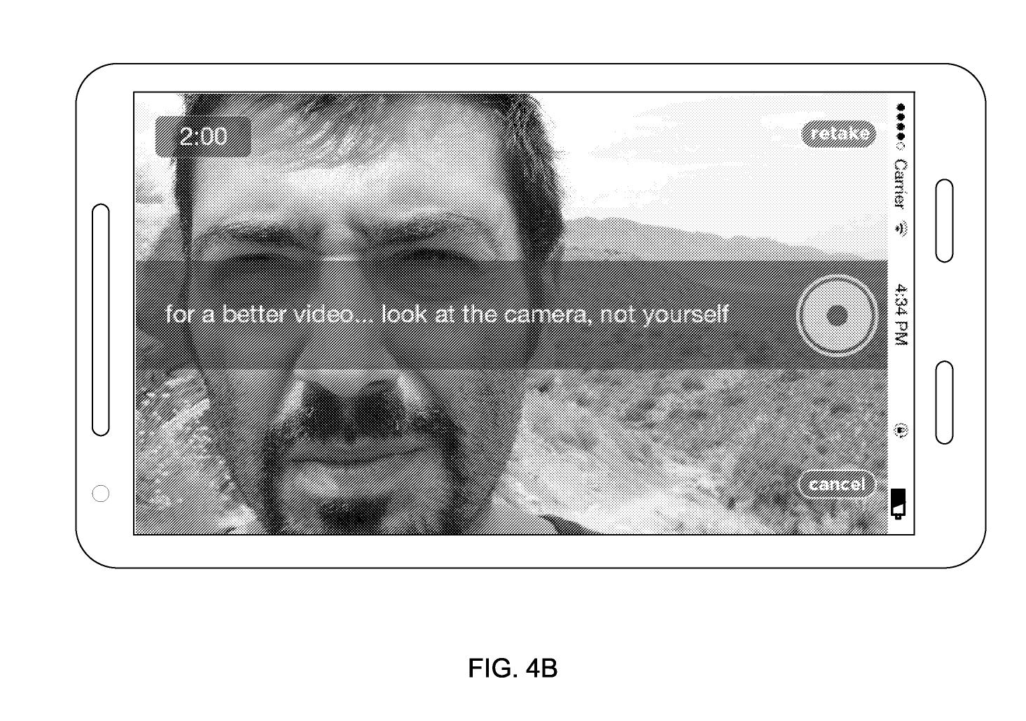

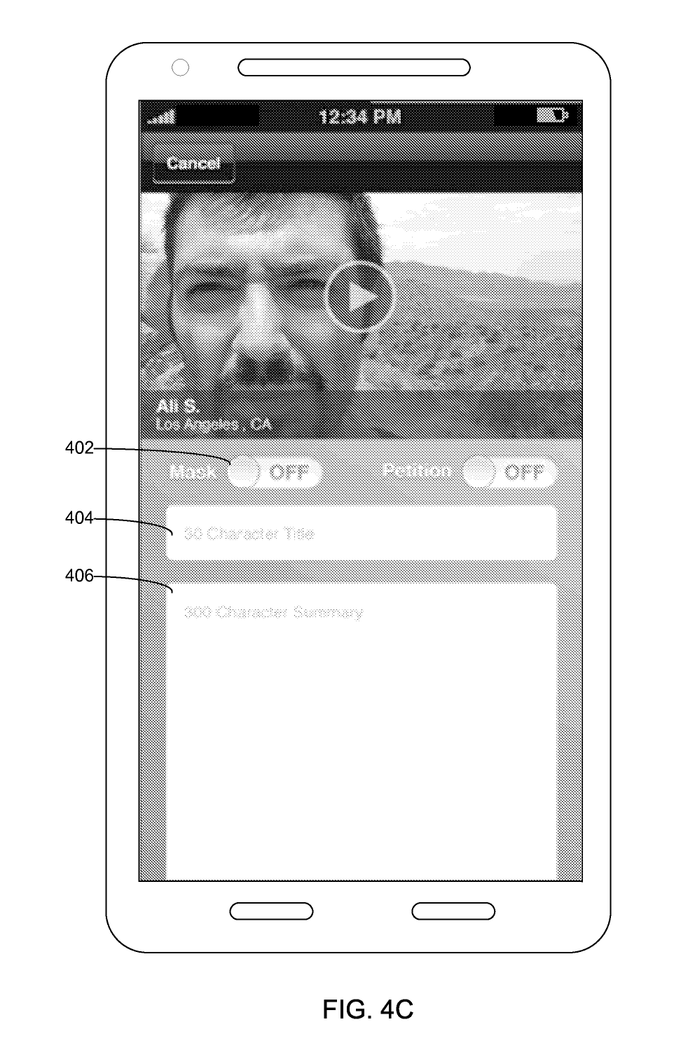

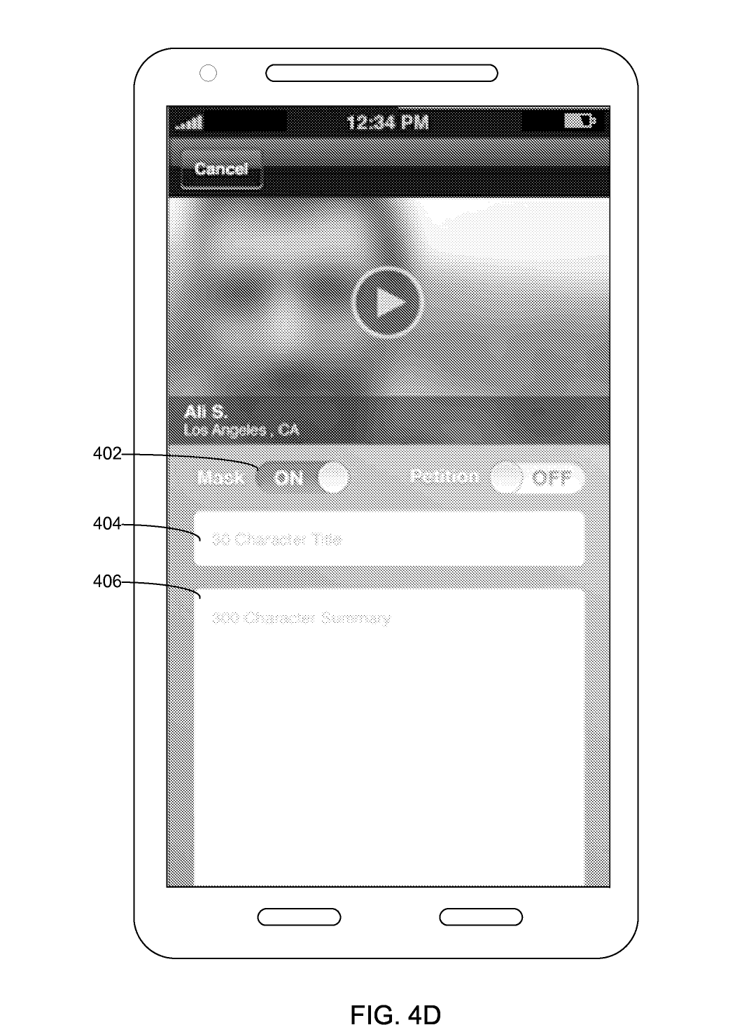

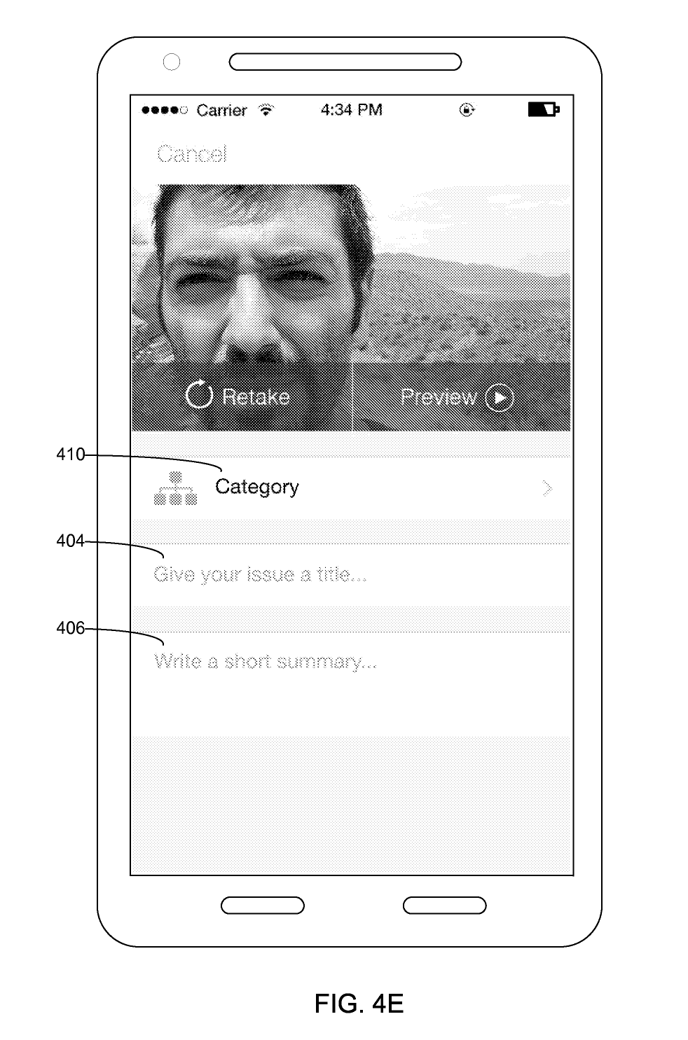

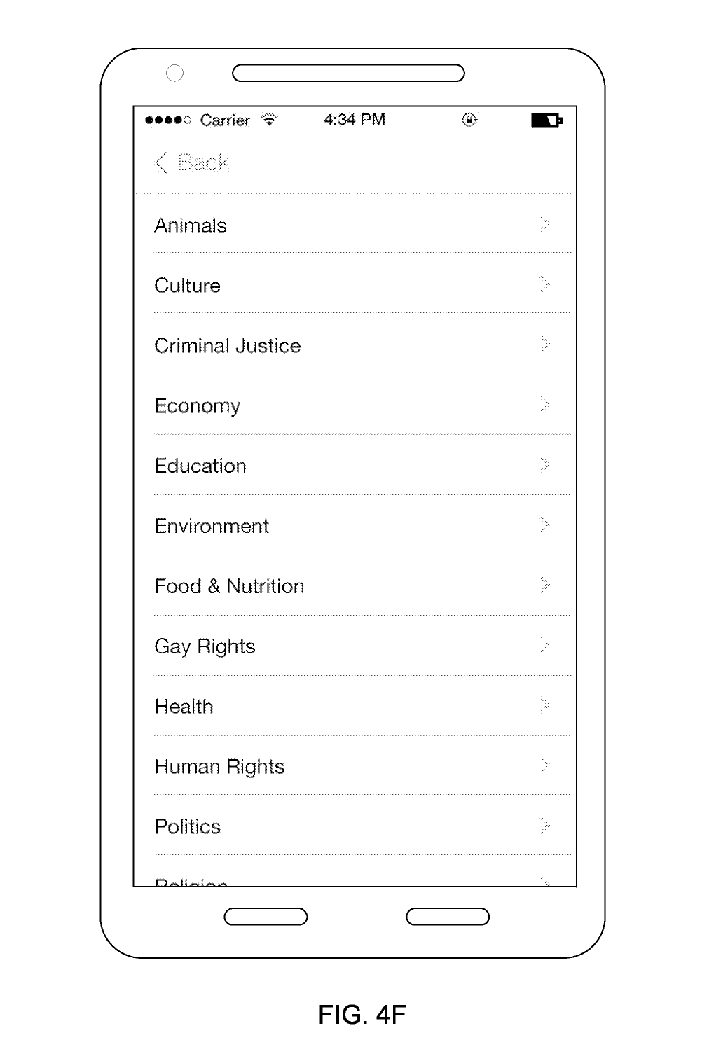

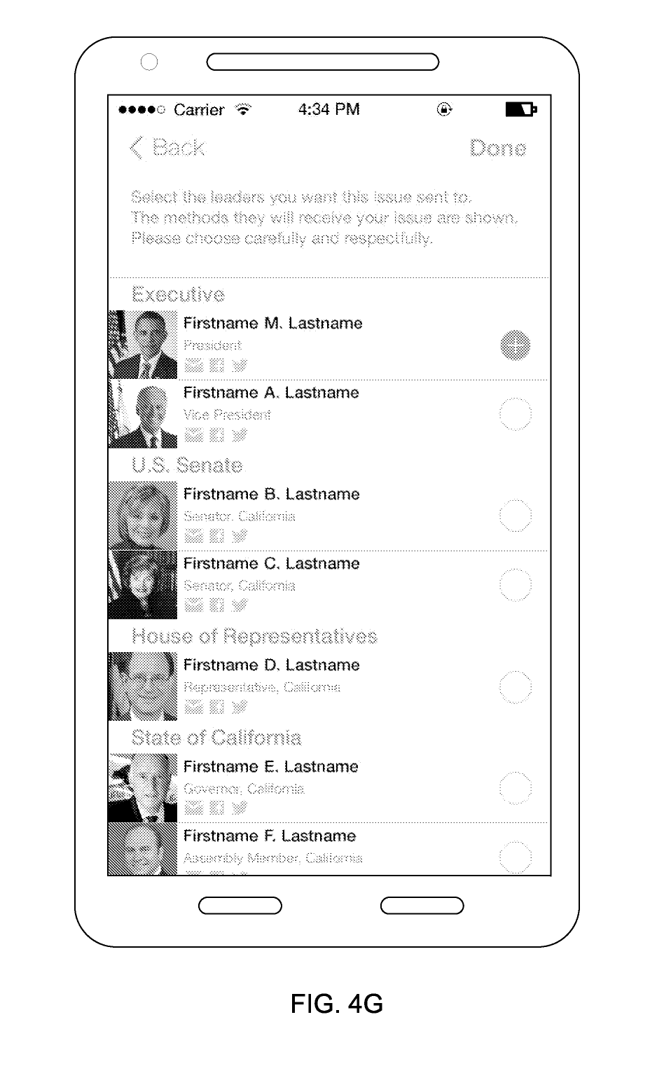

In an embodiment, the democracy server 140 can evaluate the message 202. For example, the democracy server 140 can evaluate the content of the message 202 to determine whether the message 202 contains any offensive material. The evaluation of the content of the message 202 is described in greater detail below with respect to FIG. 3. If the democracy server 140 determines that the message 202 does not contain any offensive material, the message 202 is forwarded to the government server 130 as message 204. In addition, the democracy server 140 can provide other users with a certain level of access to the content of the message 202 (e.g., certain information related to the message 202 may not be available to all users, as described below with respect to FIGS. 4A-G). If the democracy server 140 determines that the message 202 contains offensive material, the message 202 is not forwarded to the government server 130. The user of the citizen device 110 can be notified that the message 202 has not been forwarded to the government server 130 and can be warned to not include offensive material in future messages and/or temporarily or permanently banned from generating future messages.

If the democracy server 140 provides other users with access to the content of the message 202, other users can reply to the message 202 via another message and/or promote the message 202. For example, another user can generate a message 205 (e.g., a video captured by the another user and a description of the content of the video) in reply to the content of the message 202 (e.g., a vote for the message 202), and one of the society devices 150 can transmit the message 205 to the democracy server 140. In an embodiment, if the message 205 is transmitted to the democracy server 140, the message 202, the message 205, and/or any other messages 205 generated by the one or more society devices 150 can be included in the message 204, with the message 202 set as the first message that will be viewed by the public official or challenger. In another embodiment, if the message 205 has a higher weight than the message 202 (e.g., because more users have voted or promoted the message 205 than the message 202), the message 205, the message 202, and any other messages 205 generated by the one or more society devices 150 can be included in the message 204, with the message 205 set as the first message that will be viewed by the public official and the message 202 set as the second message that will be viewed by the public official. As another example, another user can promote the message 202, and one of the society devices 150 can transmit the promotion via message 205 to the democracy server 140. In an embodiment, the message 204 can include an indication of which users and/or the number of users that have promoted the message 202.

In an embodiment, the government server 130 receives the message 204. The government server 130 can extract the content of the message 204 (e.g., text, captured audio, captured video, etc.) and forward such content to the government device 135 via message 206. For example, the government server 130 can transmit the content of the message 204 to the government device 135 as an attachment in an electronic message (e.g., e-mail, text message, instant message, etc.). Existing messaging clients can be used to transmit the message 206. Alternatively, a dedicated, secure messaging client setup between the government server 130 and one or more government devices 135 can be used to transmit the message 206. The government server 130 can store the message 204 for later use.

The government device 135 can transmit a message 208A to the government server 130 and/or the democracy server 140 and/or a message 208B to the reviewer device 138. In an embodiment, the public official or challenger associated with the government device 135 can review the content of the message 206. If the public official or challenger finds the content of the message 206 to not include any offensive material, the public official or challenger has the option of responding to the message 206. The public official or challenger can respond by generating a message (e.g., an audio clip, a video clip, text, etc.) and such message can be transmitted to the government server 130 as the message 208A. If the public official or challenger finds the content of the message 206 to include offensive material, the public official or challenger can flag the message 206, and the government server 130 can be notified of this flagging via the message 208A. The government sever 130 can forward an indication that the message 206 has been flagged and the message 206 itself to the reviewer device 138 via a message 209. Additionally or alternatively, the reviewer device 138 can be notified of this flagging and receive the message 206 via the message 208B (e.g., the reviewer device 138 can be in direct communication with the government device 135).

The reviewer device 138 can transmit a message 210A to the government server 130 and/or a message 210B to the democracy server 140. In an embodiment, the message reviewer associated with the reviewer device 138 reviews the content of the message 206 and determines whether the message 206 includes offensive material. Such determination can be transmitted to the government server 130 via the message 210A or to the democracy server 140 via the message 210B.

In some embodiments, if the reviewer device 138 determines that the message 206 does not contain any offensive material, the government server 130 maintains the message 204 and/or 206. Otherwise, if the reviewer device 138 determines that the message 206 does contain offensive material, the government server 130 deletes (or archives) the message 204 and/or 206. In an embodiment, if the democracy server 140 does not receive the message 210B, the government server notifies the democracy server 140 of the determination via a message 211. Like the government server 130, the democracy server maintains the message 202 and/or 204 if there is no offensive material and deletes (or archives) the message 202 and/or 204 if there is offensive material (e.g., users can no longer view the message 202).

In an embodiment, if the government device 135 transmits the message 208A as including the message generated by the public official or challenger, the message 208A can be forwarded to the democracy server 140 via the message 211. The democracy server 140 can then make the message generated by the public official or challenger available to some or all users. For example, the message generated by the public official or challenger can be transmitted to the citizen device 110 via message 212 and to the one or more society devices 150 via message 213.

In a further embodiment, while viewing or reading the message generated by the public official or challenger, a user can provide campaign contributions using the citizen device 110 and/or the one or more society devices 150. For example, the democracy server 140 may store payment information associated with a user (e.g., in user database 390 described below). The democracy server 140 may embed a link in the message 212 that automatically deducts an amount specified by the user or an amount automatically determined by the democracy server 140 each time the link is selected and provide such amount to the public official or challenger. In this way, the democracy server 140 may allow a user to provide granular contributions to a public official or challenger. For example, the user may select the link each time the public official or challenger makes a point that the user agrees with. In addition, the democracy server 140 may track an amount that a user has donated to a particular public official or challenger, notify the user when the user has reached the campaign contributions limit specified by law, and/or prevent the user from contributing any additional funds once the limit has been reached.

FIG. 3 is a more detailed block diagram of the democracy server 140 of the communications system of FIG. 1. As illustrated in FIG. 3, the democracy server 140 can include a language and image filter module 310, a civility review module 315, a content analysis module 320, a data aggregation module 325, and/or an input/output module 330. The democracy server 140 can include (not shown) or be in communication with a video database 350, an issues database 360, a debate database 370, a government employee database 380, and/or a user database 390.

In an embodiment, the language and image filter module 310 is configured to analyze a received message for offensive material. For example, the language and image filter module 310 can be configured to analyze a video's audio track to determine whether a profanity is uttered or a derogatory comment is made. A predetermined list of profane or derogatory words or phrases can be compared with the audio track to determine whether such words or phrases exist in the received message. The list can be maintained by the democracy server 140 and updated over time. The language and image filter module 310 can also be configured to analyze the frames of a video to determine whether an inappropriate gesture (e.g., a provocative gesture, an insulting gesture, etc.) or any other inappropriate action is made. A database of inappropriate images can be maintained by the democracy server 140 and compared with the frames of the video to determine whether any inappropriate gestures or actions are present in the message. The database of inappropriate images can be updated over time.

In some embodiments, as described above with respect to FIGS. 1 and 2, reviewer devices 138 are configured to allow message reviewers to review any flagged messages. In other embodiments, the civility review module 315 is configured to automatically review flagged messages. The civility review module 315 can analyze patterns of words spoken or written in the message, perform a waveform analysis, detect features of the voice speaking (e.g., the amount of anger in the voice), and/or the like to determine whether a flagged message includes offensive material.

As described above, the democracy server 140 can provide suggestions to the constituents. For example, a constituent may be aware of an issue, but may be unaware of the public official that would be in charge of the issue or a challenger that is interested in the issue. In an embodiment, the content analysis module 320 can be configured to analyze a message to determine a suggested list of public officials and/or a list of challengers to which the message applies. The content analysis module 320 can analyze the text description describing the content of the message as provided by the constituent via the citizen device 110 and/or the one or more society devices 150 to determine key words or phrases. The key words or phrases can be associated with issues, which are associated with public officials or challengers, and/or the public officials or challengers themselves. This can then be used to generate the suggested list of public officials and/or the suggested list of challengers. In addition or alternatively, the content analysis module 320 can analyze the audio of the message (e.g., the audio track of the video captured by the constituent), and identify key words or phrases that are associated with a particular issue and/or public official or challenger. This can then be used to generate the suggested list of public officials and/or the suggested list of challengers. The content analysis module 320 can transmit the suggested list to the device that provided the message via the input/output module 330.

In an embodiment, the data aggregation module 325 can be configured to organize messages into categories (e.g., by issues, by public officials, by users, etc.). The data aggregation module 325 can be configured to update the organization of messages as new messages are received. The data aggregation module 325 can also store the videos in a database, such as the video database 350.

The input/output module 330 can be configured to provide access to the data stored and/or available via the democracy server 140. For example, the input/output module 330 can be configured to allow users to access and view the messages, view issues, view information on bills, campaigns, petitions, and points of view provided by interested private parties, view a list of public officials, and/or the like.

In an embodiment, the democracy server 140 includes a translation module, not shown. The translation module may be configured to identify a language spoken and/or written in the message and translate the message into a plurality of languages. The language that a message is translated into may depend on the language spoken, written, or otherwise understood by another user. For example, if another user (e.g., via the society device 150) speaks, writes, and/or understands a first language and requests to view a message spoken and/or written in a second language, the translation module may be configured to translate the message into the first language so that the other user can understand the content of the message.

In an embodiment, the video database 350 can be configured to store the content (e.g., videos) of messages received by the democracy server 140. For example, the video database 350 can store the videos generated by constituents (e.g., as received from the citizen device 110 and/or the one or more society devices 150) and/or public officials (e.g., as received from the government server 130). In some embodiments, the video database 350 includes which issues a particular message is associated with.

In an embodiment, the issues database 360 can be configured to store a list of political issues. The political issues can be organized into categories and sub-categories. The content of messages (e.g., videos) can be associated with a category and/or sub-category. The list of political issues can be available to some or all constituents.

In an embodiment, the debate database 370 can be configured to store information on bills, campaigns, and petitions, and/or data provided by private parties that have a particular interest in a given political issue. For example, the debate database 370 can store the text of proposed bills, bills pending approval in a legislature, and approved bills. The debate database 370 can also store related information to the bills, such as vote counts, amendments, and the like. As another example, the debate database 370 can store campaign information, such as platforms (e.g., in text, audio, and/or video), testimonials, candidate histories, campaign schedules, and any other information pertinent to a campaign. As another example, the debate database 370 can store information on petitions that are proposed or have been submitted, such as the text of the petition, number of signatures, the party or parties that created the petition, and/or links to petition webpages (e.g., the White House petition webpage). As another example, the debate database 370 can store information (e.g., text, audio, and/or video) provided by private parties that have an interest in a particular issue or topic. In some cases, a video generated by a private party can be longer in length than a video generated by a constituent (e.g., 15 minute limit for a private party, 2 minute limit for a constituent).

In an embodiment, the government employee database 380 can be configured to store a list of public officials and/or a list of challengers. The lists can include public officials and/or challengers at the national level (e.g., public officials that work for the federal government, challengers seeking office in the federal government, etc.) and at the state and local level (e.g., public officials that work for the state or local government, challengers seeking office in the state or local government, etc.).

In an embodiment, the user database 390 can be configured to store a user profile for each of the users (e.g., constituents) associated with the citizen device 110 and/or the one or more society devices 150. For example, the user profile can include the videos and a number of videos associated with the user, the videos and the number of videos received from public officials or challengers in response to videos generated by the user, a number of votes received on any particular video generated by the user (and the videos generated by other users in response to the video generated by the user), a number of promotions received on any particular video, a number of bookmarked issues and/or videos and a link to those bookmarked issues and/or videos, a name of the user, contact information for the user, a political preference of the user, a list of public officials of which the user is a constituent, and/or a list of challengers seeking office in a region in which the user is a constituent.

In some embodiments, one or more of the databases described above can be implemented using a relational database, such as DB2, Sybase, MySQL, Oracle, CodeBase, and Microsoft® SQL Server as well as other types of databases such as a flat-file database, an entity relationship database, and object-oriented database, and/or a record-based database. The databases described above can be stored in a central repository or in different locations. The databases can be housed in a server apparatus or in a personal device, like a cell phone, a smart phone, a PDA, a tablet, a laptop, a desktop, a camera, a flash drive, a memory card, an optical disc, or the like. Note that while FIG. 3 depicts five databases, other embodiments can include more or fewer databases depending on the type of data a user may request. As is described herein, the democracy server 140 can run operating system software and a user can request data through a web-enabled user access point. Accordingly, a user can request any data available through the network 120 and supported by the operating system software.

FIGS. 4A-G are diagrams depicting exemplary graphical user interfaces used to capture video and generated by an application executed by the citizen device 110 and/or the one or more society devices 150 of the communications system 100 of FIG. 1. As illustrated by FIG. 4A, the application may request a user to rotate the citizen device 110 and/or the one or more society devices 150 from a portrait orientation to a landscape orientation. In an embodiment, the citizen device 110 and/or the one or more society devices 150 prevents a user from capturing video unless the citizen device 110 and/or the one or more society devices 150 is orientated in a landscape configuration. The citizen device 110 and/or the one or more society devices 150 can include a gyroscope, accelerometer, or similar component to detect the orientation. In this way, some or all of the videos uploaded by the citizen device 110 and/or the one or more society devices 150 will have the same aspect ratio and/or size. The user may use any camera or recording device associated with the citizen device 110 and/or the one or more society devices 150 to capture video (e.g., by selecting button 408).

As illustrated in FIG. 4B, once the citizen device 110 and/or the one or more society devices 150 is placed in a landscape orientation, the citizen device 110 and/or the one or more society devices 150 can be configured to allow the user to record a video. The application can provide a countdown to let the user know when the recording will begin and a timestamp to indicate the length of the video. The countdown may begin once the citizen device 110 and/or the one or more society devices 150 is placed in a landscape orientation. The user may be able to retake the video if the user so wishes. In an embodiment, a video is limited to two minutes or less.

As illustrated in FIG. 4C, once the video has been captured, the application executed by the citizen device 110 and/or the one or more society devices 150 allows the user to preview the video. In an embodiment, the user can enter a title in field 404 and/or a description of the content of the video in field 406. In a further embodiment, the user can enable a mask feature via mask button 402. For example, the user may wish to hide his or her identity as the video may be accessible by the general public. As illustrated in FIG. 4D, enabling the mask button 402 can mask (e.g., blur or otherwise distort) the video. In some embodiments, when the mask button 402 is enabled, other users or constituents who view the video will see the blurring or distortion. However, the public official or challenger that receives the video will see the original version (e.g., the unmasked version) of the video. In this way, a user can keep the focus on the content of his or her message rather than on the appearance of the user.

As illustrated in FIG. 4E, once the video has been captured, the application executed by the citizen device 110 and/or the one or more society devices 150 may allow the user to select a category for the video via button 410. In an embodiment, as illustrated in FIG. 4F, once button 410 is selected, a list of selectable categories may appear. Alternatively or in addition, the user may be allowed to enter a new category or issue. After a category or issue is selected, the application may combine one or more categories or issues (e.g., such that the videos or other messages associated with each category or issue are combined to be associated with the same category or issue). For example, the combining may occur automatically based on words or phrases included in the summary of the videos or other messages or included in the summary of the category or issue. As another example, the summaries of the videos, other messages, or categories or issues may be parsed and suggestions may be provided to a human. The human may then manually combine categories or issues.

As illustrated in FIG. 4G, after selecting a category via button 410, entering the title in field 404, entering the description of the content of the video in field 406, and/or choosing whether to mask the video, the application enables the user to select one or more public officials or challengers that should receive the video. In an embodiment, some public officials or challengers may be mutually exclusive such that choosing a first public official or challenger prevents the user from selecting a second public official or challenger. In some embodiments, not shown, the democracy server 140 provides the application with a list of suggested recipients. The suggested recipients may be based on the contents of the title or summary provided in fields 404 and/or 406.

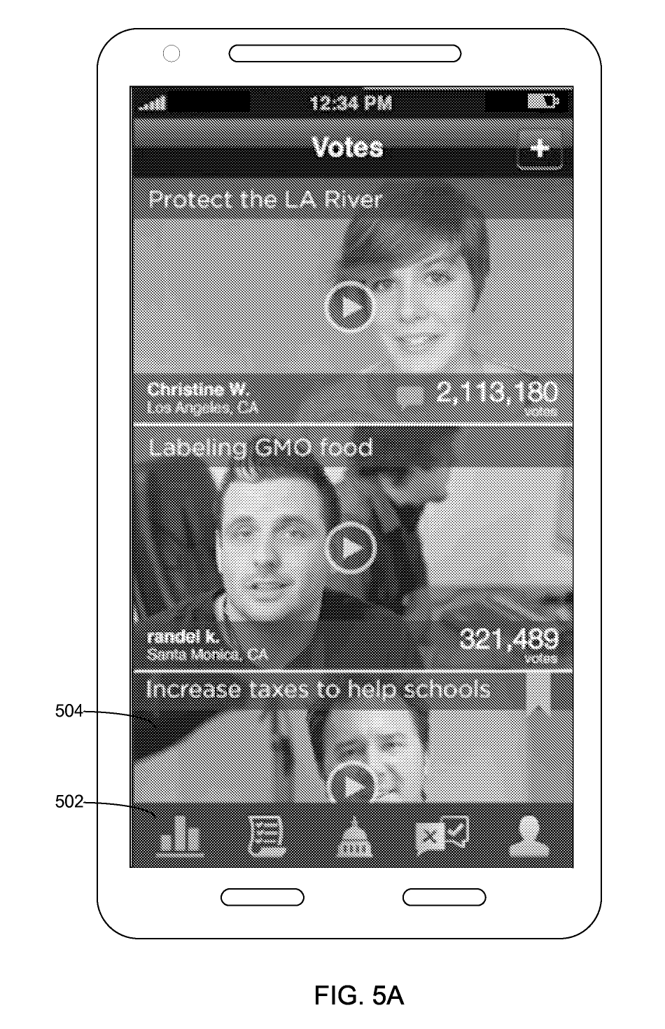

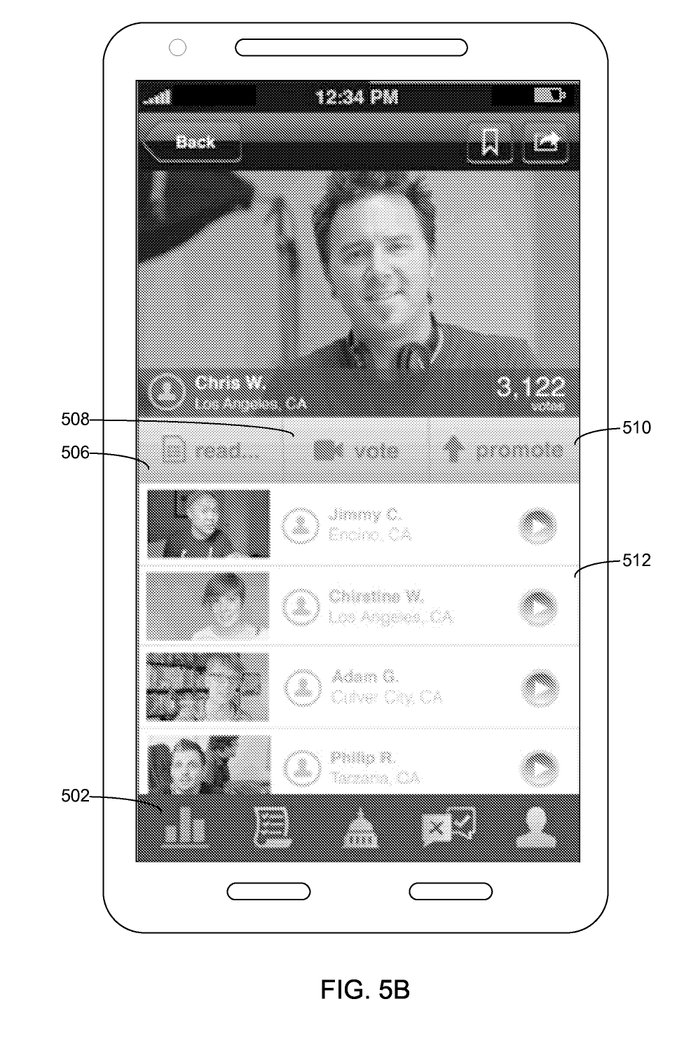

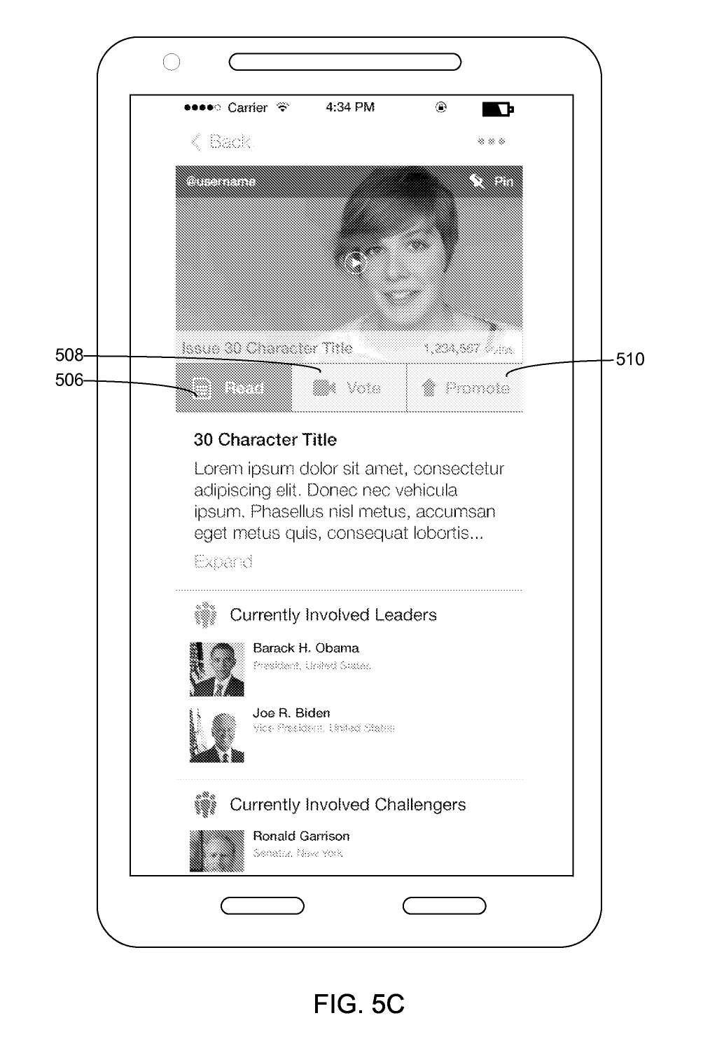

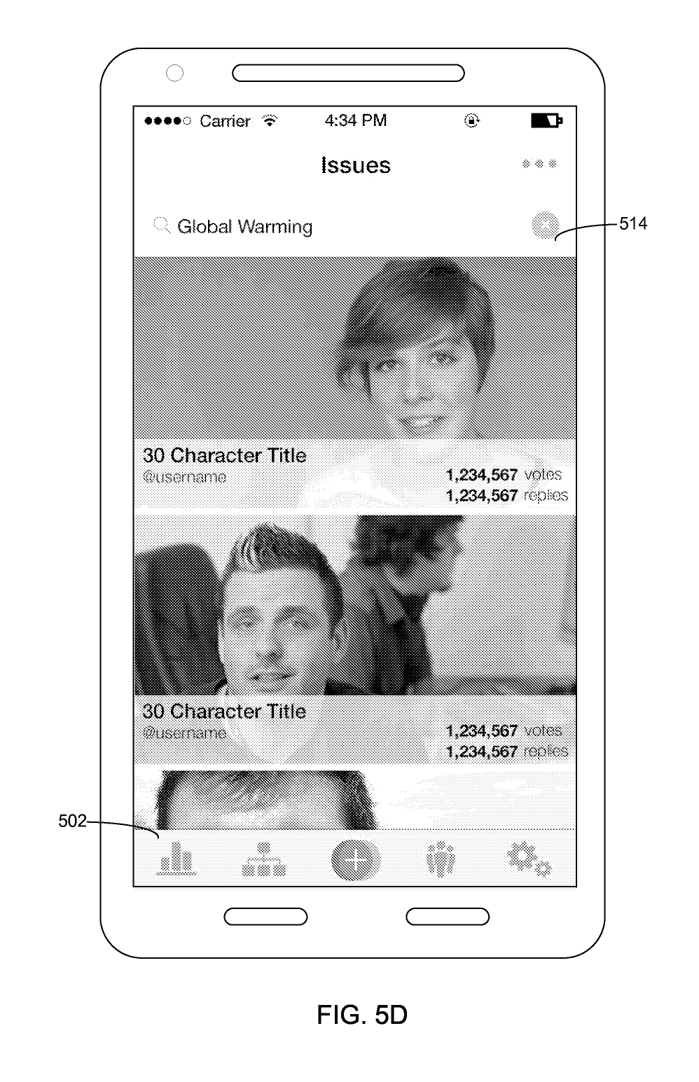

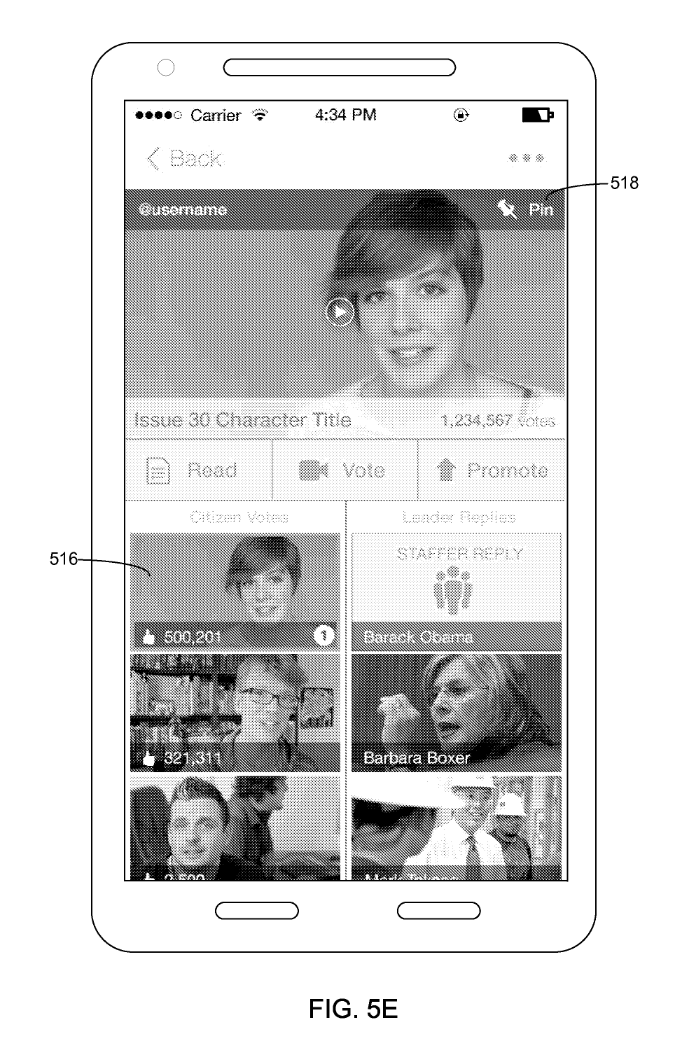

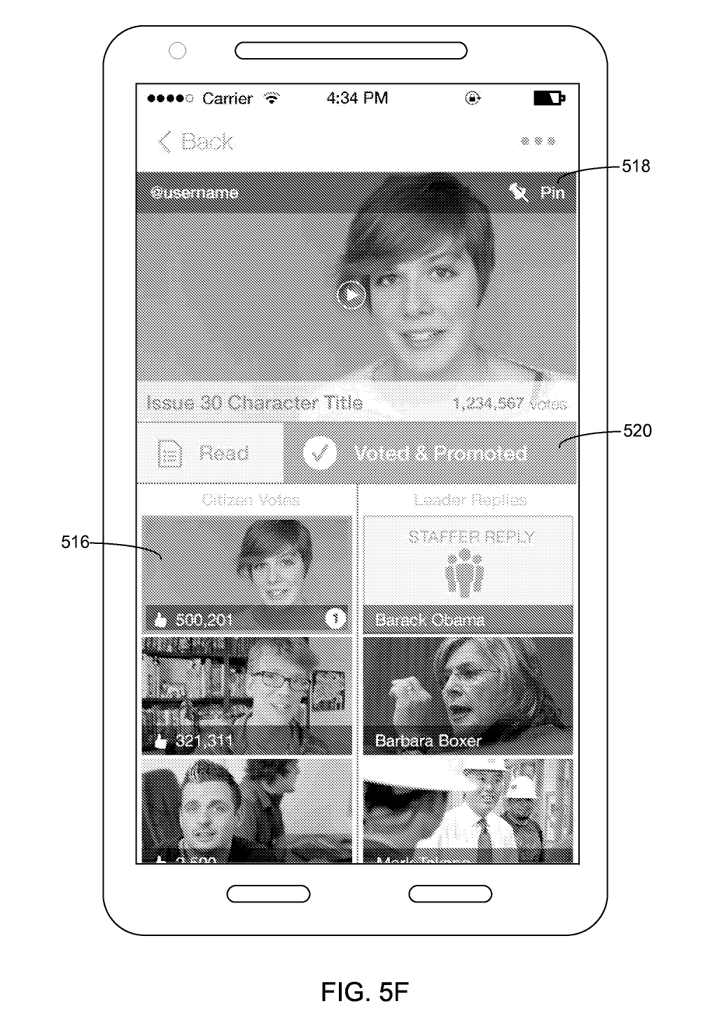

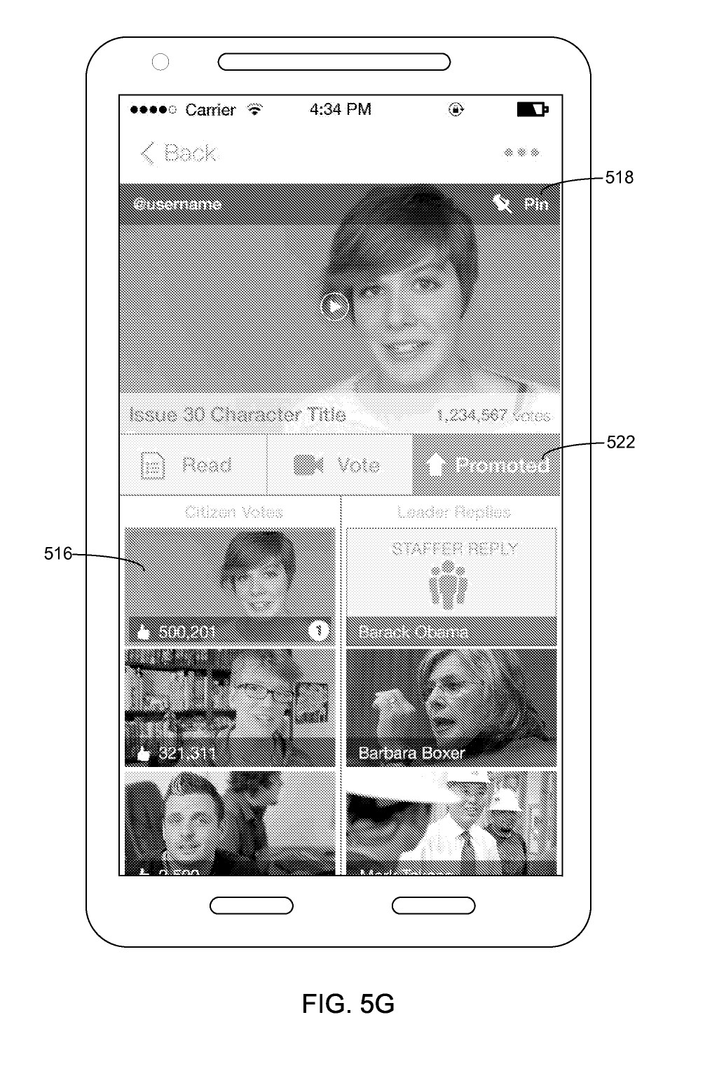

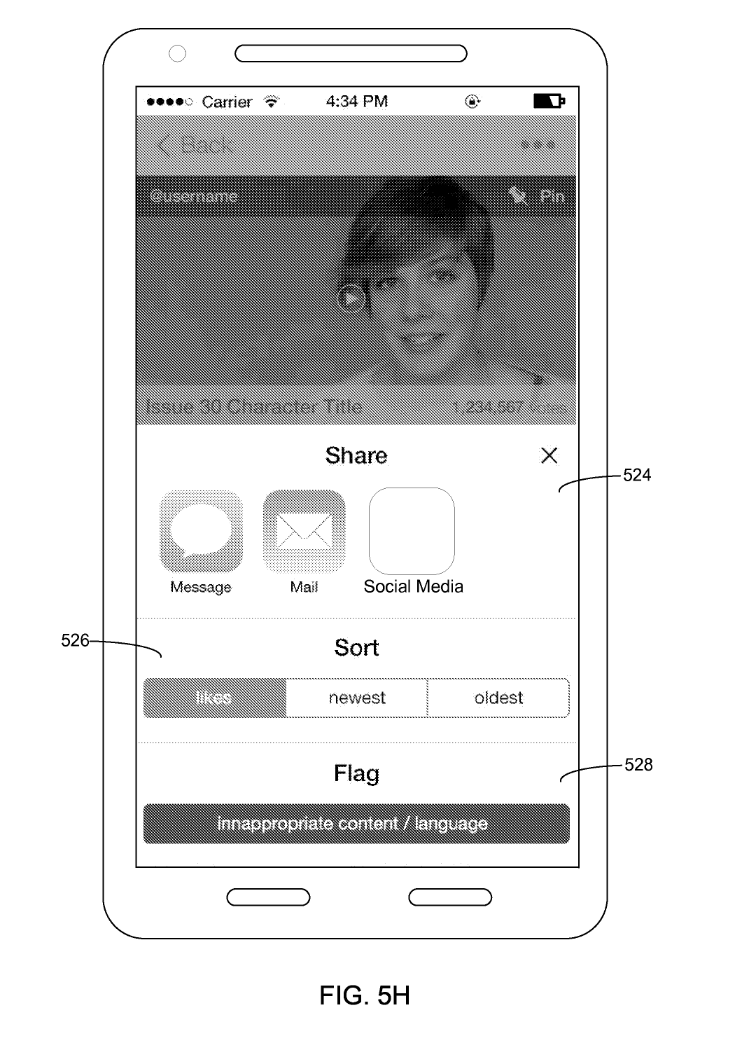

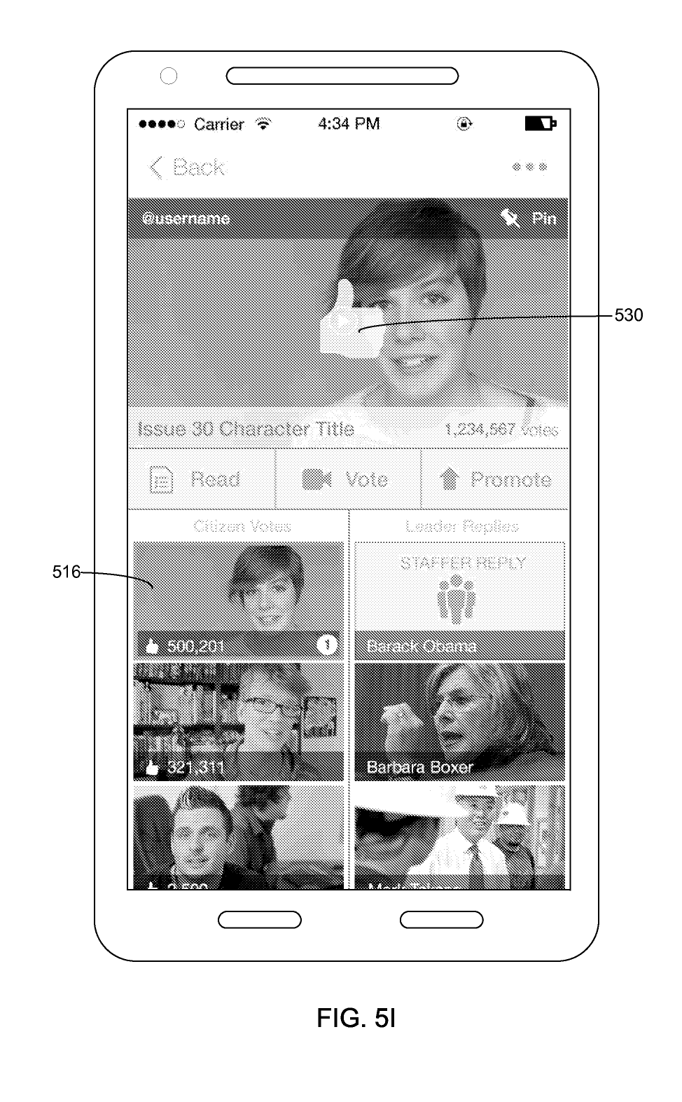

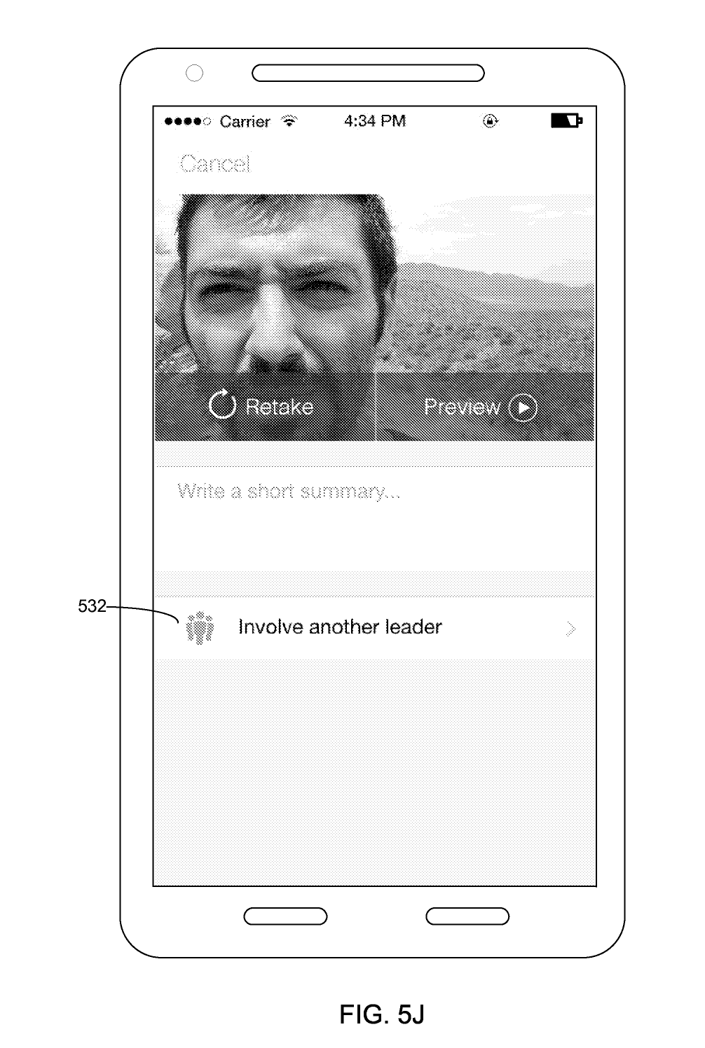

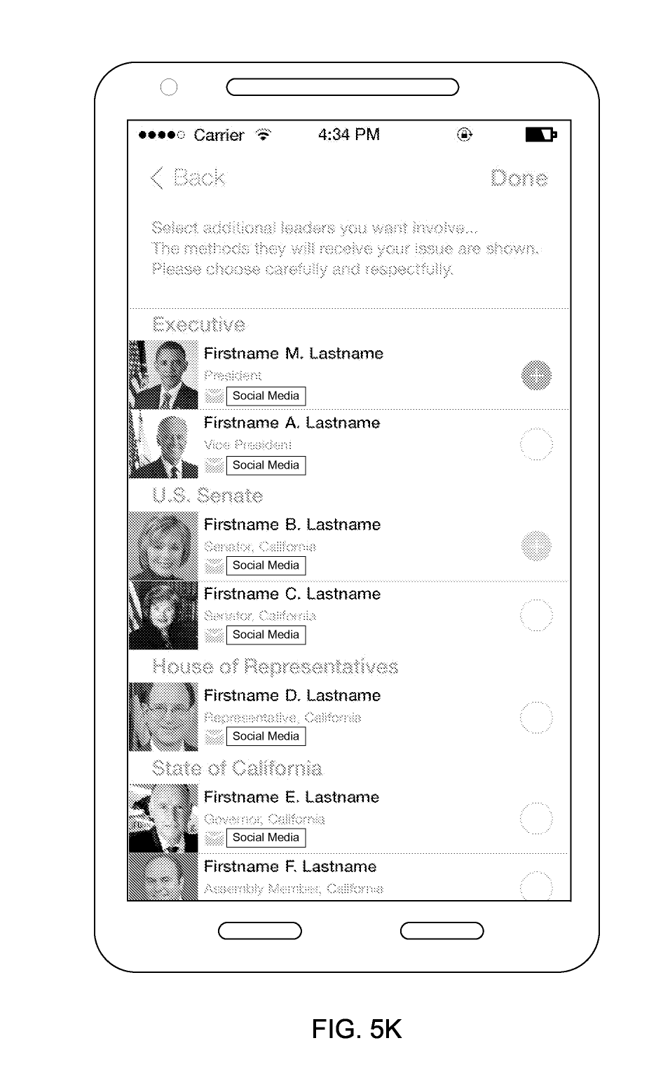

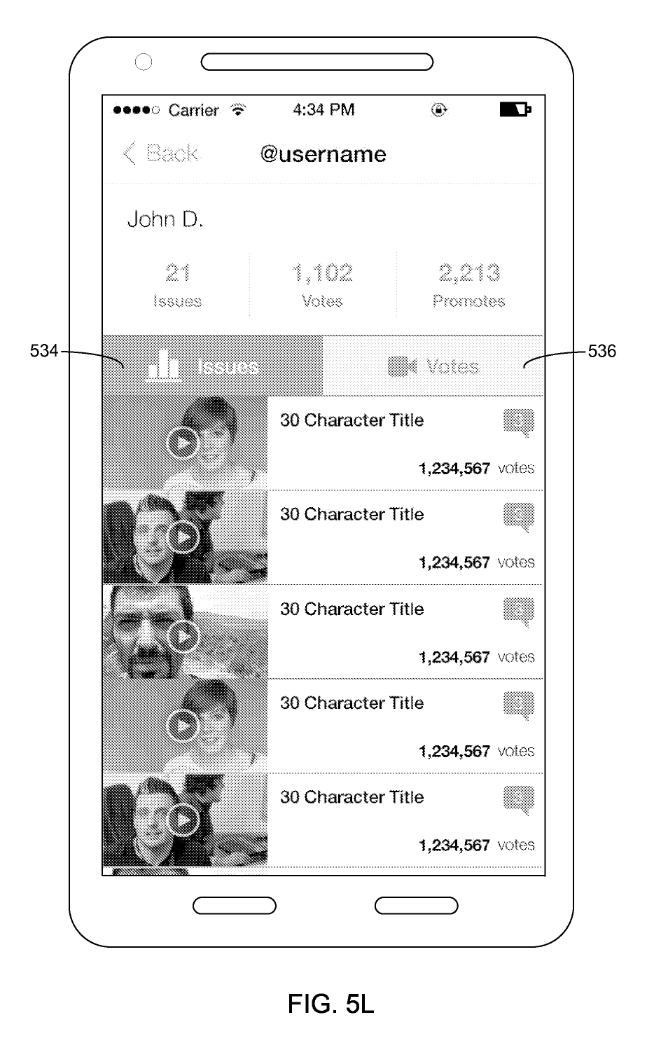

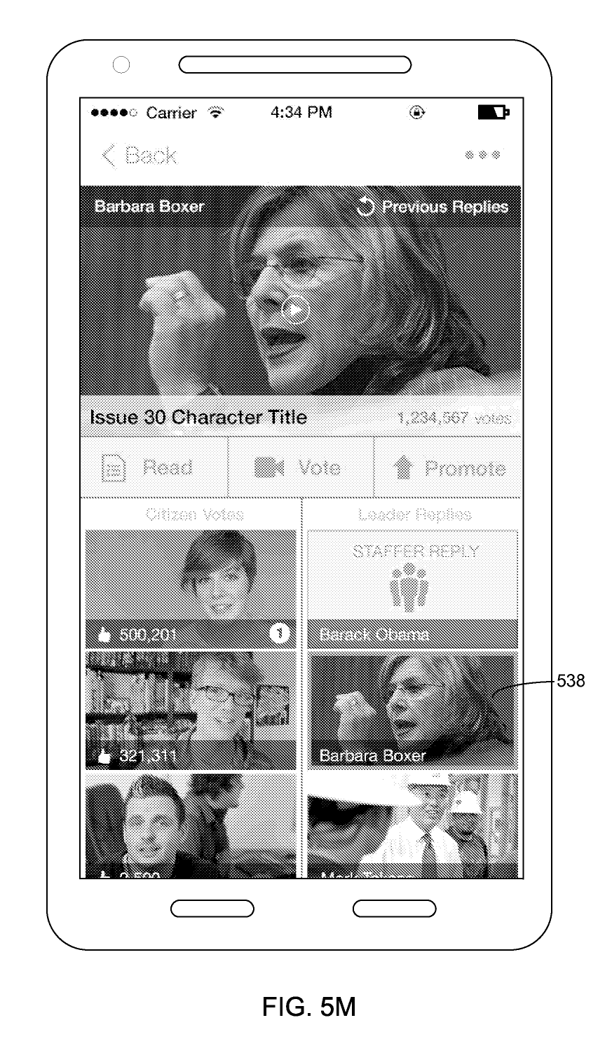

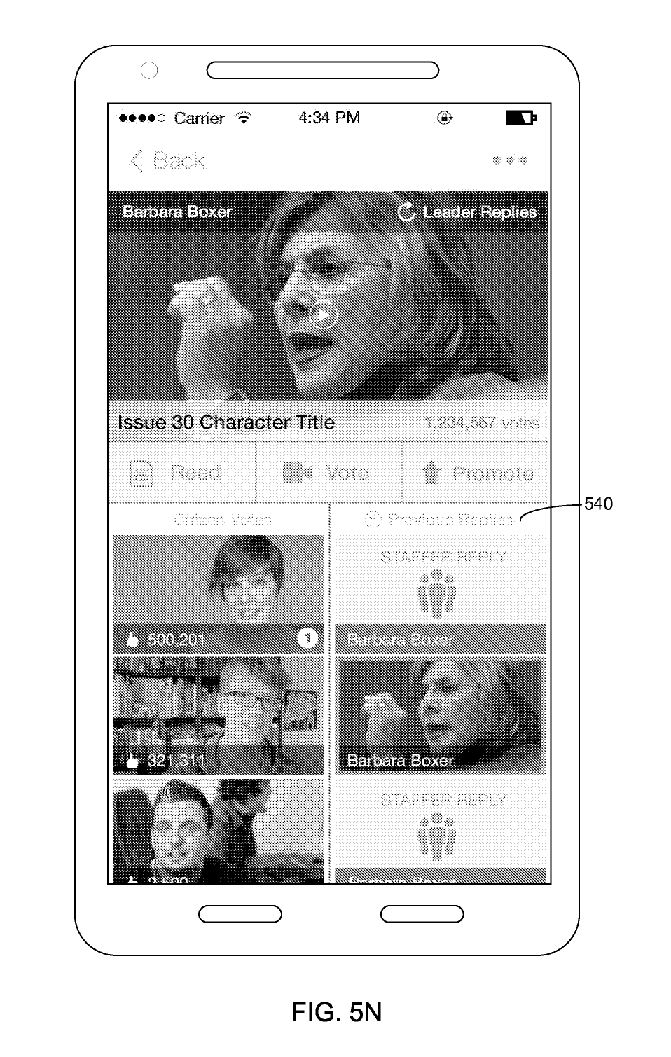

FIGS. 5A-N are diagrams depicting exemplary graphical user interfaces that display videos captured by other users and that are generated by an application executed by the citizen device 110 and/or one or more society devices 150 of the communications system 100 of FIG. 1. As illustrated in FIG. 5A, the application can provide a set of menu buttons at the bottom of the display. A first menu button can be a ranking button 502. When the ranking button 502 is selected, a series of videos or other messages generated by other users are displayed. For example, the videos or other messages can be organized by issues or topics, can include who generated the video or other message and where the video or other message was generated, a number of votes and/or promotions that the video or other message has received, and/or whether the user has pinned (e.g., bookmarked) a particular video or other message. In an embodiment, the initial video or other message displayed for each issue can be set based on a ranking. For example, each video or other message within each issue category may be ranked based on views, likes, votes, promotes, and/or the like. The highest ranked video or other message within each issue may initially be displayed in the application, as illustrated in FIG. 5A.

Selecting a video or other message can provide more information. For example, if video 504 is selected, the application can display a graphical user interface as illustrated in FIG. 5B. Here, the user can read a title and/or description of the video or other message by selecting read button 506 (e.g., as illustrated in FIG. 5C), vote for the video or other message by selecting vote button 508, and/or promote the video or other message by selecting promote button 510. The user can also see which public officials and/or challengers are associated with the video by selecting the read button 506 (e.g., as illustrated in FIG. 5C). In an embodiment, selecting the vote button 508 prompts the user to capture a video as illustrated with respect to FIGS. 4A-B. In a further embodiment, videos or other messages generated by users that have voted for the video or other message are available for viewing in area 512.

As illustrated in FIG. 5D, the user can search for issues via search field 514. Videos associated with the search term entered in the search field 514 may appear below the search field 514.

In an embodiment, selecting a video or other message results in the display of additional videos. For example, as illustrated in FIG. 5E, the selection of video 516 may result in a display of thumbnails of additional videos or other messages submitted in response to the video 516. The order of the additional videos or other messages may depend on the number of votes, promotes, and/or other criteria set by the user, as described below. In addition, the selection of video 516 may result in a display of thumbnails of videos or other messages submitted by public officials, staffers of public officials, or challengers in response to the video 516. In an embodiment, a picture of the public official or challenger appears in the thumbnail when the response is created by the public official or challenger. However, a picture of a public official or challenger may not appear if the response is created by a staffer of the public official or challenger to highlight those responses that are created by public officials or challengers. As described herein, a user may pin a video by selecting pin button 518.

As illustrated in FIG. 5F, if a user has voted for and promoted a video or other message, the user may receive such an indication. For example, if a user has voted for and promoted the video 516, field 520 may indicate this. Likewise, as illustrated in FIG. 5G, if a user has only promoted a video or other message, the user may receive such an indication. For example if a user has only promoted the video 516, field 522 may indicate this.

As illustrated in FIG. 5H, a user may share a video or other message via an electronic message (e.g., a text message, an electronic mail, etc.) or a social media platform by selecting the appropriate button in window 524. Furthermore, a user may be able to sort videos or other messages that are displayed based on a number of likes that the video or other message has received and/or a date that the video or other message was created by selecting the appropriate button in window 526. In addition, a user may be able to flag a video or other message for inappropriate content and/or language by selecting the button in window 528.

In an embodiment, a user may like a video or other message by selecting a button and/or by tapping (e.g., double-tapping, triple tapping, etc.) a video or other message. For example, the video 516 may be double-tapped and a like icon 530 may appear to indicate that the user has liked the video 516.

As described herein, a user may vote for a video or other message, such as the video 516, by capturing a video or other message to add further commentary to the commentary provided in the voted-for video or other message. As illustrated in FIG. 5J, once the video or other message has been captured by the user for the purpose of voting for another video or other message, the user may receive an option to involve additional public officials or challengers to the issue via button 532. As illustrated in FIG. 5K, selecting button 532 provides the user with an option to choose additional public officials or challengers. In an embodiment, the user cannot select a public official or challenger who is already associated with the issue. A public official and/or challenger may be notified that he or she has been involved or associated with an issue via an electronic message, social media, and/or the like.

In an embodiment, a user may select the name or username of a person that captured a video or other message. As illustrated in FIG. 5L, upon the selection of the name or username, the user may be able to view a number of issues the person is involved with, a number of votes the person has received, a number of promotes the person has received, a list of the videos or other messages captured by the person (e.g., via the selection of button 534), and/or a list of the videos or other messages captured by others for the purpose of voting for a video or message captured by the person (e.g., via the selection of button 536).

As illustrated in FIG. 5M, a user can select a video or other message captured by a public official or a challenger in response to another video or other message. For example, the user can select the video 538 captured by a public official. The video 538 may appear near the top of the interface upon the selection and can be played by the user. In addition, as illustrated in FIG. 5N, upon the selection, the interface may display additional videos captured by that public official or challenger (e.g., in box 540).

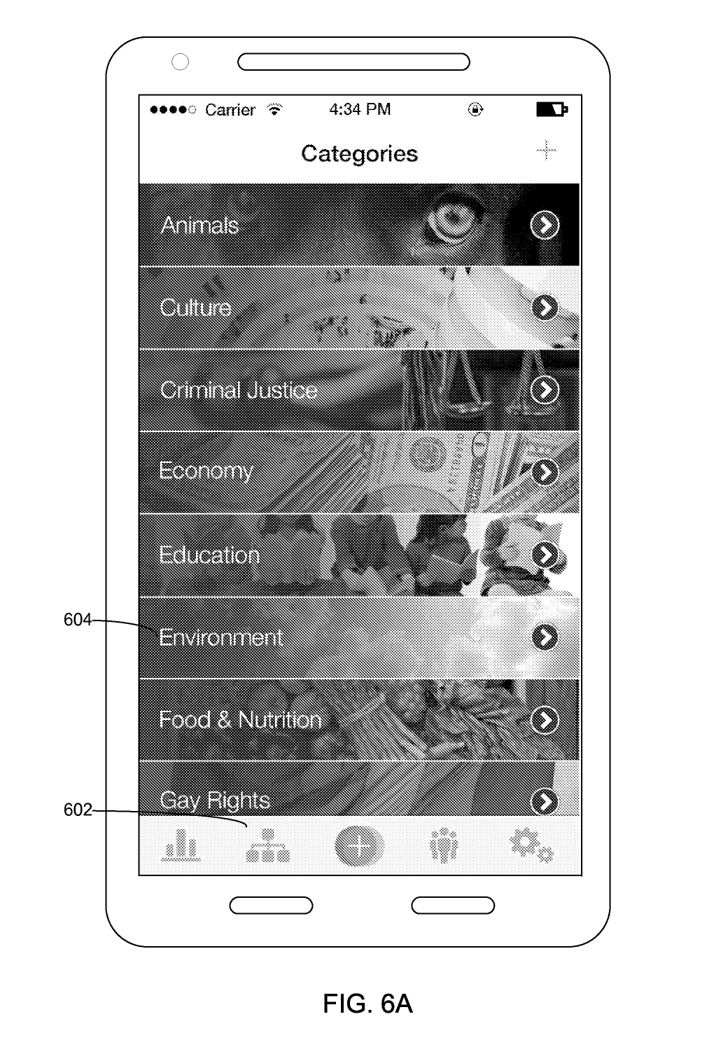

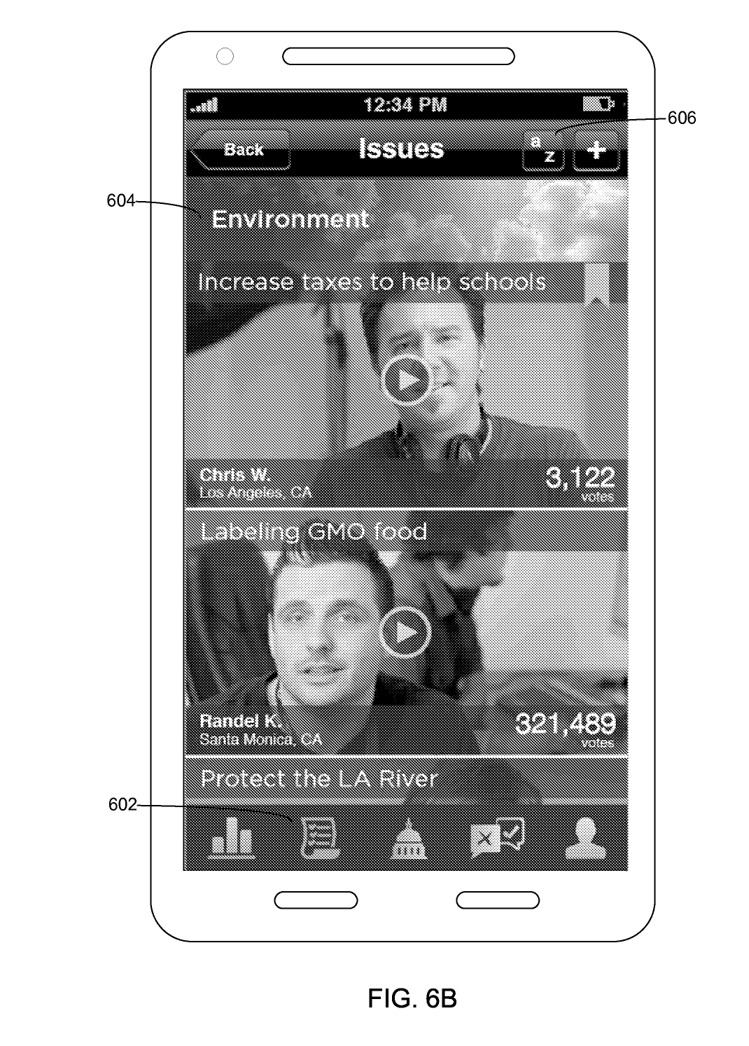

FIGS. 6A-B are diagrams depicting exemplary graphical user interfaces that display political issues and that are generated by an application executed by the citizen device 110 and/or one or more society devices 150 of the communications system 100 of FIG. 1. As illustrated in FIG. 6A and described above, the application can provide a set of menu buttons at the bottom of the display. A second menu button can be an issues button 602. When the issues button 602 is selected, a list of categories of political issues is displayed. For example, some categories can include animals, culture, criminal justice, economy, education, environment, food and nutrition, gay rights, etc.

If a category is selected, sub-categories can be displayed. In addition or alternatively, if a category is selected, a list of videos or other messages associated with the category are displayed (e.g., as illustrated in FIG. 6B). For example, if the environment category 604 is selected, the environment category 604 can be displayed along with a list of the videos or other messages associated with the category 604. As described above, the list can include who generated the video or other message and where the video or other message was generated, a number of votes and/or promotions that the video or other message has received, and/or whether the user has pinned or bookmarked a particular video or other message. In addition, each video or message can include a title that describes the political issue associated with the category.

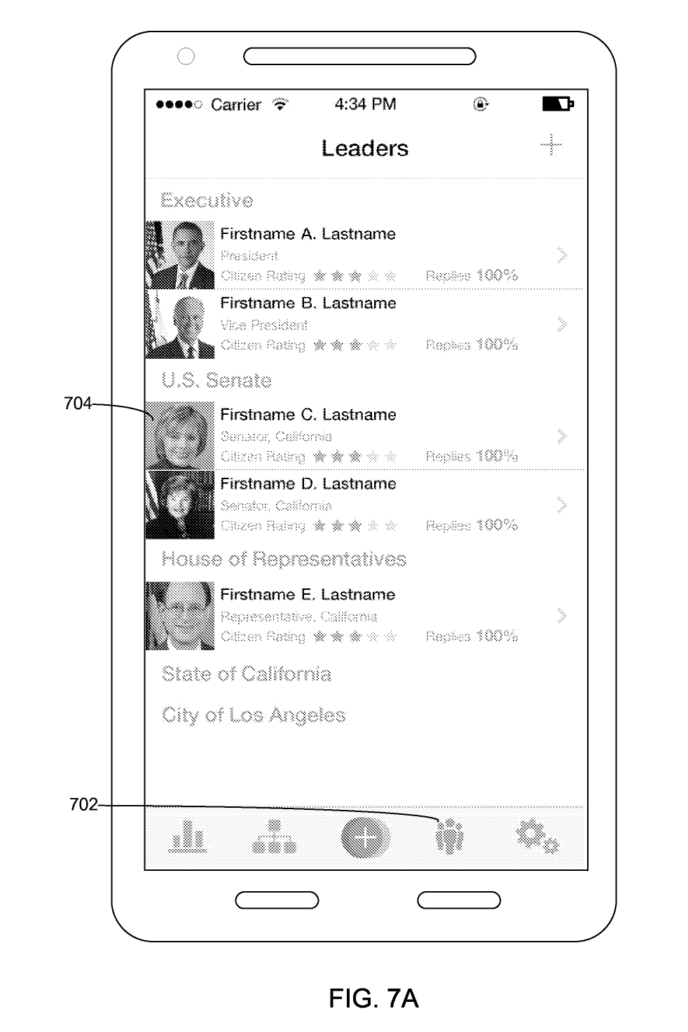

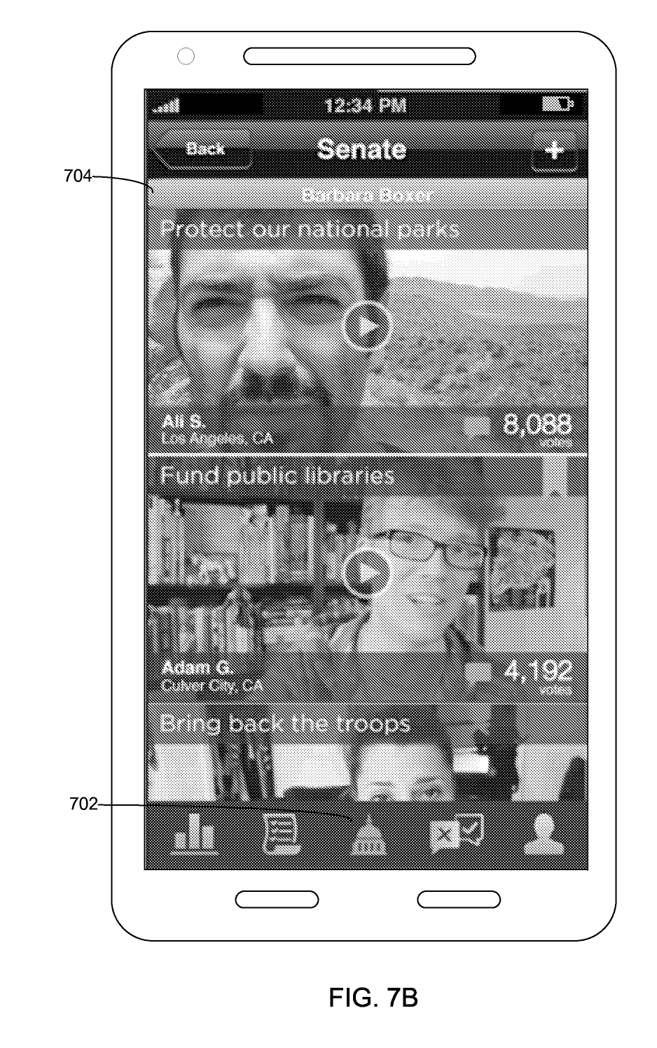

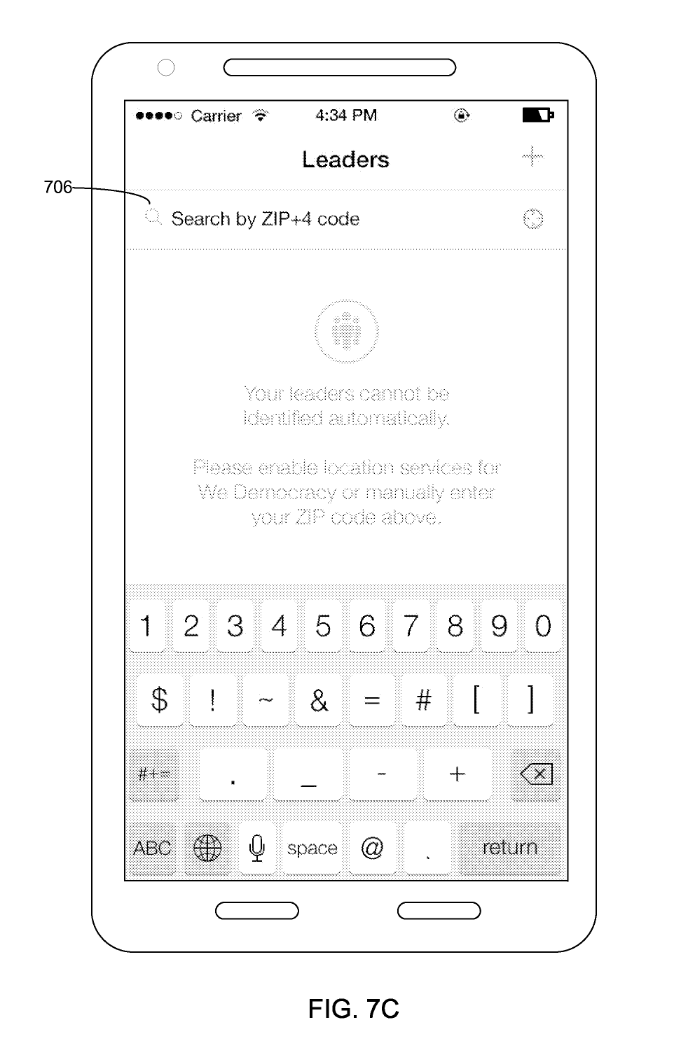

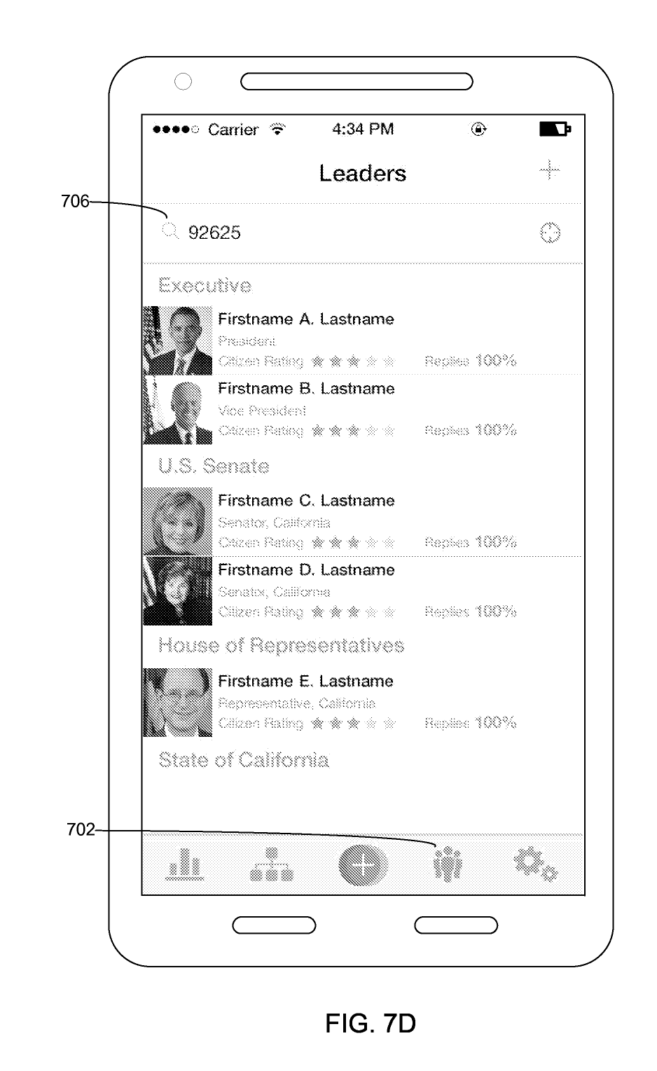

FIGS. 7A-D are diagrams depicting exemplary graphical user interfaces that display a list of public officials and that are generated by an application executed by the citizen device 110 and/or the one or more society devices 150 of the communications system 100 of FIG. 1. As illustrated in FIG. 7A and described above, the application can provide a set of menu buttons at the bottom of the display. A third (or fourth) menu button can be a leader button 702. When the leader button 702 is selected, a list of public officials and/or a list of challengers is displayed. The listing can include the name of the public official or challenger, the title of the public official or challenger, a rating of the public official or challenger (e.g., given as a star rating, a number rating, etc.), and/or a percentage of messages that the public official or challenger responds to.

In an embodiment, the public officials or challengers provided in the list are selectable. In an embodiment, as illustrated in FIG. 7B, selecting a public official or challenger displays a list of videos or other messages that are directed to issues associated with the public official or challenger and/or that have been sent to the public official or challenger. For example, Barbara Boxer can be chosen by selecting button 704, which causes the application to display videos or other messages directed to political issues associated with her jurisdiction.

In an embodiment, as illustrated in FIGS. 7C-D, the user receives a list of public officials and/or challengers by entering a zip code or address in field 706. Public officials and/or challengers may be automatically identified based on the entered zip code or address (e.g., by identifying the jurisdiction associated with the zip code or address and identifying public officials and/or challengers associated with the identified jurisdiction).

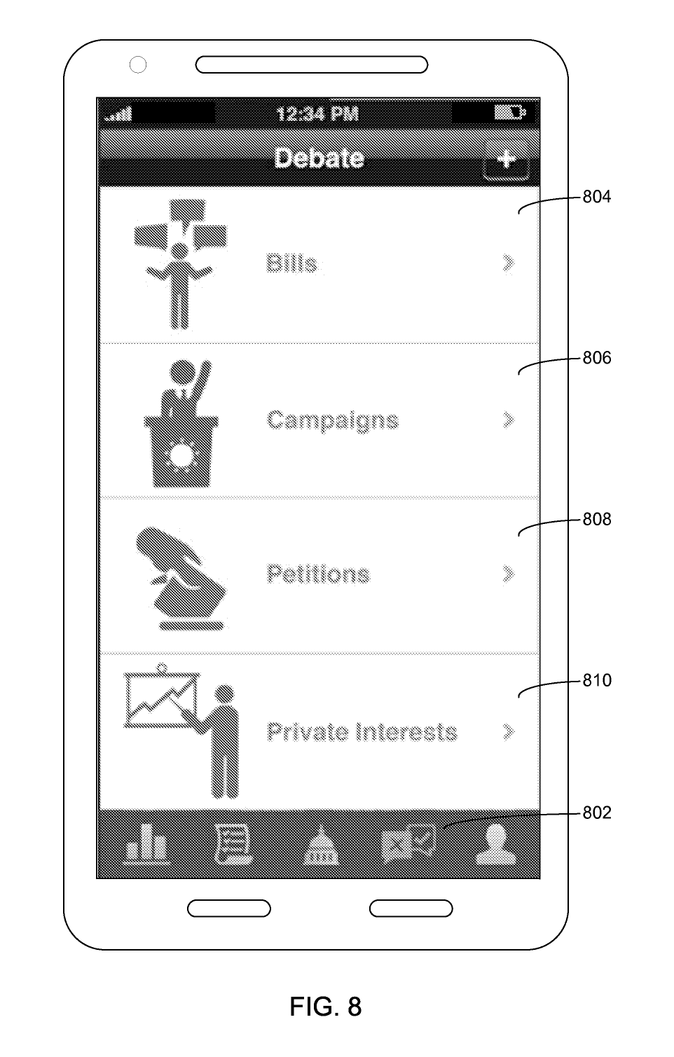

FIG. 8 is a diagram depicting an exemplary graphical user interface that displays information on bills, campaigns, petitions, and diverse points of view and that is generated by an application executed by the citizen device 110 and/or the one or more society devices 150 of the communications system 100 of FIG. 1. As illustrated in FIG. 8 and described above, the application can provide a set of menu buttons at the bottom of the display. A fourth menu button can be a debate button 802. When the debate button 802 is selected, the user is able to select from four options: a bills button 804, a campaigns button 806, a petitions button 808, and/or a private interests button 810.

In an embodiment, the bills button 804, when selected, provides the text of proposed bills, bills pending approval in a legislature, and/or approved bills. Selecting the bills button 804 can also provide information regarding the bills, such as vote counts, amendments, and the like. In a further embodiment, the campaigns button 806, when selected, provides campaign information, such as platforms (e.g., in text, audio, and/or video), testimonials, candidate histories, campaign schedules, and any other information pertinent to a campaign. In a further embodiment, the petitions button 808 provides information on petitions that are proposed or have been submitted, such as the text of the petition, number of signatures, the party or parties that created the petition, and/or links to petition webpages (e.g., the White House petition webpage). In a further embodiment, the private interests button 810, when selected, provides information (e.g., text, audio, and/or video) provided by private parties that have an interest in a particular issue or topic. Such information provided when selecting the debate button 802 can be provided by the democracy server 140.

In some embodiments, not shown, the debate button 802 allows a user to view and participate in a debate between public officials and/or challengers. For example, a user may be able to submit a question (e.g., in the form of a captured video or other message) to be answered by a public official or challenger. Likewise, a news organization or an interested party (e.g., a corporation, a for-profit organization, a non-profit organization, a lobbyist, etc.) may be able to submit a question using one or more society devices 150. In some embodiments, a news organization or an interested party may pay a licensing fee in order to participate in the debate or cover the proceedings of the debate. A public official or challenger, using the government device 135, may be able to reply to a submitted question for some or all users to see. Thus, the application may allow a user to participate in a town hall-style debate via the citizen device 110 and/or the one or more society devices 150.

In some embodiments, not shown, the debate button 802 allows a user to view educational materials. For example, information on basic civics, complex civics, political science, and/or the like may be provided. In addition, information on sub-courses, such as philosophy, history, and/or the like may be provided. Furthermore, young users, such as children, may be able to play games to learn more about civics and/or the various issues that other users have commented on. The game may include questions or case studies that young users can answer or solve and/or allow young users to pose questions. Such answers or questions may be transmitted to a separate kids account on a government device 135 to be checked or answered by a public official, a challenger, or a staffer.

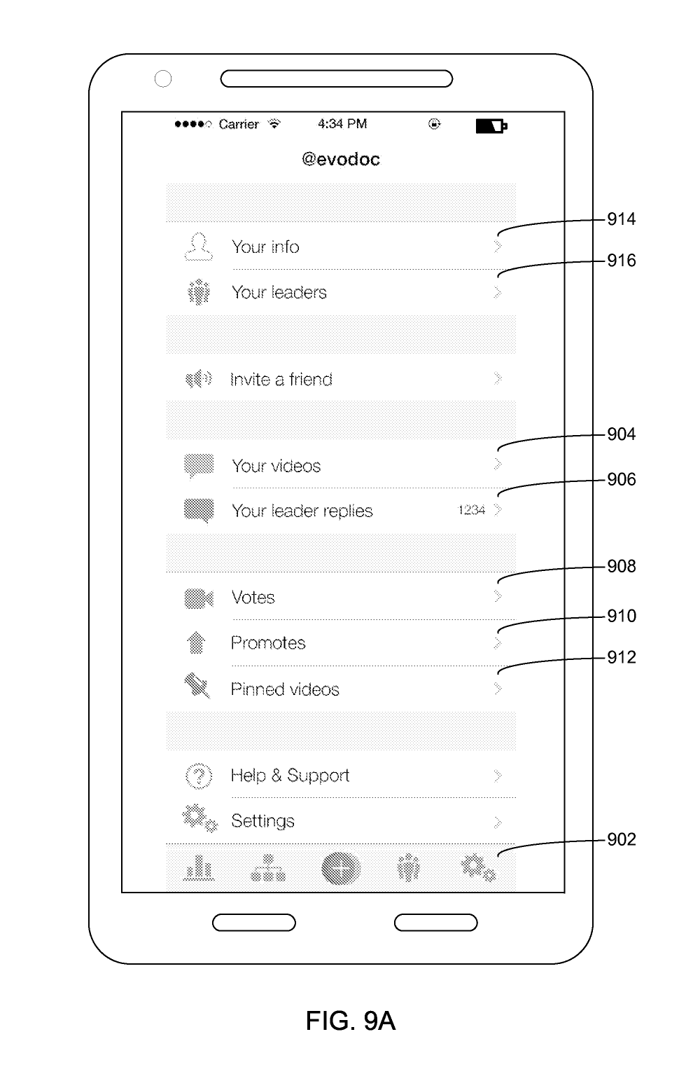

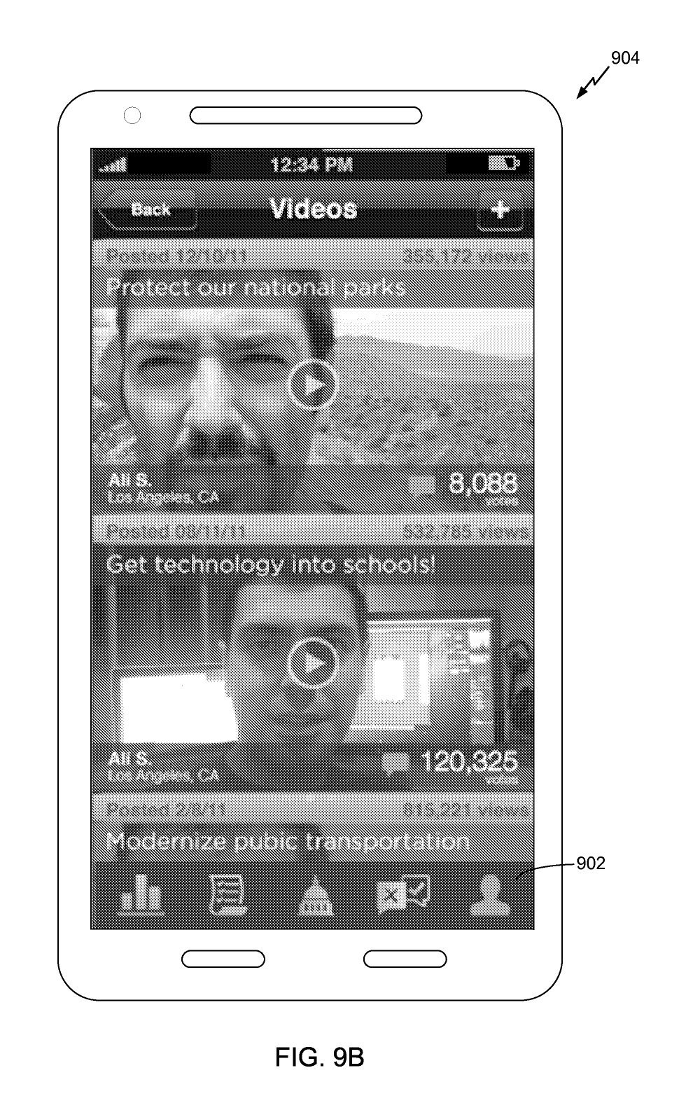

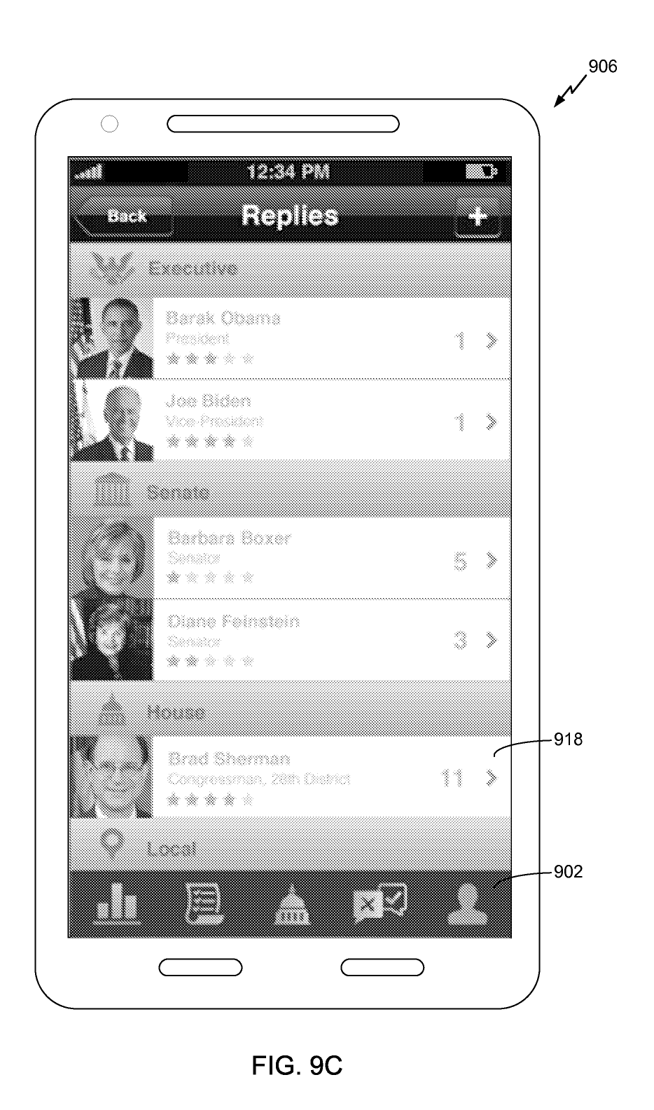

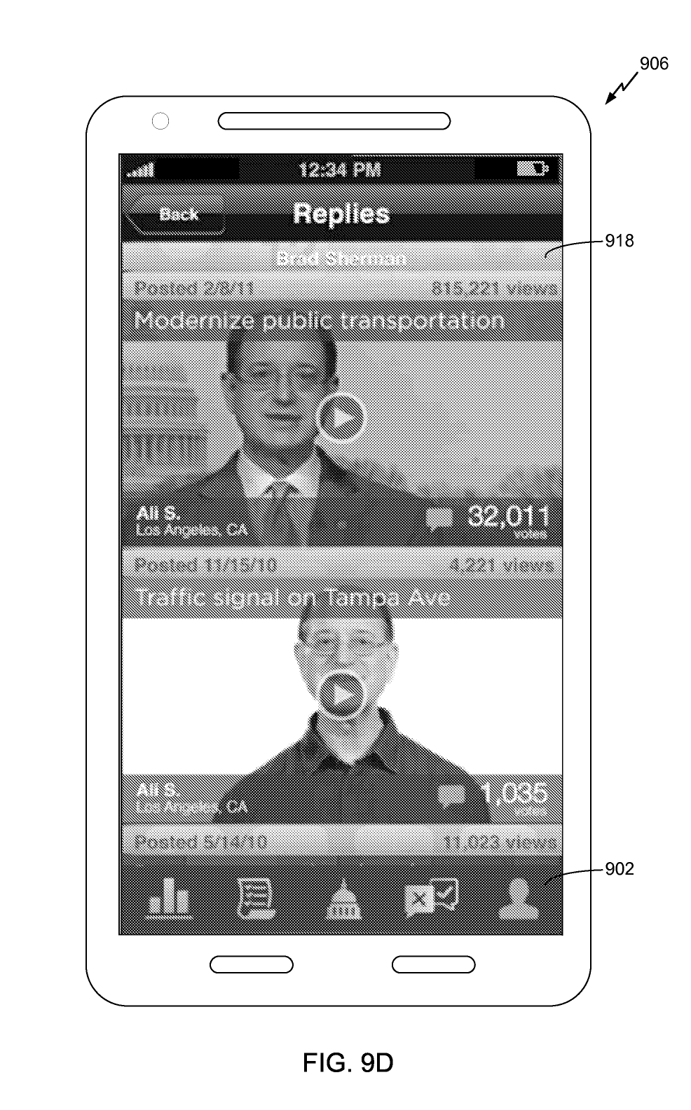

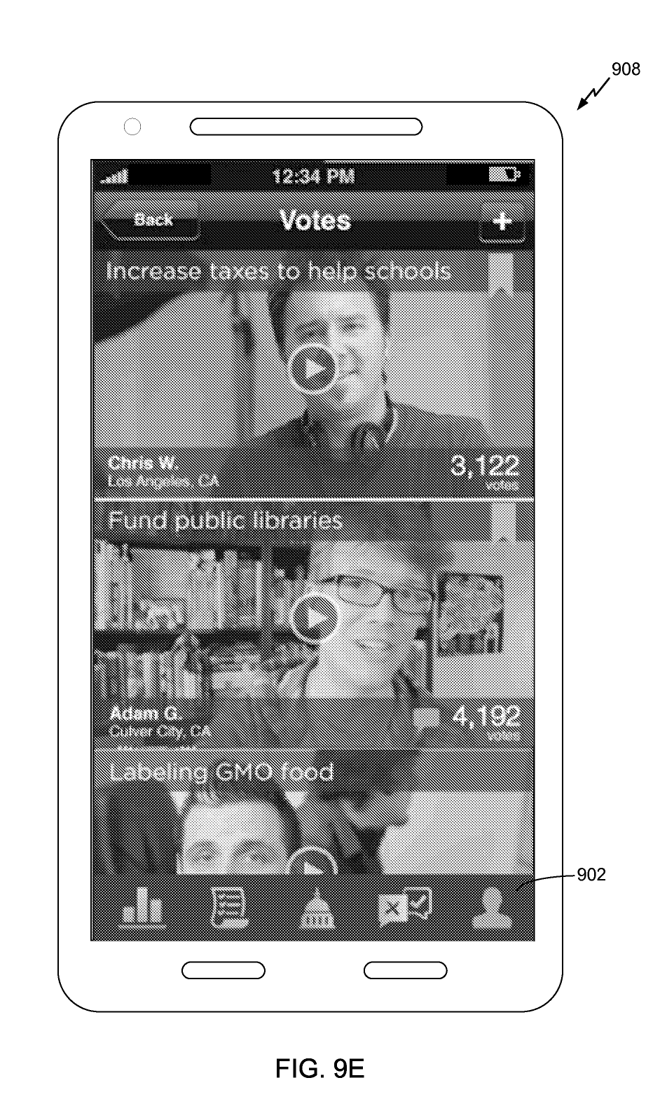

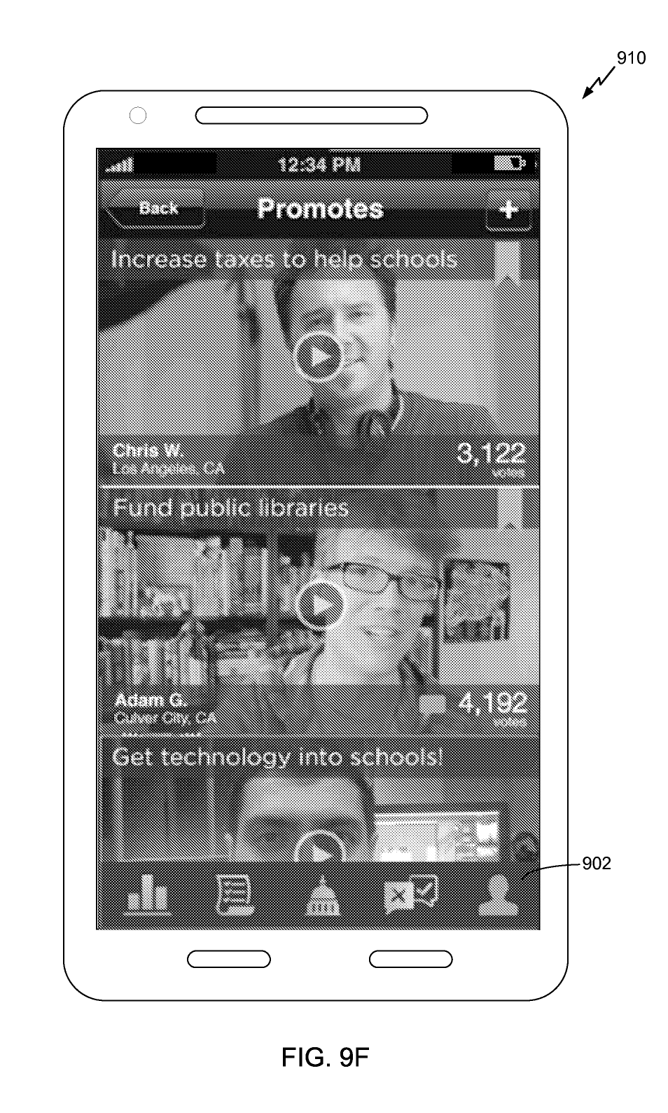

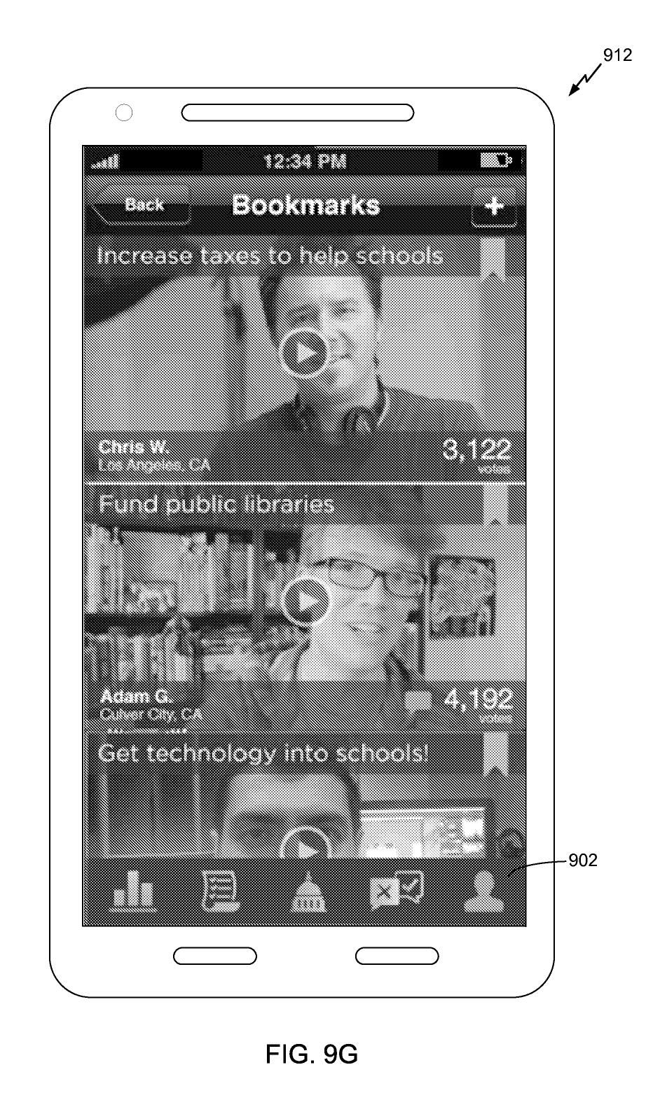

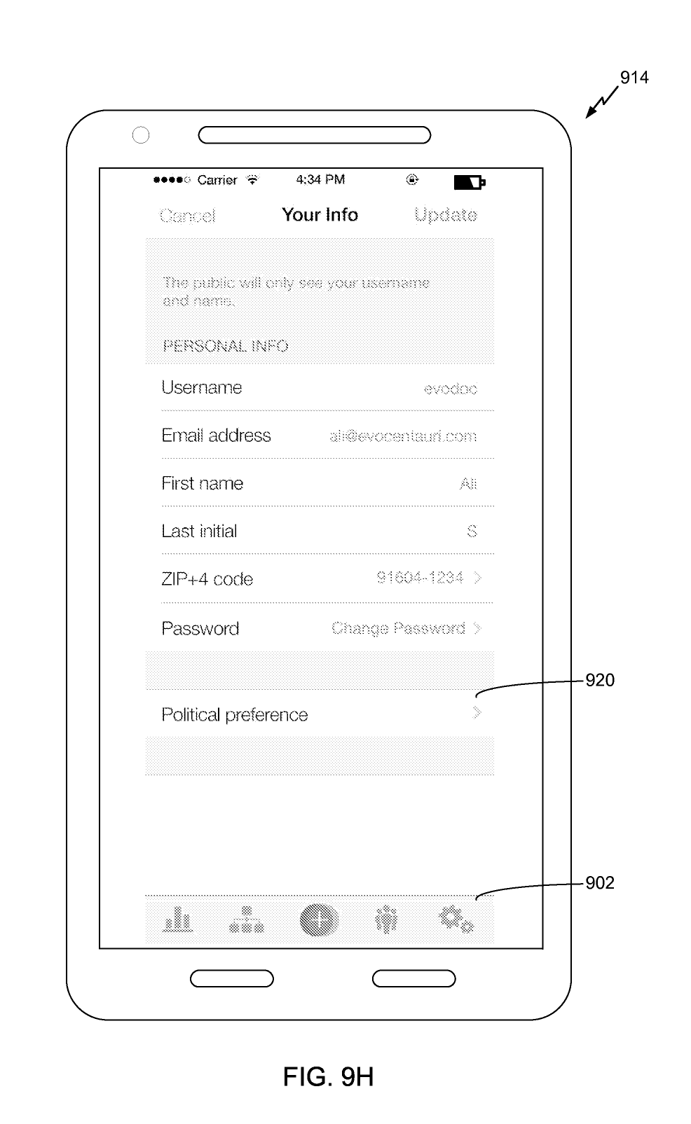

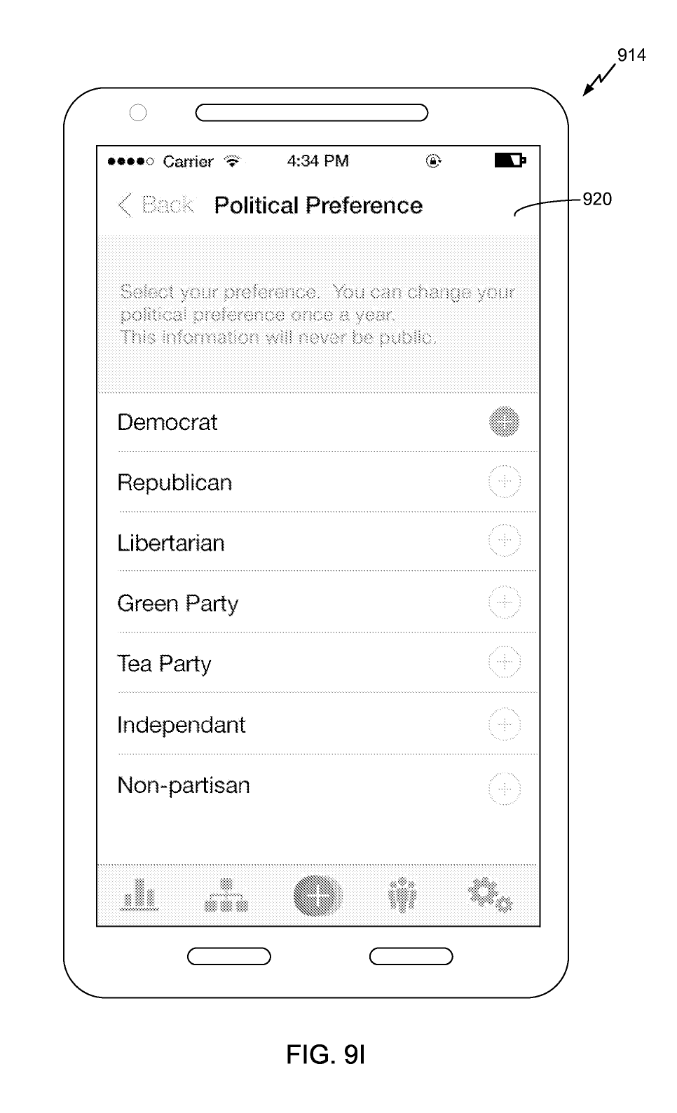

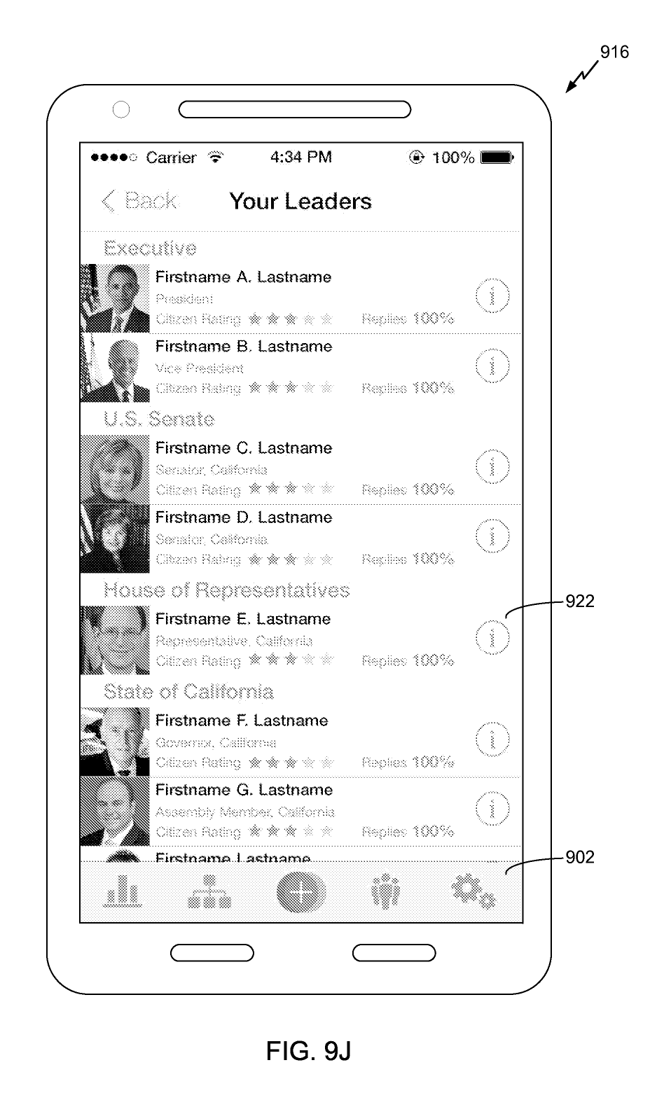

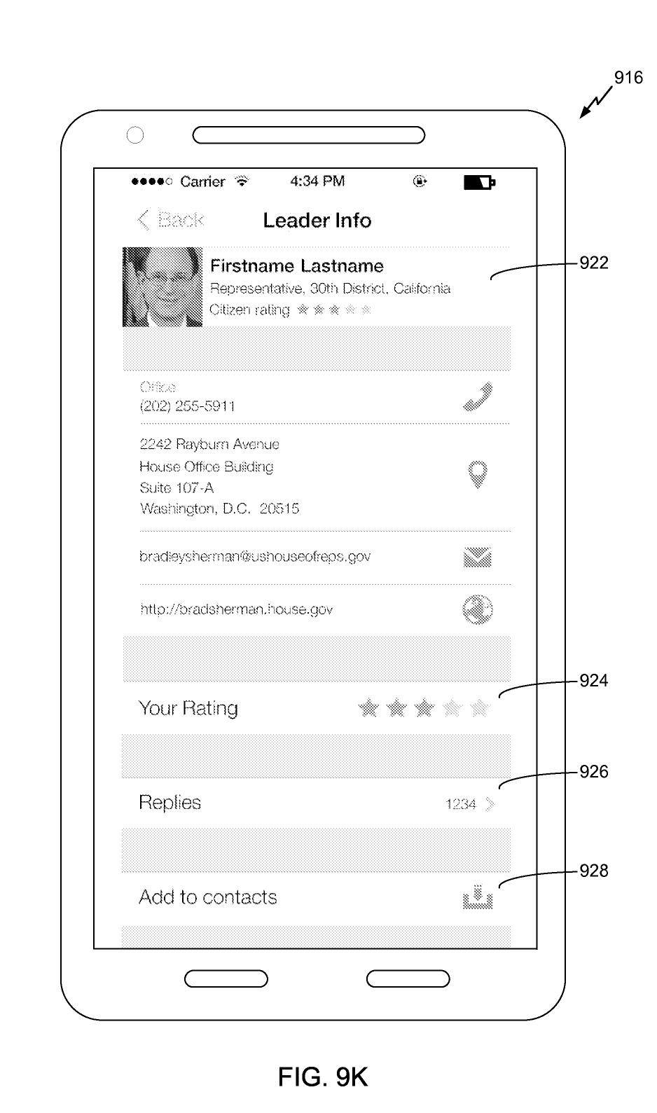

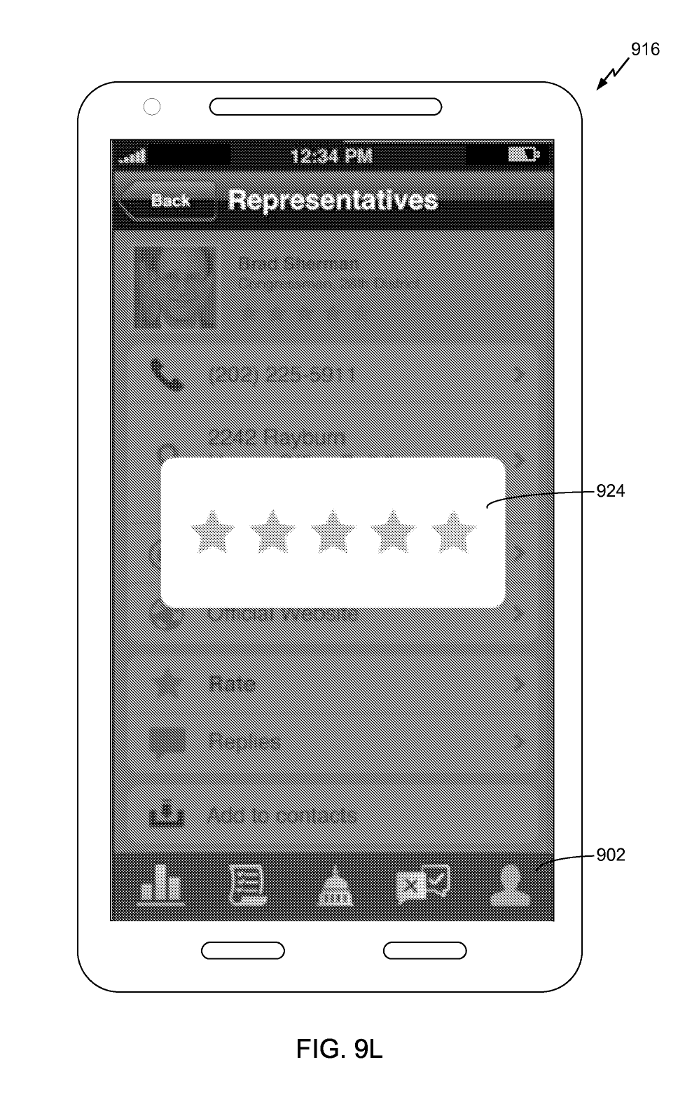

FIGS. 9A-L are diagrams depicting exemplary graphical user interfaces that display a user profile and that are generated by an application executed by the citizen device 110 and/or one or more society devices 150 of the communications system 100 of FIG. 1. As illustrated in FIG. 9 and described above, the application can provide a set of menu buttons at the bottom of the display. A fifth menu button can be a user button 902. When the user button 902 is selected, the user is able to select view his or her profile. In an embodiment, the user profile includes seven menu buttons: a video button 904, a replies button 906, a votes button 908, a promotes button 910, a pin button 912, a profile button 914, and/or a representative button 916.

As illustrated in FIG. 9B, the application displays videos or other messages generated by the user when the videos button 904 is selected. Information associated with the videos or other messages can be provided, such as a title and/or political issue, a name of who took the video or other message and where the video or other message was taken, a number of views, and/or a number of votes.

As illustrated in FIG. 9C, the application displays a list of public officials and/or challengers that have replied to the user's videos or other messages when the replies button 906 is selected. As described above with respect to FIG. 7A, the listing can include the name of the public official or challenger, the title of the public official or challenger, a rating of the public official or challenger (e.g., given as a star rating, a number rating, etc.), and/or the number of messages generated by the user that the public official or challenger has responded to.

In an embodiment, selecting a public official or challenger from the list provides a list of videos or other messages generated by the public official or challenger in response to the video or other message generated by the user. For example, Brad Sherman can be chosen by selecting the button 918 and list of videos generated by Brad Sherman or staffers associated with Brad Sherman are displayed, as illustrated in FIG. 9D. In some embodiments, the videos include the date posted, the issue that the public official or challenger addresses, a number of views of the response, and/or the number of votes for the response.

As illustrated in FIG. 9E, the application displays a list of videos that the user has voted for when the votes button 908 is selected. As illustrated in FIG. 9F, the application displays a list of videos that the user has promoted when the promotes button 910 is selected. As illustrated in FIG. 9G, the application displays a list of videos that the user has bookmarked (or pinned) when the pin button 912 is selected.

As illustrated in FIG. 9H, the application displays fields for the user to provide his or her information when the profile button 914 is selected. In an embodiment, the user can provide his or her name, an email address, a zip code, and/or a political preference. For example, the user can select a political preference button 920 to choose his or her political preference. As illustrated in FIG. 9I, the user can select one or many possible political affiliations and/or choose no affiliation. In an embodiment, the selected political preference can affect the voting and promoting of videos. For example, if the user identifies with a first political preference and votes or promotes a video generated by another user that identifies with a second, different political preference, then the video generated by the another user can be weighted more heavily than if the video was voted for or promoted by a user with the same political preference as the another user (e.g., the video generated by the another user can increase its vote or promote count by two when voted for or promoted by a user with a different political preference and increase its vote or promote count by one when voted for or promoted by a user with the same political preference).

As illustrated in FIG. 9J, the application displays a list of public officials and/or challengers of which the user is a constituent. In an embodiment, the list includes national, state, and/or local public officials and/or challengers. The list can be based on the zip code and or other location provided by the user.

The public officials or challengers can be selected to provide the user with more information on the public official or challenger and/or to allow the user to rate the public official or challenger. For example, Brad Sherman can be chosen by selecting button 922. Upon selecting Brad Sherman, his contact information is provided as well as a link to his official website, as illustrated in FIG. 9K. In addition, the application allows the user to rate the public official or challenger by selecting ratings button 924, view replies generated by the public official or challenger by selecting replies button 926, and/or add the public official or challenger to the user's contact list by selecting contacts button 928. As an example, if the ratings button 924 is selected, a pop-up window or a window embedded in the previous window can appear and allow the user to rate the public official or challenger, as illustrated in FIG. 9L.

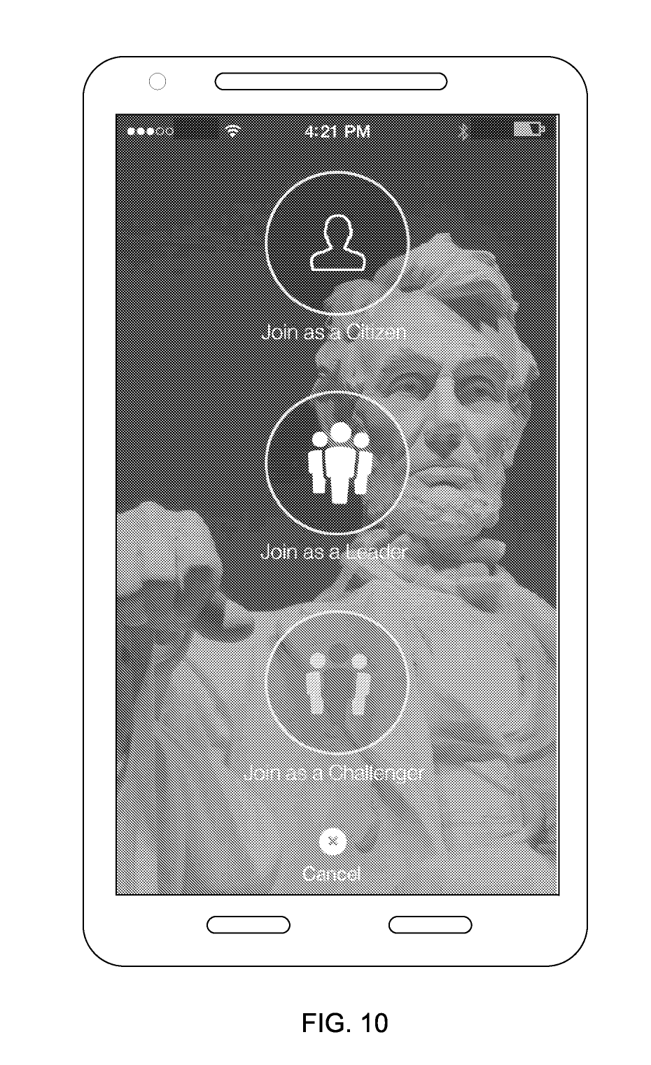

FIG. 10 is a diagram depicting an exemplary graphical user interface that displays an option to log into an application executed by the citizen device 110 and/or one or more society devices 150 of the communications system 100 of FIG. 1. As illustrated in FIG. 10, a user may join and log into the application as a citizen (e.g., a constituent), a leader (e.g., a public official), or a challenger (e.g., a person challenging a public official for office). As described herein, the corresponding user interfaces may vary depending on how a user logs into the application.

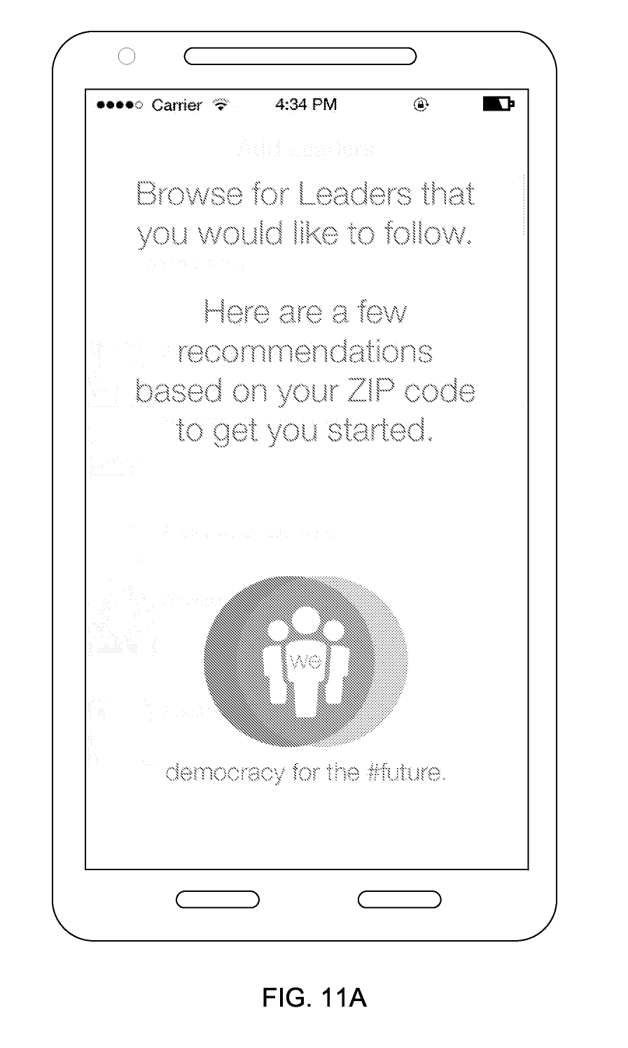

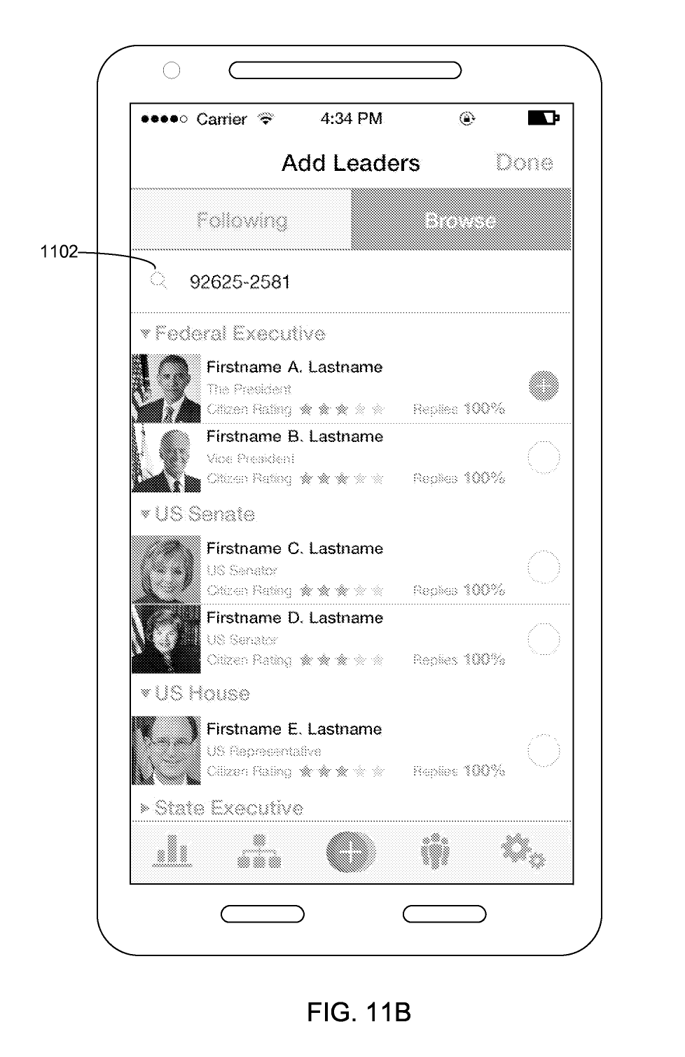

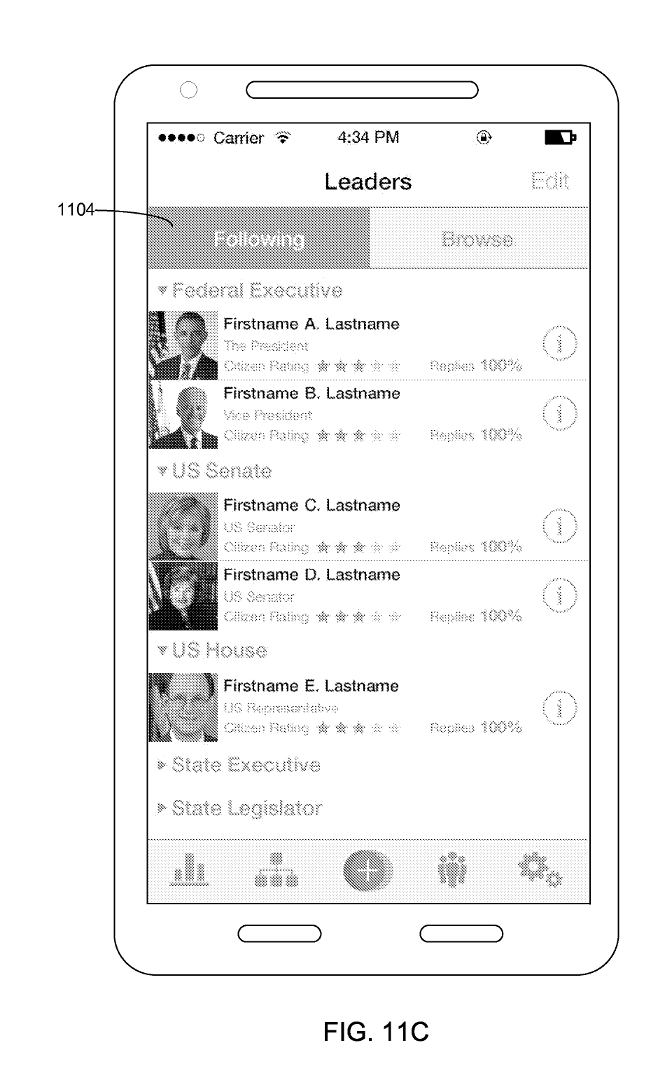

FIGS. 11A-C are diagrams depicting exemplary graphical user interfaces that display an option for following a public official or challenger using an application executed by the citizen device 110 and/or one or more society devices 150 of the communications system 100 of FIG. 1. As illustrated in FIG. 11A, a user can be prompted to enter a zip code or address. The user may enter the zip code or address in field 1102 as illustrated in FIG. 11B. Based on the entered zip code or address, the application may display a list of public officials and/or challengers that can be selected by the user, as illustrated in FIG. 11B. In an embodiment, the user can select button 1104 to view the public officials and/or challengers that the user is currently following, as illustrated in FIG. 11C. By following a public official and/or challenger, the user may be notified when the public official and/or challenger responds to a video or other message and/or performs another activity using the application.

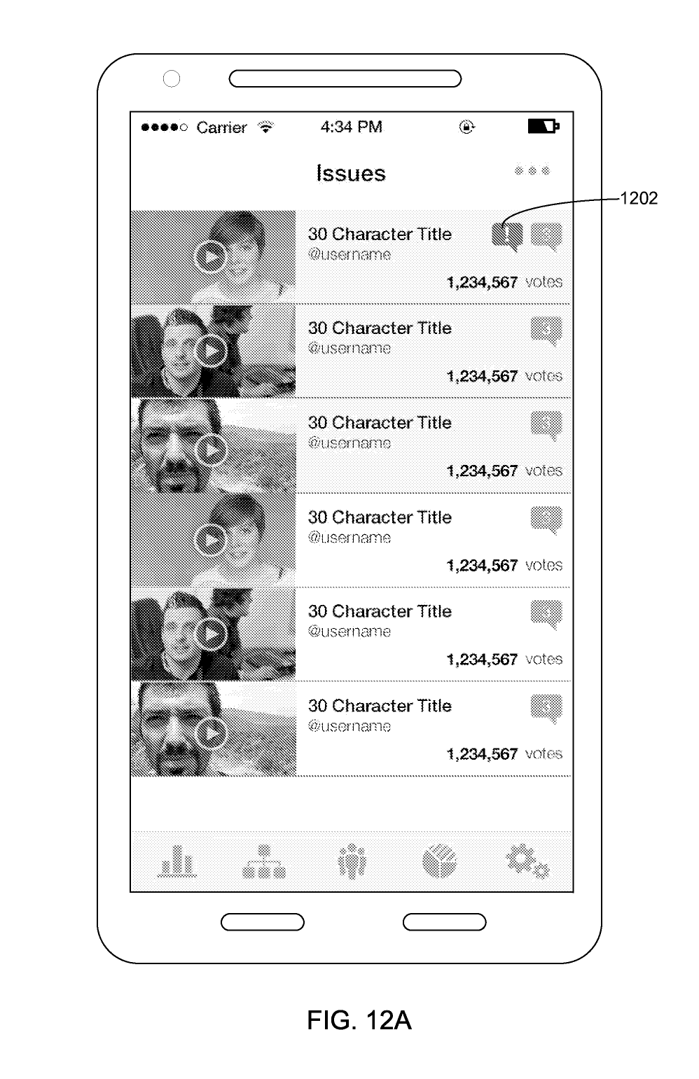

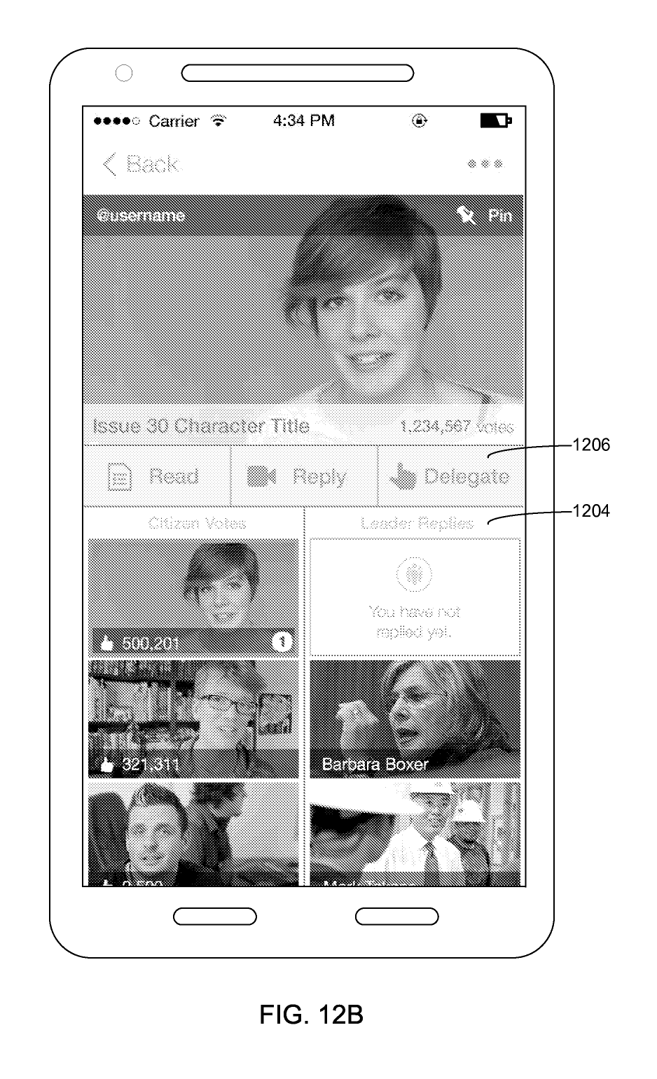

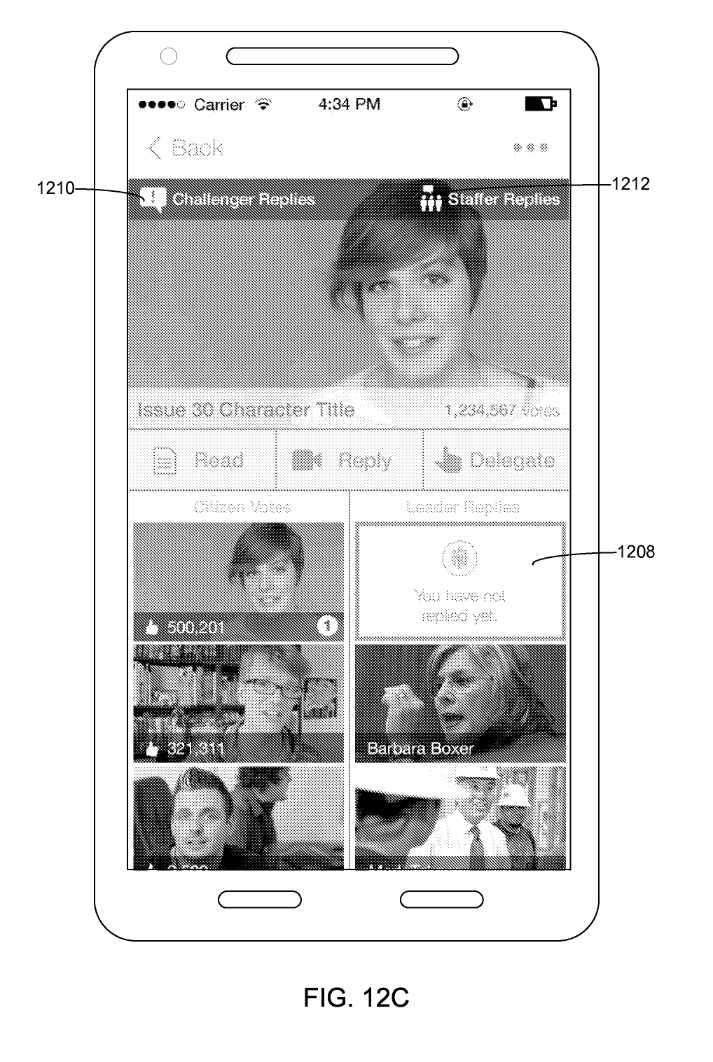

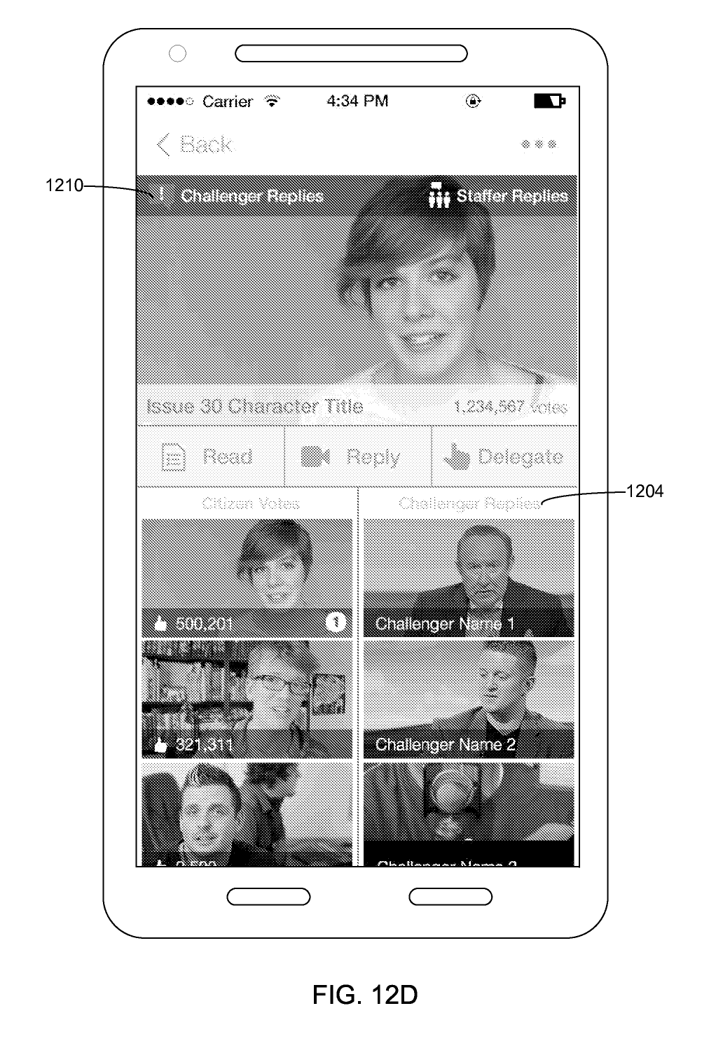

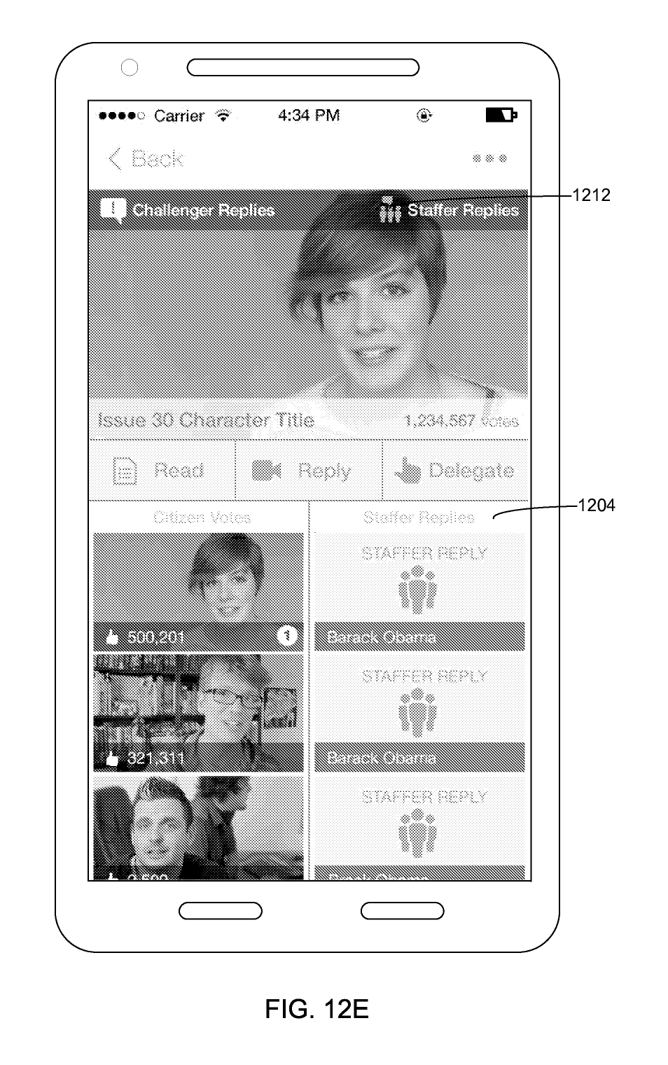

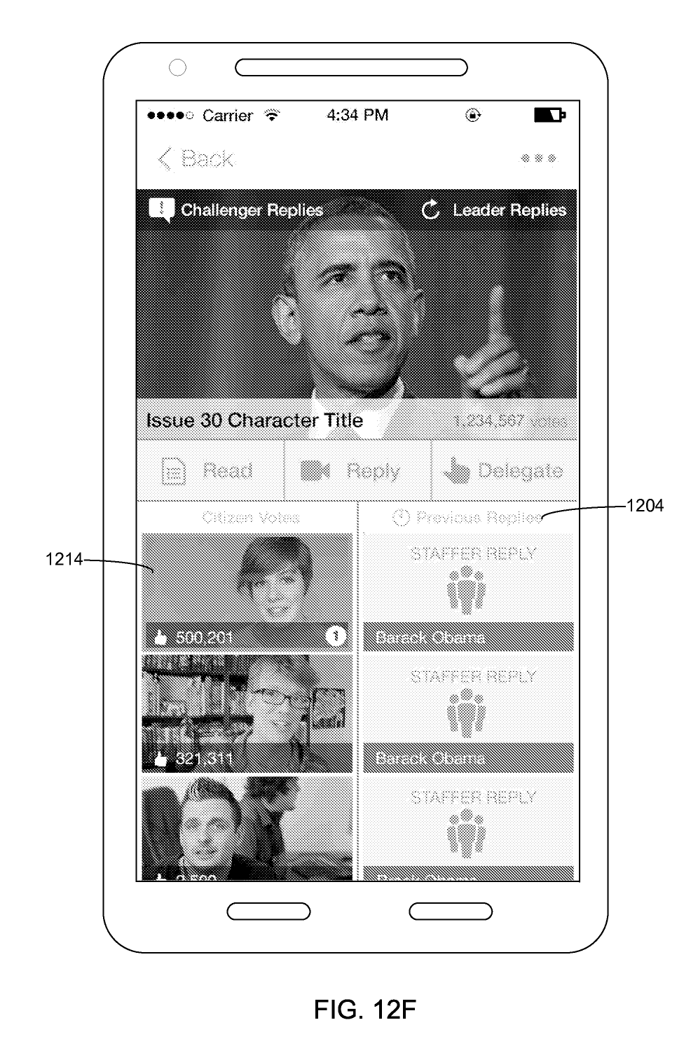

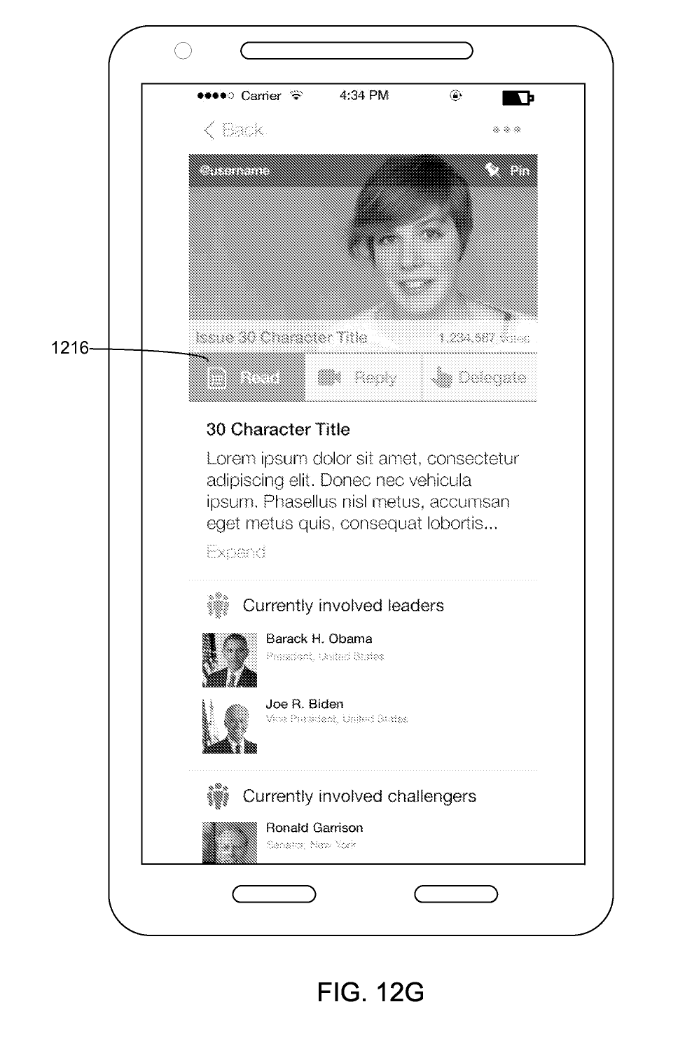

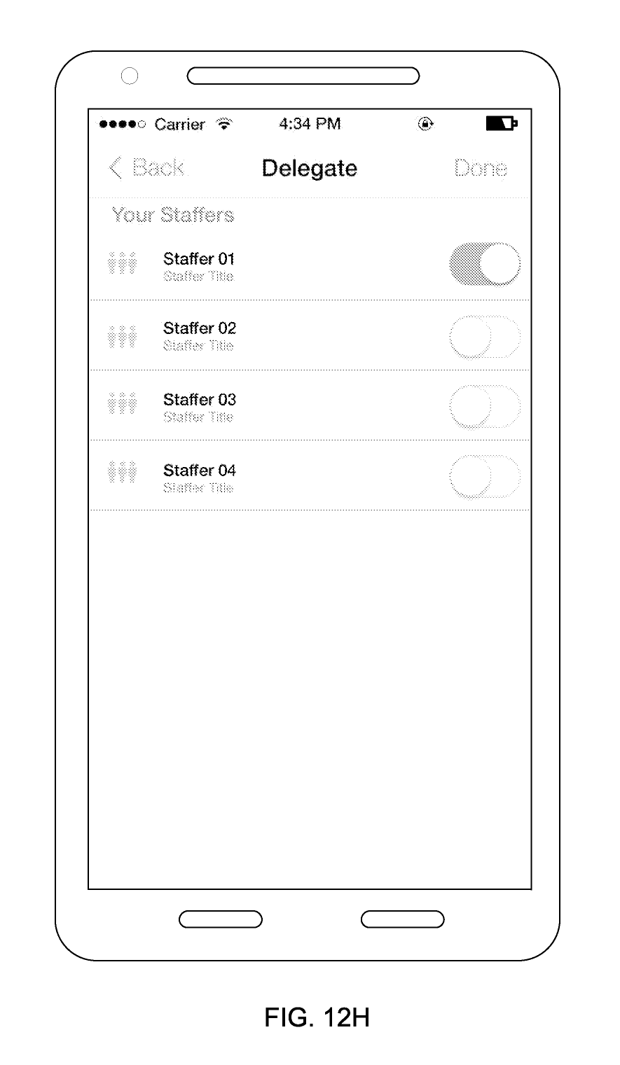

FIGS. 12A-I are diagrams depicting exemplary graphical user interfaces that display an application executed by the government device 135 of the communications system 100 of FIG. 1. As illustrated in FIG. 12A, a public official using the government device 135 may be able to view videos or other messages associated with an issue that the public official is involved with. In addition, the public official may be able to identify videos or other messages that have received a response from a challenger via notification 1202.

In an embodiment, as illustrated in FIG. 12B, a public official can select a video to view more information. For example, the public official can determine whether he or she has responded and see responses provided by other public officials and/or challengers in box 1204. If the public official has not responded, the public official may respond or delegate a staffer to respond via delegate button 1206 as illustrated in FIG. 12C. If message 1208, which indicates that the public official has not responded, is selected, the public official may be able to view responses provided by persons challenging that particular public official via button 1210 and/or responses provided by the public official's staffers via button 1212. For example, by selecting button 1210, the box 1204 may display responses captured by persons challenging the particular public official as illustrated in FIG. 12D. As another example, by selecting button 1212, the box 1204 may display responses captured by the public official's staffers as illustrated in FIG. 12E.

As illustrated in FIG. 12F, upon selecting a video or other message, such as video 1214, the box 1204 may display responses previously captured by the public official or the public official's staffers related to the issue associated with the video 1214. In addition, the public official may be able to view information about the video or other message (e.g., a title, a summary, etc.) and/or public officials and/or challengers involved with the issue by selecting button 1216, as illustrated in FIG. 12G.

Upon selecting the delegate button 1206, the public official may be provided with a list of staffers from which the public official may select one or more staffers to respond to the video or other message, as illustrated in FIG. 12H. The list of staffers may be based on the staffers that the public official or challenger has approved to respond to videos or other messages. As illustrated in FIG. 12I, the staffers chosen to respond to the video or other message may be displayed in box 1218 of the application after the selection and/or when the delegate button 1206 is selected.

In other embodiments, the user interfaces of FIGS. 12A-I may be viewable by a challenger. In such a situation, the videos may be tailored to the challenger and the notification 1202 may notify the challenger when a public official that the challenger is challenging has responded to a video or other message.

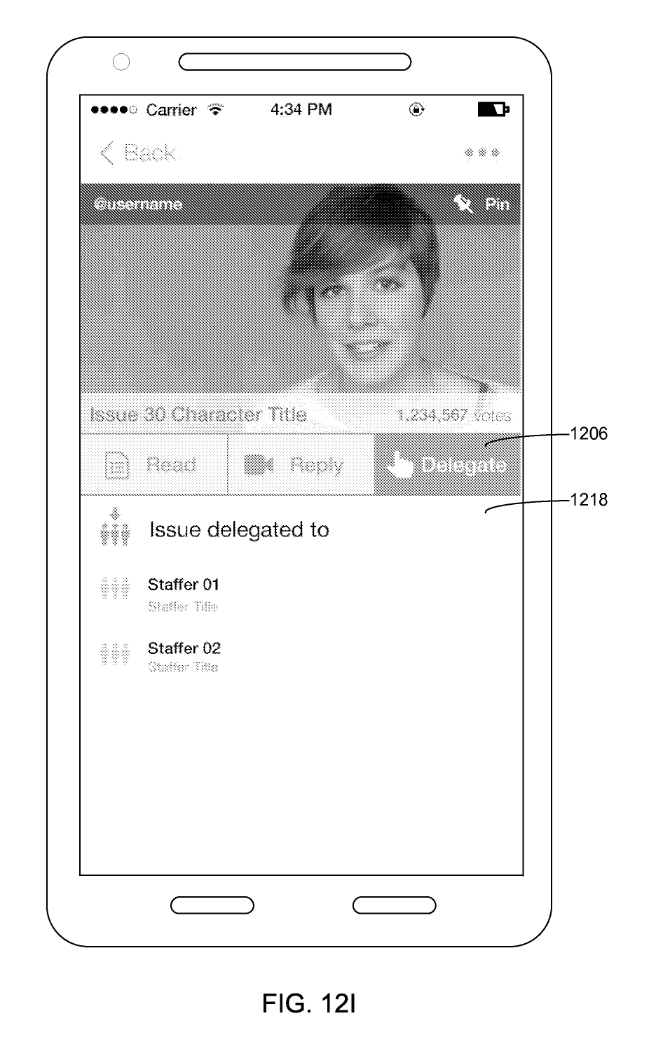

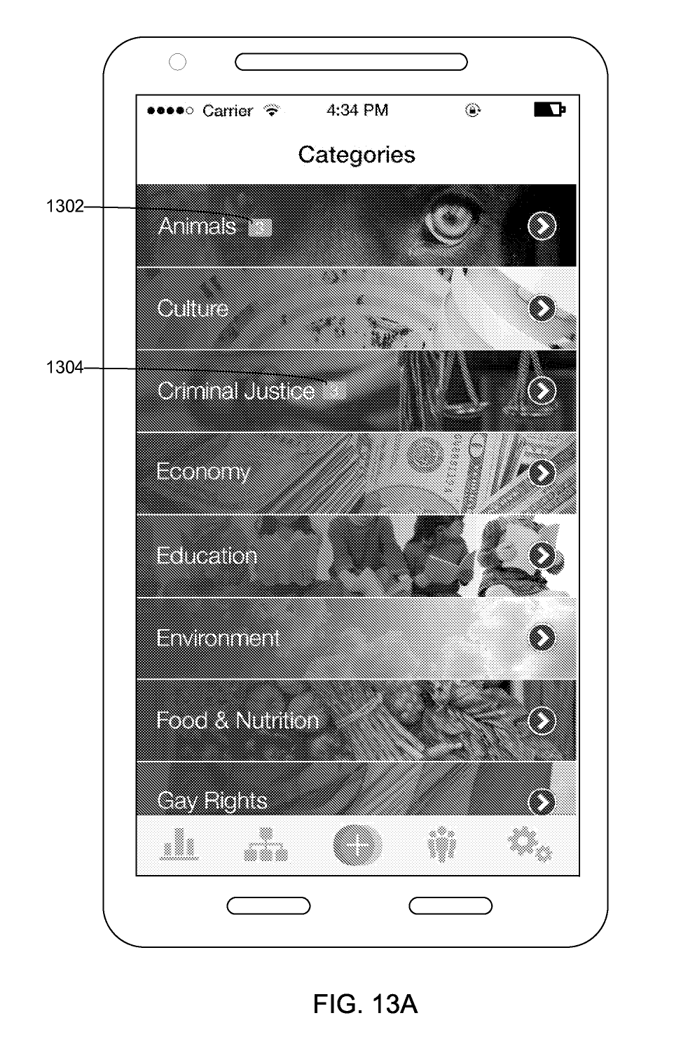

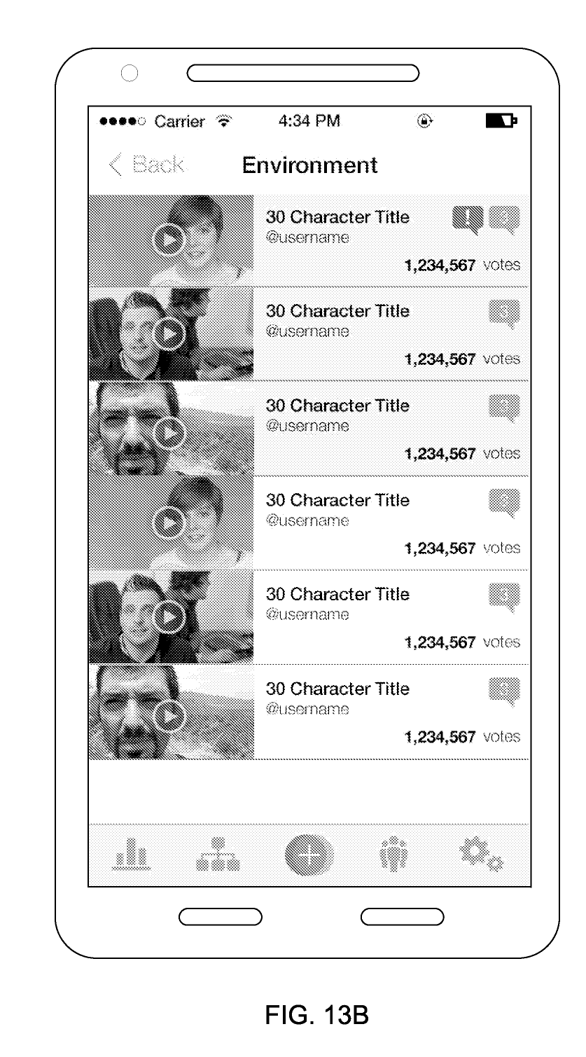

FIGS. 13A-B are diagrams depicting exemplary graphical user interfaces that display an application executed by the government device 135 of the communications system 100 of FIG. 1. As illustrated in FIG. 13A, a public official or challenger may be able to view a list of categories of political issues. For example, some categories can include animals, culture, criminal justice, economy, education, environment, food and nutrition, gay rights, etc. When a new video or other message has been captured related to a category that the public official or challenger is involved with, a notification may appear next to the category, such as notifications 1302 and 1304.

If a category that includes a notification is selected, a list of videos or other messages can be displayed, as illustrated in FIG. 13B. The new videos and/or other messages may be so indicated and/or displayed near the top of the user interface.

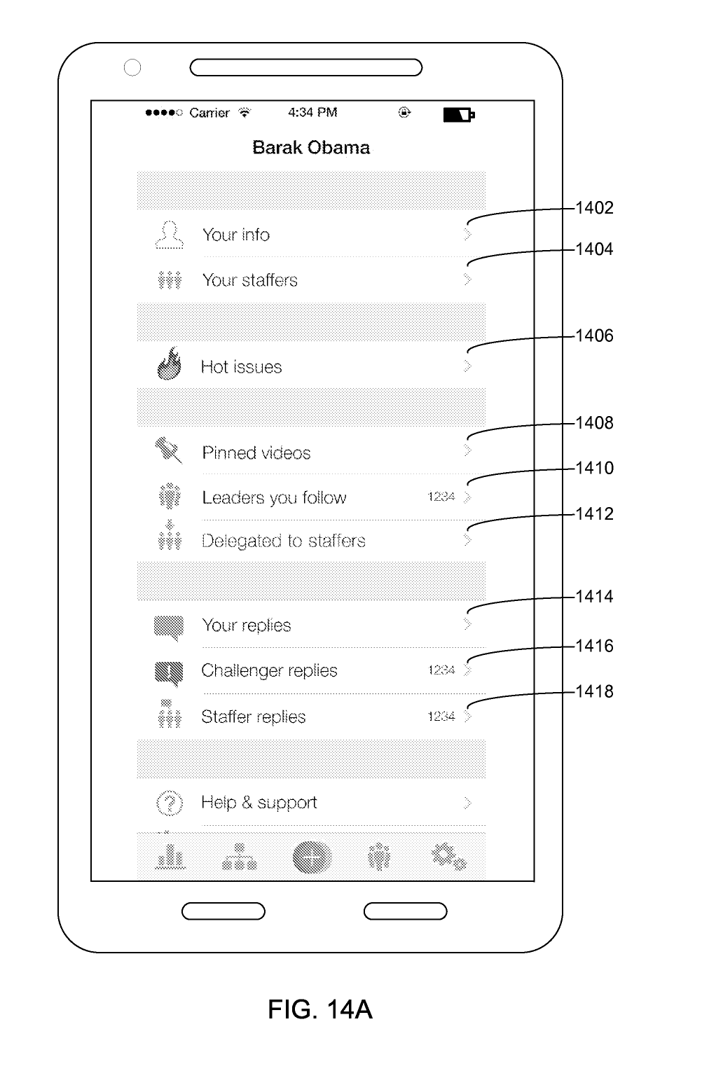

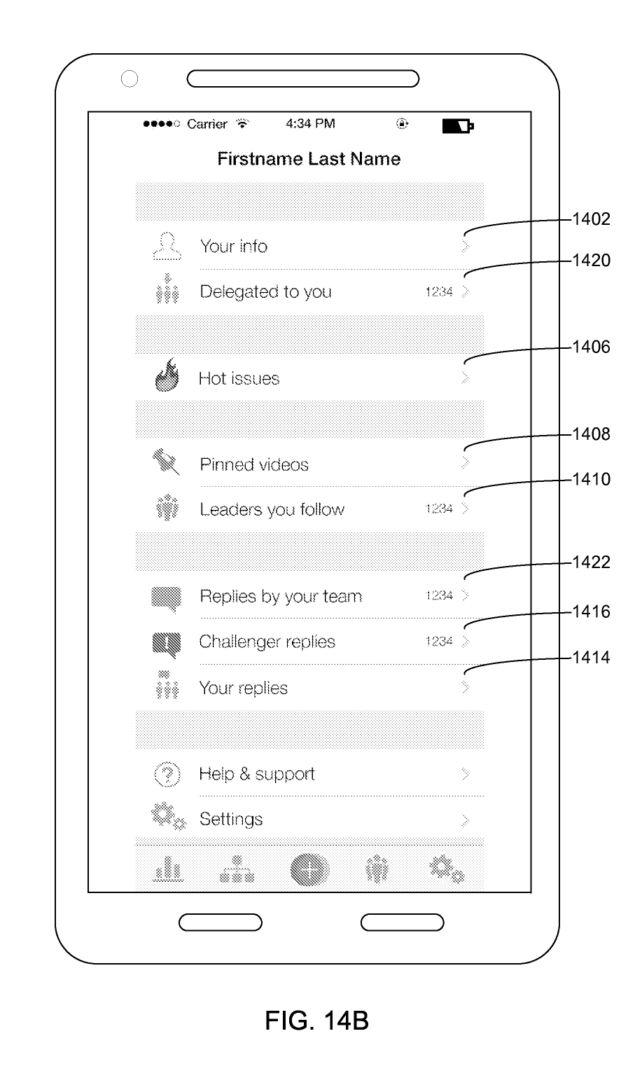

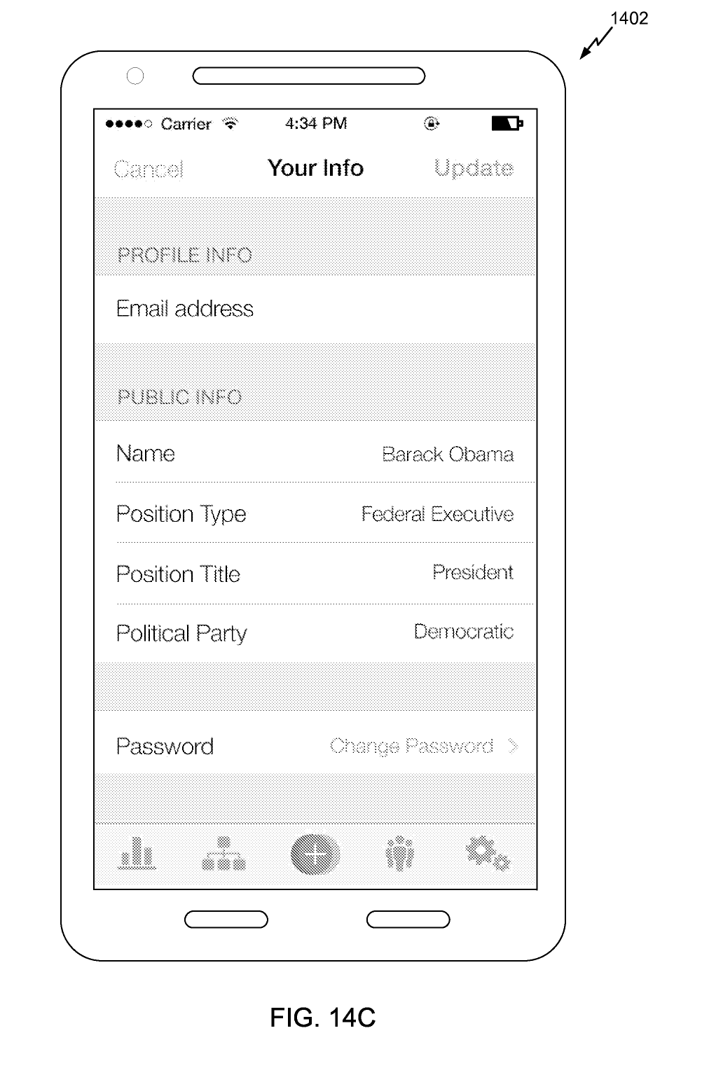

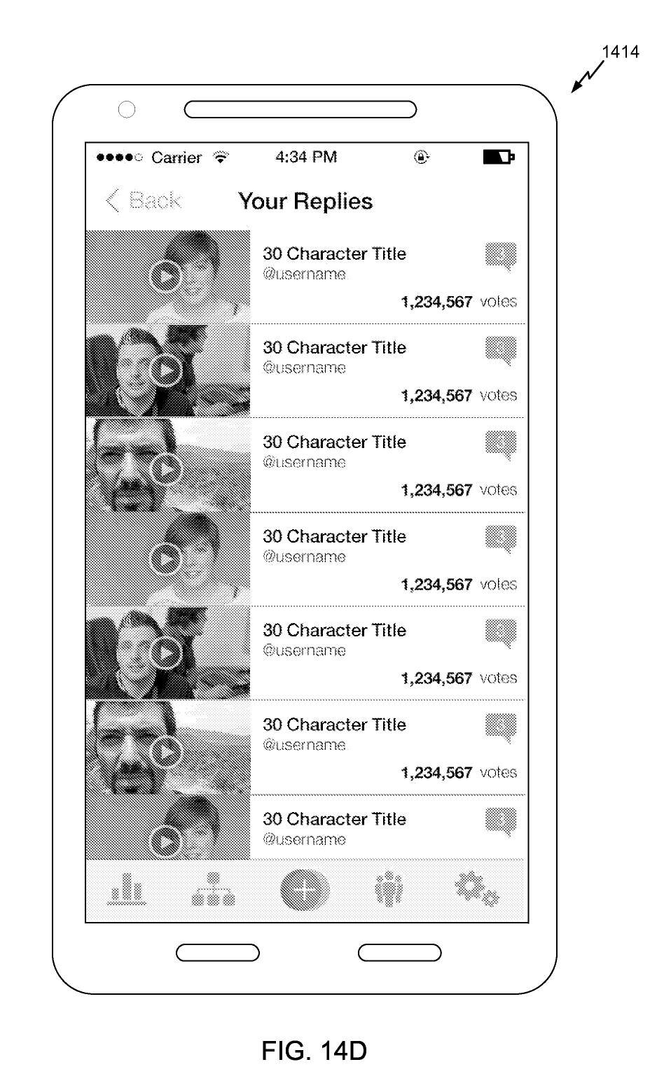

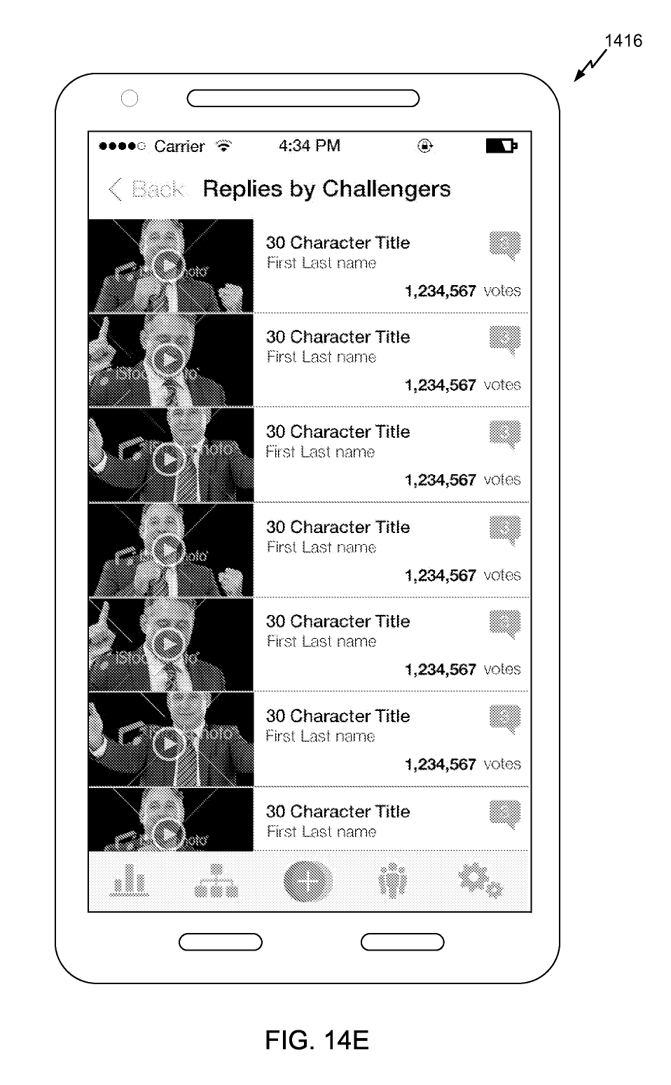

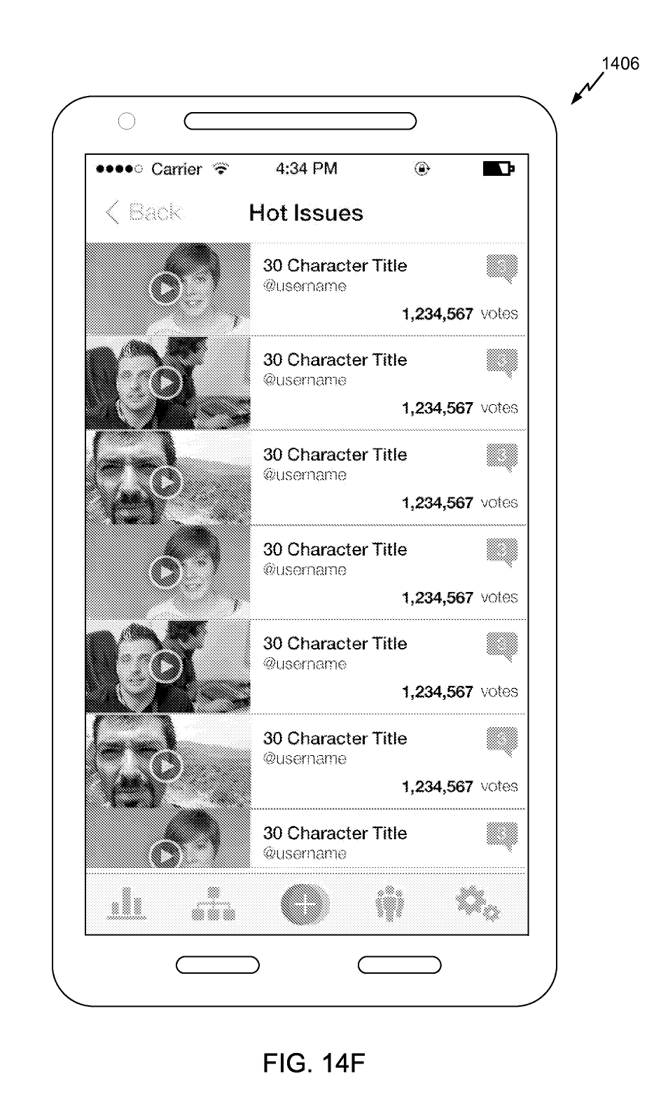

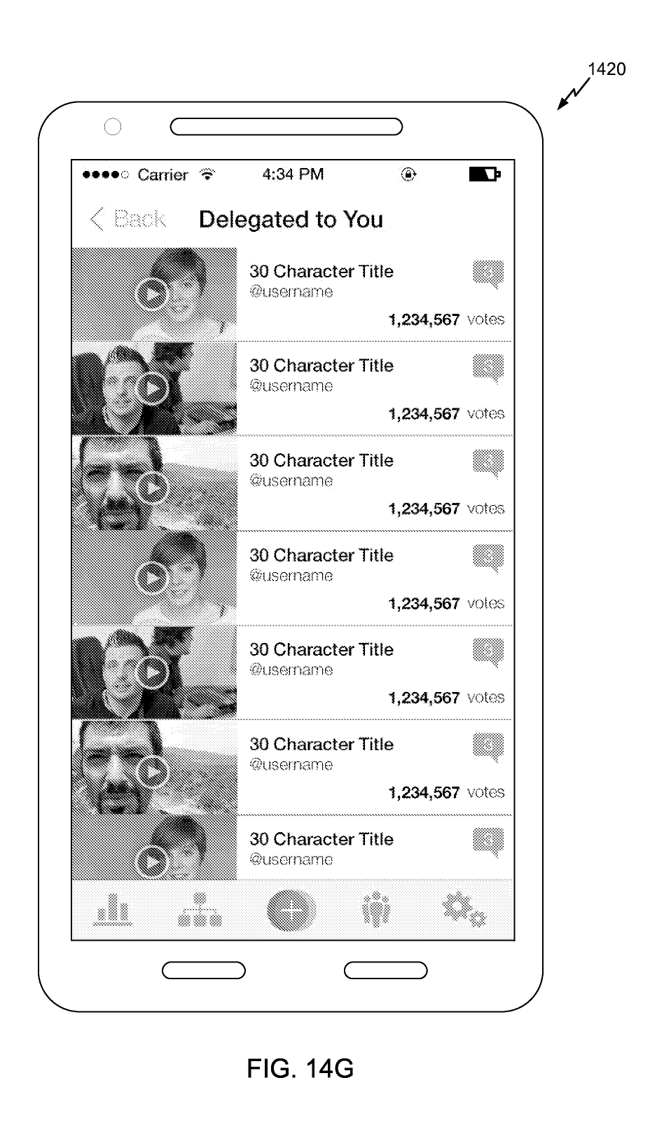

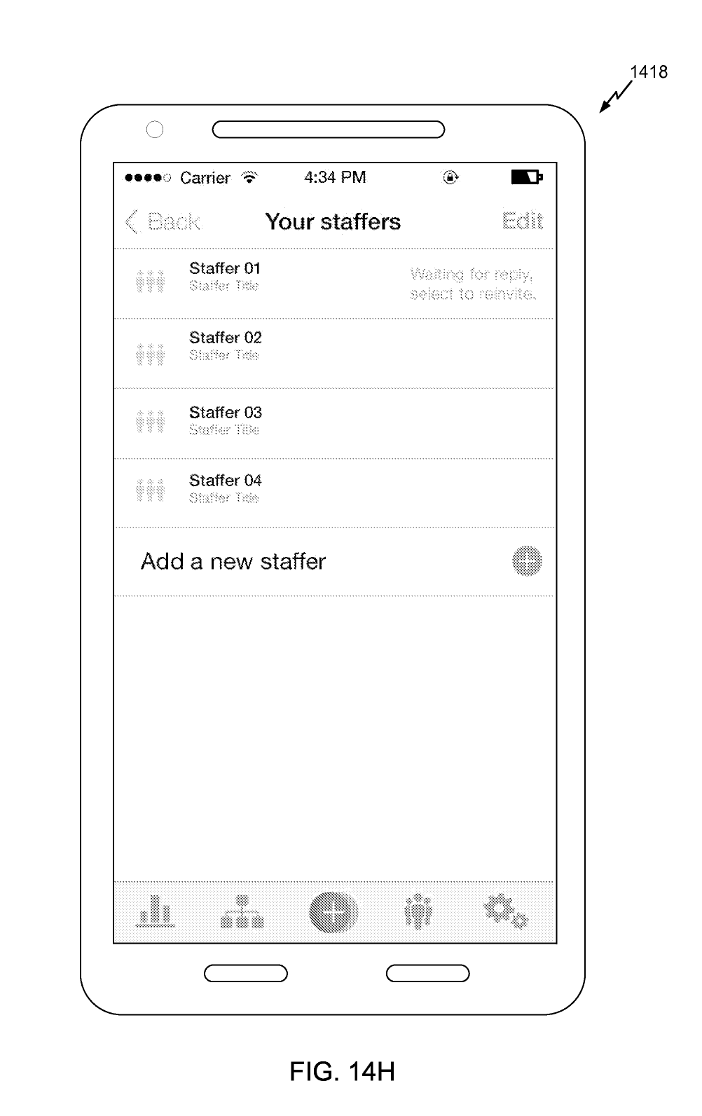

FIGS. 14A-H are diagrams depicting exemplary graphical user interfaces that display a user profile generated by an application executed by the government device 135 of the communications system 100 of FIG. 1. As illustrated in FIGS. 14A-H, a public official, staffer, and/or challenger can view his or her profile. In an embodiment, the user profile of a public official or challenger, as illustrated in FIG. 14A, includes nine menu buttons: a profile button 1402, a staffers button 1404, a hot issues button 1406, a pinned videos button 1408, a follow button 1410, a delegation button 1412, a replies button 1414, a challenger replies button 1416, and/or a staffer replies button 1418.

In an embodiment, the user profile of a staffer, as illustrated in FIG. 14B, includes eight menu buttons: the profile button 1402, a delegated button 1420, the hot issues button 1406, the pinned videos button 1408, the follow button 1410, a team replies button 1422, the challenger replies button 1416, and/or the replies button 1414.

As illustrated in FIG. 14C, the application displays fields for the public official, challenger, or staffer to provide his or her information when the profile button 1402 is selected. In an embodiment, the public official, challenger, or staffer can provide his or her name, an email address, a position type, a position title, and/or a political party.

As illustrated in FIG. 14D, the application displays videos or other messages generated by the public official, challenger, or staffer when the replies button 1414 is selected. Information associated with the videos or other messages can be provided, such as a title and/or political issue, a name of who took the video or other message and where the video or other message was taken, a number of views, and/or a number of votes.

As illustrated in FIG. 14E, the application displays videos or other messages generated by a person challenging the public official or challenger when the challenger replies button 1416 is selected. Information associated with the videos or other messages can be provided, such as a title and/or political issue, a name of who took the video or other message and where the video or other message was taken, a number of views, and/or a number of votes.

As illustrated in FIG. 14F, the application displays videos or other messages generated by users related to issues that are topical, controversial, popular, and/or the like when the hot issues button 1406 is selected. Information associated with the videos or other messages can be provided, such as a title and/or political issue, a name of who took the video or other message and where the video or other message was taken, a number of views, and/or a number of votes.

As illustrated in FIG. 14G, the application displays videos or other messages delegated to a staffer when the delegated button 1420 is selected. Information associated with the videos or other messages can be provided, such as a title and/or political issue, a name of who took the video or other message and where the video or other message was taken, a number of views, and/or a number of votes.

As illustrated in FIG. 14H, the application displays a list of staffers associated with the public official or challenger when the staffers button 1418 is selected. In an embodiment, the public official or challenger has the option to add additional staffers.

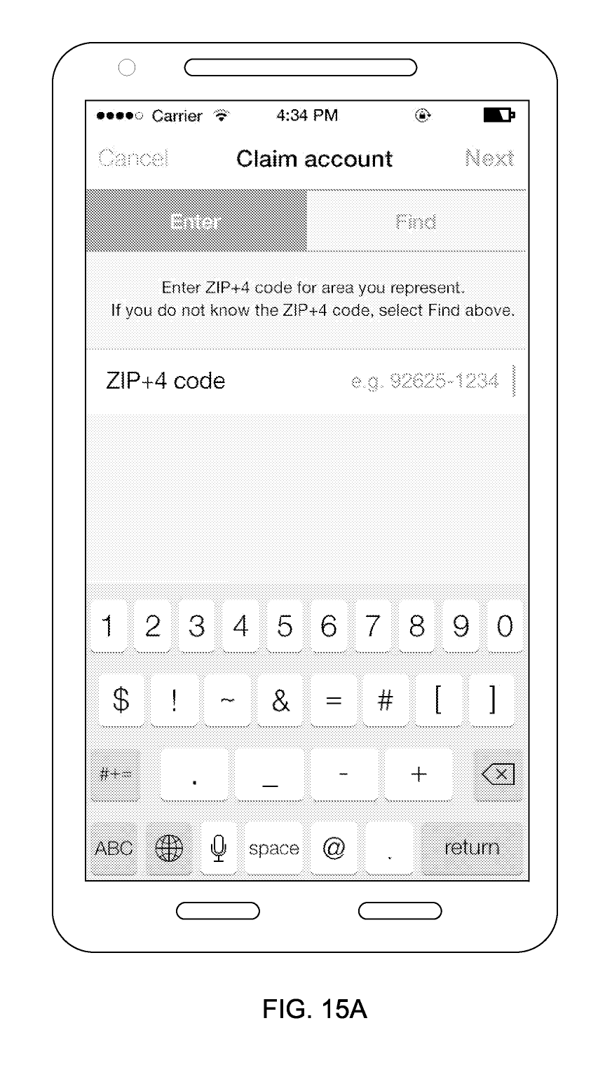

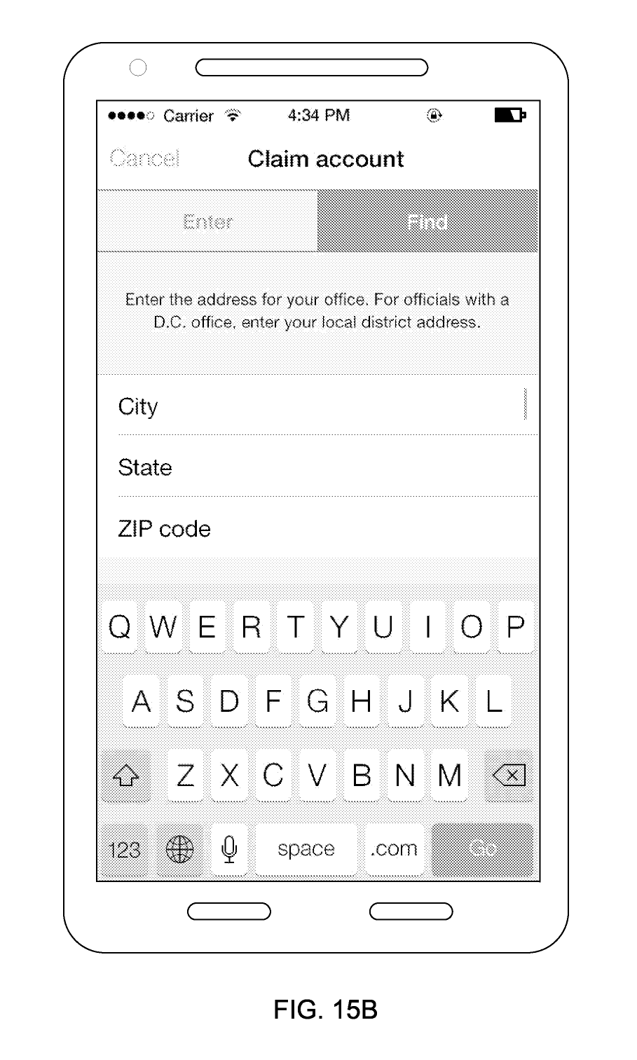

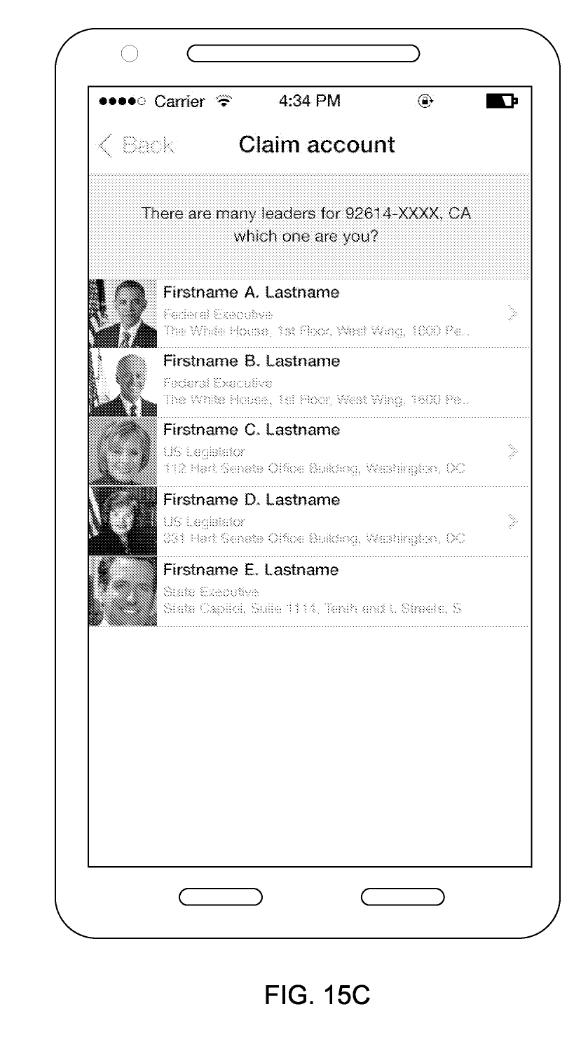

FIGS. 15A-C are diagrams depicting exemplary graphical user interfaces that display a process for claiming an account generated by an application executed by the government device 135 of the communications system 100 of FIG. 1. As illustrated in FIG. 15A, a public official or challenger may claim an account associated with the respective public official or challenger by first entering a zip code or address of a jurisdiction associated with the public official or challenger. The public official or challenger may then be prompted to enter an address of an office associated with the public official or challenger, as illustrated in FIG. 15B. Based on the information provided by the public official or challenger, the application may provide a suggested list of public officials or challengers that can be selected by the public official or challenger, as illustrated in FIG. 15C.

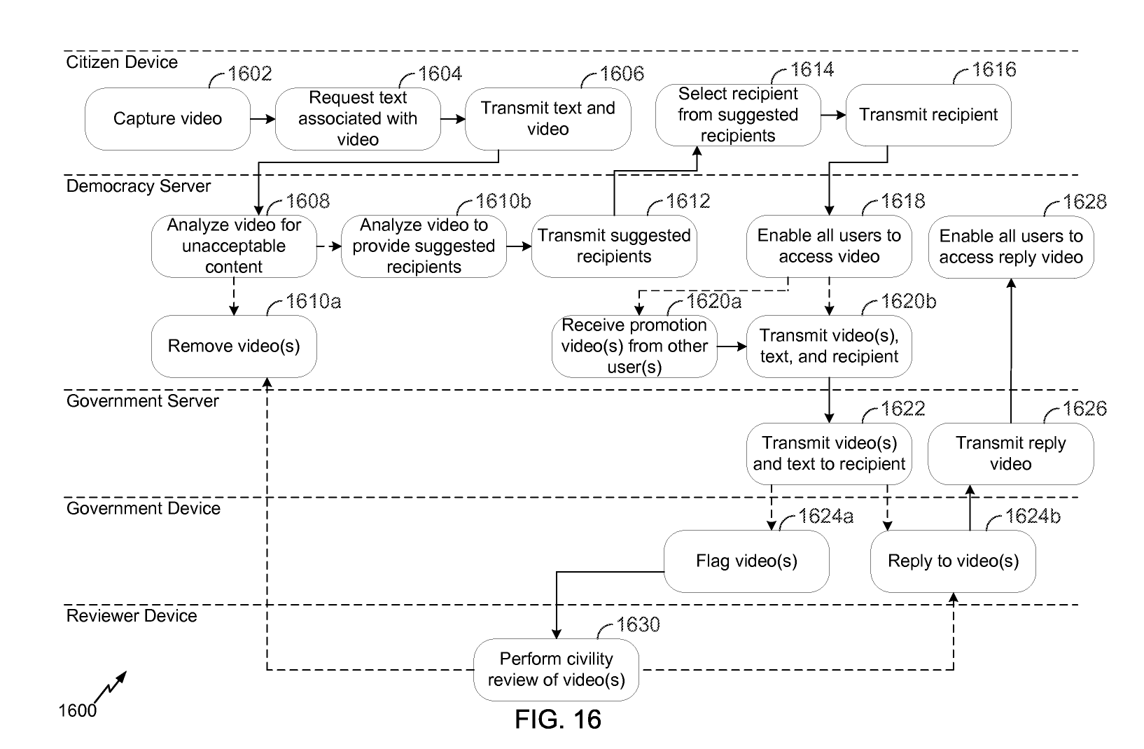

FIG. 16 is a flow diagram 1600 depicting a process for facilitating communications between a user and a public official or a challenger. As illustrated in FIG. 16, the diagram 1600 begins at block 1602. At block 1602, video is captured by a citizen device, such as the citizen device 110 of FIG. 1, via an executed application. At block 1604, the application requests text associated with the video from the user. For example, the text can include a title of the video and a description of the content of the video. At block 1606, the video and text are transmitted to a democracy server, such as the democracy server 140 of FIG. 1.

At block 1608, the democracy server analyzes the video for unacceptable content. For example, a language and image filter module, such as the language and image filter module 310, analyzes the video (e.g., the frames of the video and/or the audio track) to identify offensive material. If the democracy server identifies offensive material, the diagram 1600 proceeds to block 1610a. If the democracy server does not identify offensive material, the diagram 1600 proceeds to block 1610b.

At block 1610a, the democracy server removes the video, warns the user to not include offensive material in videos, and/or temporarily or permanently bans the user. At block 1610b, the democracy server analyzes the video to provide a list of suggested recipients. In an embodiment, the list of suggest recipients includes a list of public officials and/or challengers associated with the content of the video. For example, a content analysis module, such as the content analysis module 320, analyzes the text and/or the video to determine key words or phrases associated with a political issue, public official, or challenger to generate the list.

At block 1612, the generated list of suggested recipients is transmitted to the citizen device. At block 1614, the user of the citizen device selects a recipient from a list of public officials and/or challengers and/or the list of suggested recipients. At block 1616, the citizen device transmits the selected recipient(s) to the democracy server.

At block 1618, the democracy server enables some or all users to access the video generated by the citizen device. In some embodiments, other users vote and/or promote the video generated by the citizen device, and the diagram 1600 proceeds from block 1618 to 1620a to 1620b. In other embodiments, no users vote and/or promote the video generated by the citizen device, and the diagram 1600 proceeds from block 1618 to 1620b.

At block 1620b, the video generated by the citizen device, any videos generated by other users in response to the video generated by the citizen device, any text accompanying the video(s), and/or the recipient(s) are transmitted to a government server. In an embodiment, as described above, the video generated by the citizen device is set as the first message that the public official(s) or challenger(s) views. In another embodiment, as described above, a video generated by another user in response to the video generated by the citizen device is set as the first message that the public official(s) views. At block 1622, the government server transmits the video(s) and any accompanying text to a government device associated with the intended public official(s) or challenger(s). Alternatively, the video generated by the citizen device, any videos generated by other users in response to the video generated by the citizen device, any text accompanying the video(s), and/or the recipient(s) are transmitted directly to a government device associated with the intended public official(s) or challenger(s).

As described above, the public official(s) or challenger(s) can respond to a video generated by a user or flag a video generated by a user. If the public official(s) flags the video(s), the diagram 1600 proceeds to block 1624a. Otherwise, the diagram 1600 ends (e.g., if the public official(s) or challenger(s) does not respond) or proceeds to block 1624b (e.g., if the public official(s) or challenger(s) responds).

At block 1624a, the public official(s) or challenger(s) flags the video(s) via the government device. The flagged video(s) can be sent to a reviewer device associated with a message reviewer. At block 1630, the message reviewer can review the message for offensive material. If no offensive material exists, the diagram 1600 ends (e.g., if the public official(s) or challenger(s) does not respond) or proceeds to block 1624b (e.g., if the public official(s) or challenger(s) responds). If offensive material exists, the diagram 1600 proceeds to block 1610a.

At block 1624b, the public official(s) or challenger(s) responds to the video generated by the citizen device using the government device. In an embodiment, the government device then transmits the reply video generated by the public official(s) or challenger(s) to the government server. At block 1626, the government server transmits the reply video generated by the public official(s) or challenger(s) to the democracy server. At block 1628, the democracy server enables some or all users to access the reply video generated by the public official(s) or challenger(s). After block 1628, the diagram 1600 ends.

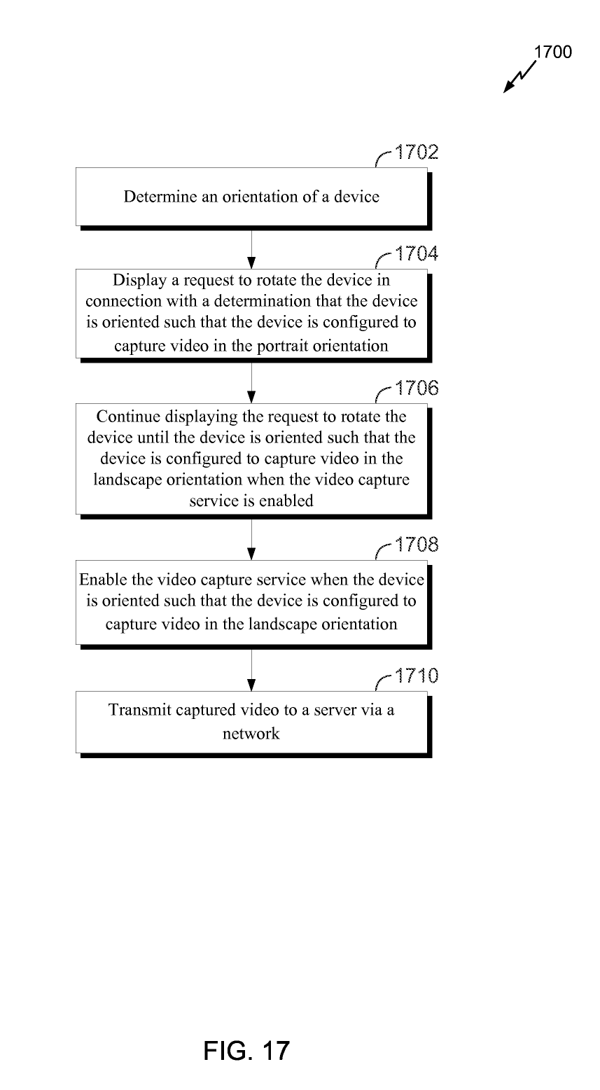

FIG. 17 is a flowchart depicting an embodiment of a process 1700 for capturing video of commentary on a political issue. In an embodiment, the process 1700 is performed by an application executed by the citizen device 110 and/or the one or more society devices 150 of FIG. 1. The process 1700 begins at block 1702. At block 1702, an orientation of a device is determined. In an embodiment, the video capture service enables the device to capture video in one of a landscape orientation or a portrait orientation when the video capture service is enabled. In a further embodiment, the video capture service is initially disabled.

At block 1704, a request is displayed to rotate the device in connection with a determination that the device is oriented such that the device is configured to capture video in the portrait orientation. In an embodiment, the determination of the device's orientation is made by a gyroscope, accelerometer, or other such component included in the citizen device 110 and/or the one more society devices 150.

At block 1706, the request to rotate the device is continuously displayed until the device is oriented such that the device is configured to capture video in the landscape orientation when the video capture service is enabled. At block 1708, the video capture service is enabled when the device is oriented such that the device is configured to capture video in the landscape orientation. At block 1710, the captured video is transmitted to a server via a network. After block 1710, the process 1700 ends.

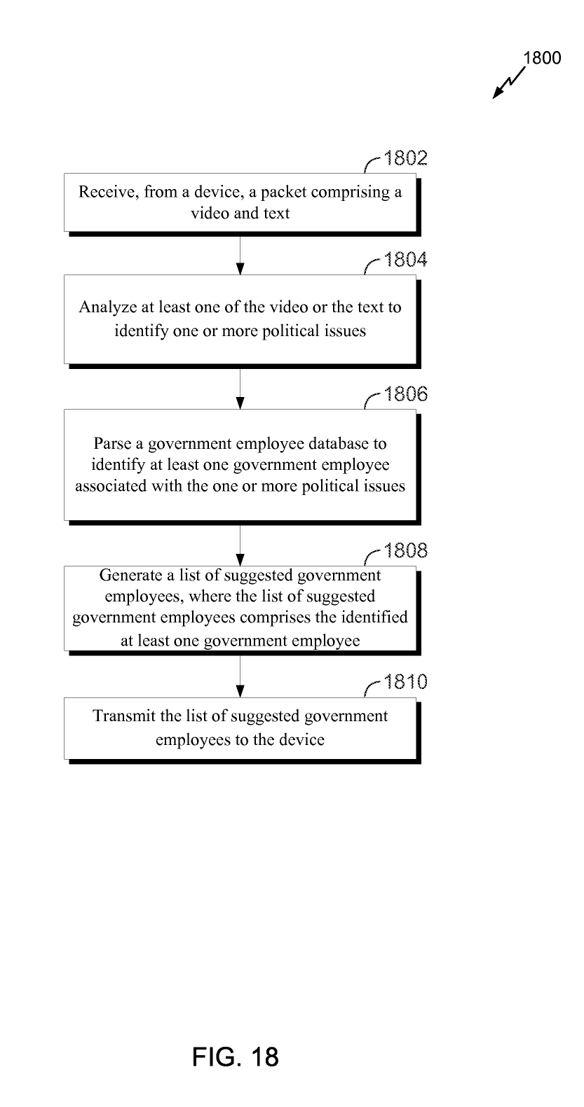

FIG. 18 is a flowchart depicting an embodiment of a process 1800 for analyzing video of commentary on a political issue. In an embodiment, the process 1800 is performed by the democracy server 140 of FIG. 1. The process 1800 begins at block 1802. At block 1802, a packet is received from a device, and the packet comprises a video and text. In an embodiment, the text includes a title and/or describes the content of the video.

At block 1804, at least one of the video or the text is analyzed to identify one or more political issues. In an embodiment, key words or phrases are identified in the audio track of the video and/or in the text description of the video that are associated with political issues, public officials, and/or challengers in order to identify the one or more political issues.

At block 1806, a government employee database is parsed to identify at least one government employee associated with the one or more political issues. At block 1808, a list of suggested government employees is generated. In an embodiment, the list of suggested government employees includes the identified at least one government employee. At block 1810, the list of suggested government employees is transmitted to the device. After block 1810, the process 1800 ends.

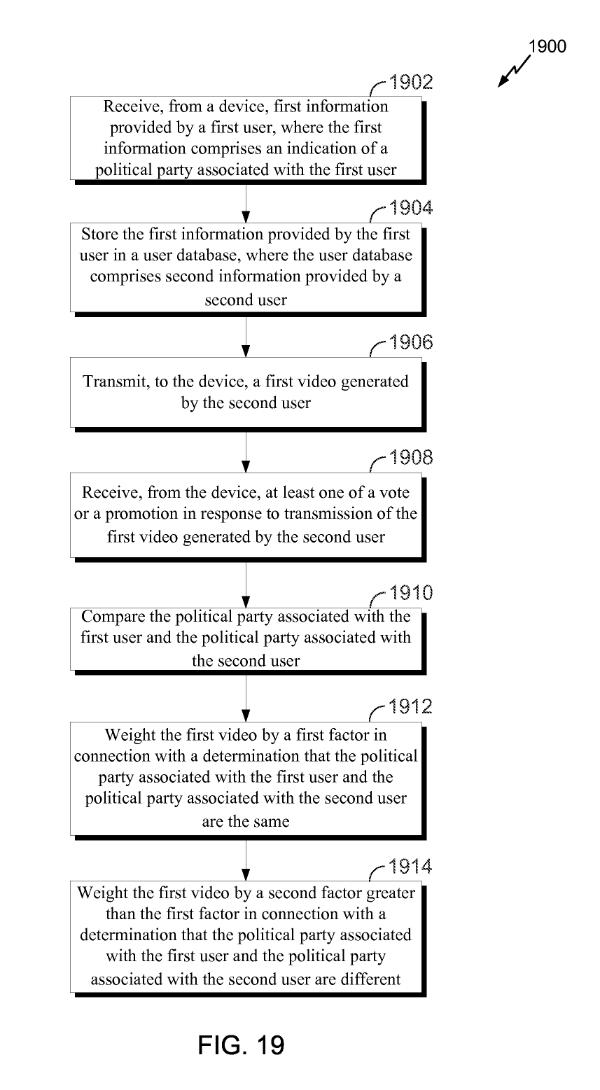

FIG. 19 is a flowchart depicting an embodiment of a process 1900 for promoting a video. In an embodiment, the process 1900 is performed by the democracy server 140 of FIG. 1. The process 1900 begins at block 1902. At block 1902, first information is received from a device and provided by a first user. In an embodiment, the first information comprises an indication of a political party associated with the first user.

At block 1904, the first information provided by the user is stored in a user database. In an embodiment, the user database comprises second information provided by a second user. At block 1906, a first video generated by the second user is transmitted to the device. In an embodiment, the first video is stored in the user database or a video database and associated with the second user.

At block 1908, at least one of a vote or a promotion is received from the device in response to transmission of the first video generated by the second user. In an embodiment, a vote includes a video captured by the first user in response to the first video generated by the second user. In a further embodiment, a promotion includes an endorsement of the first video.

At block 1910, the political party associated with the first user is compared with the political party associated with the second user. At block 1912, the first video is weighted by a first factor in connection with a determination that the political party associated with the first user and the political party associated with the second user are the same. At block 1914, the first video is weighted by a second factor greater than the first factor in connection with a determination that the political party associated with the first user and the political party associated with the second user are different. After block 1914, the process 1900 ends.

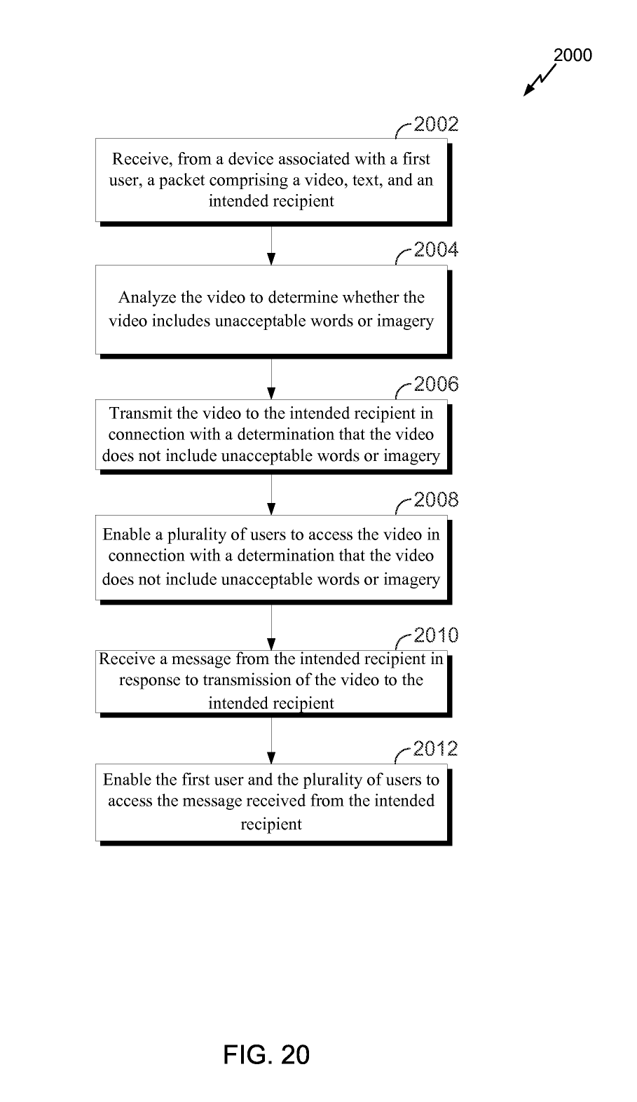

FIG. 20 is a flowchart depicting an embodiment of a process 2000 for providing access to a public official or challenger. In an embodiment, the process 2000 is performed by the democracy server 140 of FIG. 1. The process 2000 begins at block 2002. At block 2002, a packet is received from a device associated with a first user, where the packet includes a video, text, and an intended recipient. In an embodiment, the text includes a title and/or a description of the content of the video.

At block 2004, the video is analyzed to determine whether the video includes unacceptable words or imagery. In an embodiment, unacceptable words or imagery may be provided via a database or other such repository and compared with the text and/or audio track of the video. In a further embodiment, unacceptable words or imagery include offensive material (e.g., the message includes profanity, derogatory comments, provocative or insulting gestures or actions, etc.).

At block 2006, the video is transmitted to the intended recipient in connection with a determination that the video does not include unacceptable words or imagery. In an embodiment, the video is transmitted to a public official or challenger. At block 2008, a plurality of users is enabled to access the video in connection with a determination that the video does not include unacceptable words or imagery.

At block 2010, a message is received from the intended recipient in response to transmission of the video to the intended recipient. In an embodiment, the message is a video generated by a public official or challenger in response to a video generated by a constituent. At block 2012, the first user and the plurality of users are enabled to access the message received from the intended recipient. After block 1412, the process 1400 ends.

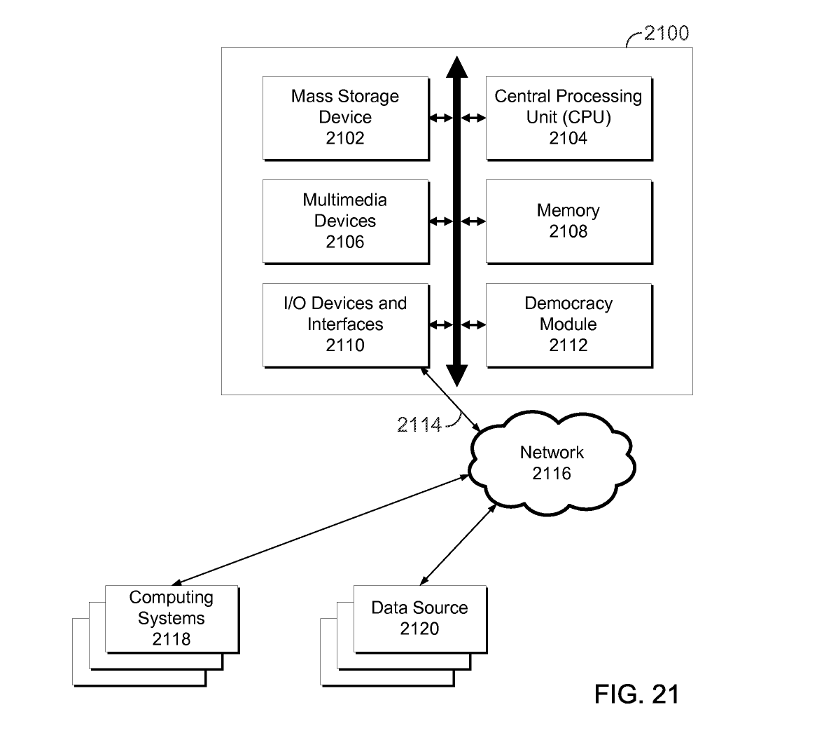

FIG. 21 is block diagram depicting an embodiment of a more detailed device 2100 of the communications system 100 of FIG. 1. In an embodiment, the device 2100 comprises the citizen device 110, the government devices 135, the reviewer devices 138, and/or the one or more society devices 150. As illustrated in FIG. 21, the device 2100 can include a mass storage device 2102, a central processing unit (CPU) 2104, multimedia devices 2106, a memory 2108, input/output (I/O) devices and interfaces 2110, and/or a democracy module 2112. The democracy module 2112 can carry out the functions, methods, and/or processes described herein. For example, the democracy module 2112 can carry out the functions of the application described herein with respect to FIGS. 4A-15C. The democracy module 2112 is executed on the device 2100 by the CPU 2104, as described in more detail below.

In general the word “module,” as used herein, refers to logic embodied in hardware or firmware or to a collection of software instructions, having entry and exit points. Modules are written in a program language, such as JAVA, JavaScript, HTML, XML, CSS, AJAX, PHP, C, C#, or C++, or the like. Software modules can be compiled or linked into an executable program, installed in a dynamic link library, or can be written in an interpreted language such as BASIC letters, ASP, PERL, LUA, PHP, Ruby, Python, or the like. Software modules can be called from other modules or from themselves, and/or can be invoked in response to detected events or interruptions. Modules implemented in hardware include connected logic units such as gates and flip-flops, and/or can include programmable units, such as programmable gate arrays or processors.

Generally, the modules described herein refer to logical modules that can be combined with other modules or divided into sub-modules despite their physical organization or storage. The modules are executed by one or more computing systems, and can be stored on or within any suitable computer readable medium, or implemented in-whole or in-part within special designed hardware or firmware. Not all calculations, analysis, and/or optimization require the use of computer systems, though any of the above-described methods, calculations, processes, or analyses can be facilitated through the use of computers. Further, in some embodiments, process blocks described herein can be altered, rearranged, combined, and/or omitted.

The device 2100 includes one or more CPUs 2104, which can include a microprocessor. The device 2100 further includes the memory 2108, such as random access memory (RAM) for temporary storage of information, a read only memory (ROM) for permanent storage of information, and the mass storage device 2102, such as a hard drive, a flash drive, a memory card, a diskette, an optical media storage device, or the like. Alternatively, the mass storage device 2102 can be implemented in an array of servers. Typically, the components of the device 2100 are connected to the computer using a standards based bus system. The bus system can be implemented using various protocols, such as Peripheral Component Interconnect (PCI), Micro Channel, SCSI, Industrial Standard Architecture (ISA) and Extended ISA (EISA) architectures.

The device 2100 includes one or more I/O devices and interfaces 2110, such as a keyboard, mouse, touchpad, and printer. The I/O devices and interfaces 2110 can include one or more display devices, such as a monitor, that allows the visual presentation of data to a user. More particularly, a display device provides for the presentation of GUIs as application software data, and multi-media presentations, for example. The I/O devices and interfaces 2110 can also provide a communications interface to various external devices. The device 2100 can include one or more multimedia devices 2106, such as speakers, video cards, graphics accelerators, microphones, and/or the like.

The device 2100 can run on a variety of computing devices, such as a server, a virtual server, a Windows server, and Structure Query Language server, a Unix Server, a Linux Server, a Mac Server, a personal computer, a laptop computer, and so forth. In other embodiments, the device 2100 can run on a mainframe computer suitable for controlling and/or communicating with large databases, performing high volume transaction processing, and generating reports from large databases. The device 2100 is generally controlled and coordinated by an operating system software, such as z/OS, Windows 95, Windows 98, Windows NT, Windows 2000, Windows XP, Windows Vista, Windows 7, Linux, Unix, BSD, SunOS, Solaris, tinyOS, iOS, Windows Mobile, Android, webOS, or other compatible operating systems, including proprietary operating systems. Operating systems control and schedule computer processes for execution, perform memory management, provide file system, networking, and I/O services, and provide a user interface, such as a graphical user interface (GUI), among other things.

The device 2100 can communicate with a network 2116 via communication link 2114 (wired, wireless, or a combination thereof). In an embodiment, the network 2116 is the network 120 of FIG. 1. The network 2116 communicates with various computing devices and/or other electronic devices. For example, the network communicates with the device 2100, computing systems 2118, and/or data source 2120. In an embodiment, the computing systems 2118 can be any of the devices or servers of the communications system 100 of FIG. 1. In a further embodiment, the data source 2120 can be any of the databases illustrated in FIG. 3. The democracy module 2112 can access or can be accessed through a web-enabled user access point. Connections can be a direct physical connection, a virtual connection, and other connection type. The web-enabled user access point can include a browser module that uses text, graphics, audio, video, and other media to present data and to allow interaction with data via the network 2116. The browser module can display media associated with an application as well.

The browser module or other output module can be implemented as a combination of an all-points addressable display such as a cathode ray tube (CRT), a liquid crystal display (LCD), a plasma display, a field emission display (FED), a surface-conduction electron-emitter display (SED), a light-emitting diode display (LED), an organic light-emitting diode display (OLED), an active-matrix organic light-emitting diode display (AMOLED), or other types and/or combinations of displays. The output module can be implemented to communicate with I/O devices and interfaces 2110 and they also include software with the appropriate interfaces which allow a user to access data through the use of stylized screen elements, such as menus, windows, dialogue boxes, tool bars, and controls (e.g., radio buttons, check boxes, sliding scales, and so forth). Furthermore, the output module can communicate with a set of input and output devices to receive signals from the user.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Additionally, the skilled artisan will recognize that any of the above-described methods can be carried out using any appropriate apparatus. Further, the disclosure herein of any particular feature, aspect, method, property, characteristic, quality, attribute, element, or the like in connection with an embodiment can be used in all other embodiments set forth herein. Thus, it is intended that the scope of the present invention herein disclosed should not be limited by the particular disclosed embodiments described above.

Conditional language, such as, among others, “can,” “could,” “might,” or “may,” unless specifically stated otherwise, or otherwise understood within the context as used, is generally intended to convey that certain embodiments include while other embodiments do not include, certain features, elements and/or blocks. Thus, such conditional language is not generally intended to imply that features, elements and/or blocks are in any way required for one or more embodiments or that one or more embodiments necessarily include logic for deciding, with or without user input or prompting, whether these features, elements and/or steps are included or are to be performed in any particular embodiment.

What is claimed is:

1. A method, implemented on at least one computer device, for capturing video of commentary on a political issue, comprising:
determining an orientation of a device, wherein the device comprises a video capture service, wherein the video capture service enables the device to capture video in one of a landscape orientation or a portrait orientation when the video capture service is enabled, and wherein the video capture service is disabled;
displaying a request to rotate the device in connection with a determination that the device is oriented such that the device is configured to capture video in the portrait orientation when the video capture service is enabled;
continue displaying the request to rotate the device until the device is oriented such that the device is configured to capture video in the landscape orientation when the video capture service is enabled;
enabling the video capture service when the device is oriented such that the device is configured to capture video in the landscape orientation; and
transmitting captured video to a server via a network.

2. The method of claim 1, wherein determining the orientation of the device comprises determining the orientation of the device based on measurements of at least one of a gyroscope or an accelerometer.

3. The method of claim 1, further comprising providing a countdown to indicate when video capture will begin.

4. The method of claim 1, further comprising displaying a timestamp during video capture to indicate a length of the captured video.

5. The method of claim 1, further comprising:
receiving a request to mask the captured video; and
masking an identity of a person captured in the captured video.

6. The method of claim 5, further comprising transmitting the masked captured video to the server via the network.

7. A device for capturing video of commentary on an issue, comprising:
a computing system comprising one or more computing devices, the computing system programmed to implement a video capture unit configured to:
determine an orientation of the device, wherein the device comprises a video capture service, wherein the video capture service enables the device to capture video in one of a landscape orientation or a portrait orientation when the video capture service is enabled, and wherein the video capture service is disabled;
display a request to rotate the device in connection with a determination that the device is oriented such that the device is configured to capture video in the portrait orientation when the video capture service is enabled;
continue to display the request to rotate the device until the device is oriented such that the device is configured to capture video in the landscape orientation when the video capture service is enabled; and
enable the video capture service when the device is oriented such that the device is configured to capture video in the landscape orientation.

8. The device of claim 7, wherein the computing system is further programmed to implement an input/output unit configured to transmit captured video to a server via a network.

9. The device of claim 8, wherein the video capture unit is further configured to:
receive a request to mask the captured video; and
mask an identity of a person captured in the captured video.

10. The device of claim 9, wherein the input/output unit is further configured to transmit the masked captured video to the server via the network.

11. The device of claim 7, wherein the video capture unit is further configured to determine the orientation of the device based on measurements of at least one of a gyroscope or an accelerometer.

12. The device of claim 7, wherein the video capture unit is further configured to provide a countdown to indicate when video capture will begin.

13. The device of claim 7, wherein the video capture unit is further configured to display a timestamp during video capture to indicate a length of captured video.

14. A computer storage system comprising a non-transitory storage device, said computer storage system having stored thereon executable program instructions that direct a computer system to at least:
determine an orientation of a device, wherein the device comprises a video capture service, wherein the video capture service enables the device to capture video in one of a landscape orientation or a portrait orientation when the video capture service is enabled, and wherein the video capture service is disabled;
display a request to rotate the device in connection with a determination that the device is oriented such that the device is configured to capture video in the portrait orientation when the video capture service is enabled;
continue to display the request to rotate the device until the device is oriented such that the device is configured to capture video in the landscape orientation when the video capture service is enabled; and
enable the video capture service when the device is oriented such that the device is configured to capture video in the landscape orientation.

15. The computer storage system of claim 14, wherein the computer system is further directed to transmit captured video to a server via a network.

16. The computer storage system of claim 15, wherein the computer system is further directed to:
receive a request to mask the captured video; and
mask an identity of a person captured in the captured video.

17. The computer storage system of claim 16, wherein the computer system is further directed to transmit the masked captured video to the server via the network.

18. The computer storage system of claim 14, wherein the computer system is further directed to determine the orientation of the device based on measurements of at least one of a gyroscope or an accelerometer.

19. The computer storage system of claim 14, wherein the computer system is further directed to provide a countdown to indicate when video capture will begin.

20. The computer storage system of claim 14, wherein the computer system is further directed to display a timestamp during video capture to indicate a length of captured video.
